(19) United States
(12) Patent Application Publication
(10) Pub. No.: US 2019/0176459 A1
(43) Pub. Date: Jun. 13, 2019

(54) POSITIVE TYPE PLANOGRAPHIC PRINTING PLATE PRECURSOR AND METHOD OF PRODUCING PLANOGRAPHIC PRINTING PLATE

(71) Applicant: FUJIFILM CORPORATION, Tokyo (JP)

(72) Inventors: Yuichi YASUHARA, Haibara-gun (JP); Atsuyasu NOZAKI, Haibara-gun (JP)

(21) Appl. No.: 16/279,978

(22) Filed: Feb. 19, 2019

Related U.S. Application Data
(63) Continuation of application No. PCT/JP2017/029660, filed on Aug. 18, 2017.

(30) Foreign Application Priority Data
Sep. 29, 2016 (JP) 2016-192049

(51) Int. Cl. B41C 1/10

(52) U.S. Cl. CPC B41C 1/1016; B41C 2201/06; B41C 2201/04; B41C 2210/24; B41C 2210/02; B41C 2210/266; B41C 2210/264; B41C 2210/22

(57) ABSTRACT

Provided are a positive type planographic printing plate precursor including: a support which has a hydrophilic surface; and an image recording layer on the support, the image recording layer containing: a polymer compound 1 having at least one bond selected from the group consisting of a urea bond, a urethane bond, and a carbonate bond in a main chain and containing a sulfonamide group in the main chain; a polymer compound 2-1 having at least one of a constitutional unit represented by Formula S-1 or a constitutional unit represented by Formula S-2 or a polymer compound 2-2 having a constitutional unit represented by Formula EV-1 and a constitutional unit represented by Formula EV-2; and an infrared absorbent, and a method of producing a planographic printing plate obtained by using the positive type planographic printing plate precursor.

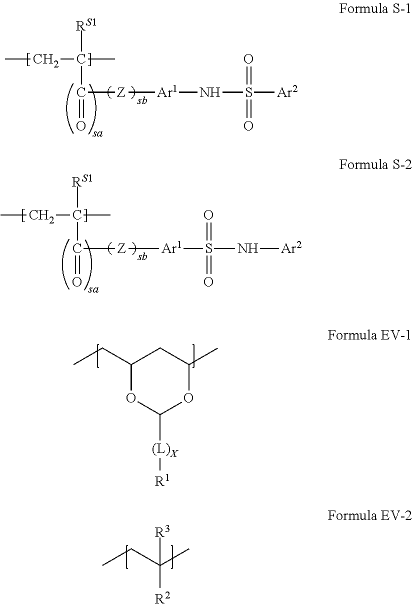

### CROSS-REFERENCE TO RELATED APPLICATIONS

This application is a continuation application of International Application No. PCT/JP2017/029660, filed Aug. 18, 2017, the disclosure of which is incorporated herein by reference in its entirety. Further, this application claims priority from Japanese Patent Application No. 2016-192049, filed Sep. 29, 2016, the disclosure of which is incorporated herein by reference in its entirety.

### BACKGROUND OF THE INVENTION

### 1. Field of the Invention

The present disclosure relates to a positive type planographic printing plate precursor and a method of producing a planographic printing plate.

### 2. Description of the Related Art

In recent years, lasers in the field of planographic printing have been remarkably developed, and in particular, solid-state lasers and semiconductor lasers having an emission region from a near infrared region to an infrared region, with a high output and a small size, have become easily available. In the field of planographic printing, as an exposure light source at the time of plate-making directly from digital data such as a computer or the like, these lasers are very useful.

A positive type planographic printing plate precursor for an infrared laser has an alkali-soluble binder resin and an infrared absorbent (for example, an infrared absorbing dye (IR dye)) and the like which absorb light and generate heat, as indispensable components. In the unexposed portion (image area), this IR dye and the like act as a development restrainer which substantially decreases the solubility of a binder resin in a developer due to an interaction between the IR dye and the like and the binder resin, and in the exposed portion (non-image area), the interaction between the IR dye and the like and the binder resin weakens due to generated heat, the IR dye and the like are dissolved in an alkaline developer, and as a result, a planographic printing plate is formed.

### SUMMARY OF THE INVENTION

Since the image forming capability of a positive type planographic printing plate precursor for an infrared laser as described above depends on the heat generated by a surface of an image recording layer being exposed to an infrared laser, in the vicinity of a support, an image is formed by diffusion of heat to the support, that is, the heat quantity to be used for solubilization of the image recording layer is reduced, and thus, the sensitivity becomes low. Therefore, there is a problem in that development restraining capability loss effects of the recording layer in the non-image area are not sufficiently obtained, a difference between the image area and the non-image area is reduced, and thus, highlight reproducibility is insufficient.

In order to solve the above-described problem of the highlight reproducibility, using a recording layer formed of a material having characteristics in which a non-image area can be more easily developed, that is, the solubility in an alkali aqueous solution is excellent may be considered, but there is a problem in that such a recording layer becomes chemically weakened even in the image area region and easily damaged by the developer, an ink washing solvent used during printing, or the plate cleaner, which means that the chemical resistance deteriorates. Further, there is demand for a resin material having characteristics in which the chemical resistance and the durability of a coated film in the unexposed portion region are excellent and the developability thereof is excellent after the dissolution suppressing action is released due to exposure.

Various improved techniques have been suggested for the same purpose as described above. For example, EP1826001B describes a thermosensitive positive type planographic printing plate precursor which includes a support having a hydrophilic surface or a hydrophilic layer, and a thermosensitive layer containing an infrared absorbent, a phenol resin, and an alkali-soluble resin having a monomer unit represented by Formula I or II.

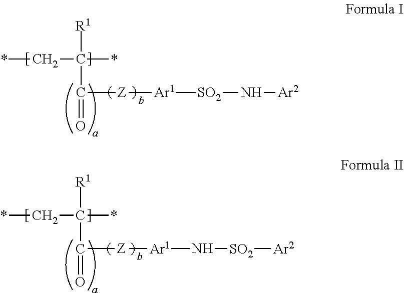

Further, WO2014/106554A describes a planographic printing plate precursor which contains a copolymer having a structure represented by Formula III and a structure represented by Formula IV and the above-described copolymer.

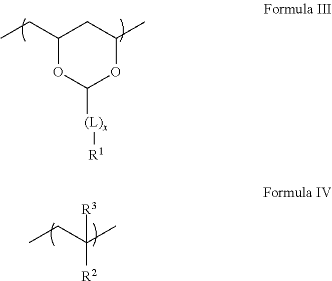

WO2016/133072A describes a photosensitive resin composition which contains a polymer compound having a polycyclic structure in the main chain and containing a sulfonamide group in the main chain, and an infrared absorbent.

In recent years, diversification of print materials (paper, ink, and the like) has progressed, and even in a case of using the same printing plate, there is a problem in that the number of printable sheets (hereinafter, referred to as “printing durability”) is greatly reduced depending on the type of a print material.

In the invention described in EP1826001B and the invention described in WO2014/106554A, high chemical resistance is obtained by using a polymer compound to which a unit with high chemical resistance has been introduced as one binder resin. However, since the strength of the image recording layer itself is weak, there is a problem in that the printing durability and the chemical resistance in printing are degraded in a case where a particularly low-quality print material (paper or ink) is used.

Further, WO2016/133072A describes a planographic printing plate precursor which contains a sulfonamide group and a polycyclic structure in the main chain and thus the printing durability and the chemical resistance become excellent. However, with the diversification of the above-described print materials, further improvement of printing durability and chemical resistance has been demanded.

Further, the present inventors found that there is a problem in that stains are generated on a printed material formed using a planographic printing plate to be obtained in a case where the planographic printing plate is prepared by exposing a positive type planographic printing plate precursor and developing the resulting precursor after a lapse of time.

It is speculated that the problem is caused because an interaction between an alkali-soluble resin and a low-molecular component such as an infrared absorbent in the image recording layer is recovered after exposure and this results in degradation of the developability.

In the present disclosure, the suppression of stains generated on a printed material formed using a planographic printing plate to be obtained in a case where the planographic printing plate is prepared by exposing a positive type planographic printing plate precursor and developing the resulting precursor after a lapse of time is expressed as “the temporal stability after exposure of the positive type planographic printing plate precursor is high”.

An object of an embodiment of the present invention is to provide a positive type planographic printing plate precursor from which a planographic printing plate with excellent chemical resistance and printing durability is obtained and which has high temporal stability after exposure.

Further, another object of an embodiment of the present invention is to provide a method of producing a planographic printing plate obtained by using the positive type planographic printing plate precursor.

Means for solving the above-described problems includes the following aspects.

<1> A positive type planographic printing plate precursor, comprising:

a support which has a hydrophilic surface; and

an image recording layer on the support,

the image recording layer comprising:

a polymer compound 1 comprising at least one bond selected from the group consisting of a urea bond, a urethane bond, and a carbonate bond in a main chain and comprising a sulfonamide group in the main chain;

a polymer compound 2-1 comprising at least one of a constitutional unit represented by the following Formula S-1 or a constitutional unit represented by the following Formula S-2 or a polymer compound 2-2 comprising a constitutional unit represented by the following Formula EV-1 and a constitutional unit represented by the following Formula EV-2; and

an infrared absorbent.

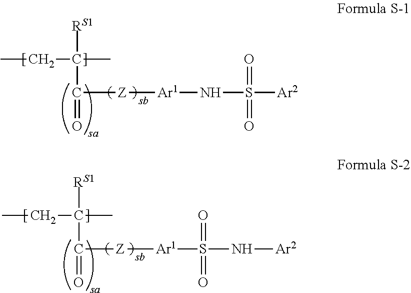

In Formulae S-1 and S-2, R^{S1} represents a hydrogen atom or an alkyl group, Z represents —O— or —N(R^{S2}), R^{S2} represents a hydrogen atom, an alkyl group, an alkenyl group, or an alkynyl group, each of Ar¹ and Ar² independently represents an aromatic group, at least one of Ar¹ or Ar² represents a heteroaromatic group, and each of sa and sb independently represents 0 or 1.

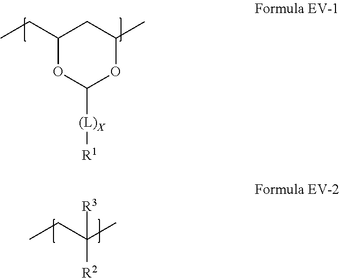

In Formulae EV-1 and EV-2, L represents a divalent linking group, X represents 0 or 1, R¹ represents an aromatic ring or heteroaromatic ring which contains at least one hydroxy group, and each of R² and R³ independently represents a hydrogen atom, a halogen atom, a linear, branched, or cyclic alkyl group which may have a substituent, a linear, branched, or cyclic alkenyl group which may have a substituent, an aromatic ring which may have a substituent, or a heteroaromatic ring which may have a substituent.

<2> The positive type planographic printing plate precursor according to <1>, in which the polymer compound 1 further comprises a polycyclic structure in the main chain.

<3> The positive type planographic printing plate precursor according to <1> or <2>, in which the polymer compound 1 comprises a constitutional unit represented by the following Formula A-1 as a constitutional unit comprising the sulfonamide group.

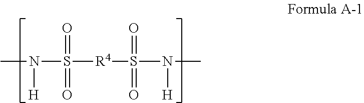

In Formula A-1, R⁴ represents a divalent linking group.

<4> The positive type planographic printing plate precursor according to <3>, in which the constitutional unit represented by Formula A-1 comprises a constitutional unit represented by any of the following Formulae B1-1 to B1-6.

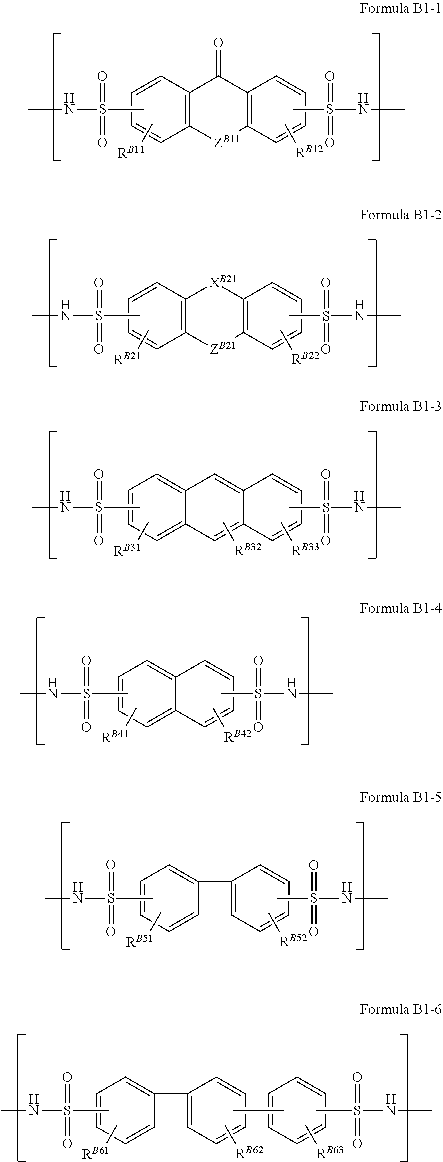

In Formulae B-1 to B1-6, each of R^{B11}, R^{B12}, R^{B21}, R^{B22}, R^{B31} to R^{B33}, R^{B41}, R^{B42}, R^{B51}, R^{B52}, and R^{B61} to R^{B63} independently represents a hydrogen atom, a sulfonamide group, a hydroxy group, a carboxy group, an alkyl group, or a halogen atom, Z^{B11} represents —C(R)₂—, —C(═O)—, —O—, —NR—, —S—, or a single bond, Z^{B21} represents —C(R)₂—, —O—, —NR—, —S—, or a single bond, each of R's independently represents a hydrogen atom or an alkyl group, X^{B21} represents —C(R′)₂—, —O—, —NR′—, —S—, or a single bond, and each of R's independently represents a hydrogen atom or an alkyl group.

<5> The positive type planographic printing plate precursor according to <3>, in which the constitutional unit represented by Formula A-1 comprises a constitutional unit represented by the following Formula B1-1 or B1-2.

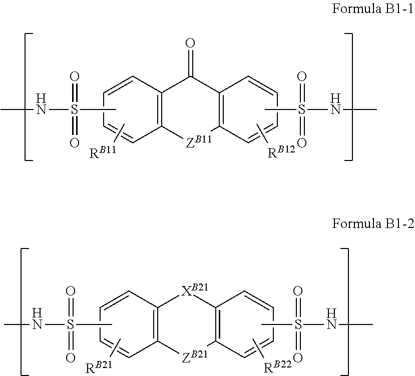

In Formula B1-1 or B1-2, each of R^{B11}, R^{B12}, R^{B21}, and R^{B22} independently represents a hydrogen atom, a sulfonamide group, a hydroxy group, a carboxy group, an alkyl group, or a halogen atom, Z^{B11} represents —C(R)₂—, —C(═O)—, —O—, —NR—, —S—, or a single bond, Z^{B21} represents —C(R)₂—, —O—, —NR—, —S—, or a single bond, each of R's independently represents a hydrogen atom or an alkyl group, X^{B21} represents —C(R′)₂—, —O—, —NR′—, —S—, or a single bond, and each of R's independently represents a hydrogen atom or an alkyl group.

<6> The positive type planographic printing plate precursor according to any one of <1> to <4>, in which the image recording layer comprises the polymer compound 2-2, and the polymer compound 2-2 is a polymer compound 2-2 represented by the following Formula VA.

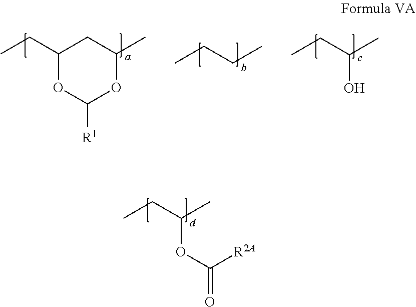

In Formula VA, R¹ represents an aromatic ring or heteroaromatic ring which contains at least one hydroxy group, R^{2A} represents an alkyl group which may have a substituent, a represents 10% to 55% by mole, b represents 15% to 60% by mole, c represents 10% to 60% by mole, and d represents 0% to 10% by mole.

<7> The positive type planographic printing plate precursor according to any one of <1> to <6>, comprising a recording layer comprising a lower layer and an upper layer in this order on the support having a hydrophilic surface, in which at least one of the lower layer or the upper layer is the image recording layer.

<8> The positive type planographic printing plate precursor according to <7>, in which the lower layer is the image recording layer, and the upper layer is another recording layer.

<9> The positive type planographic printing plate precursor according to any one of <1> to <8>, further comprising: an undercoat layer which is provided between the support having a hydrophilic surface and the image recording layer.

<10> A method of producing a planographic printing plate, comprising:

an exposure step of subjecting the positive type planographic printing plate precursor according to any one of <1> to <9> to image-wise light exposure; and

a development step of subjecting the exposed positive type planographic printing plate precursor to development using an alkali aqueous solution having a pH of 8.5 to 13.5.

According to an embodiment of the present invention, it is possible to provide a positive type planographic printing plate precursor from which a planographic printing plate with excellent chemical resistance and printing durability is obtained and which has high temporal stability after exposure.

Further, according to another embodiment of the present invention, it is possible to provide a method of producing a planographic printing plate obtained by using the positive type planographic printing plate precursor.

### DESCRIPTION OF THE PREFERRED EMBODIMENTS

Hereinafter, the contents of the present disclosure will be described in detail. The description of constituent elements below is made based on representative embodiments of the present disclosure in some cases, but the present disclosure is not limited to such embodiments.

Further, in the specification of the present application, the numerical ranges shown using “to” indicate ranges including the numerical values described before and after “to” as the lower limit values and the upper limit values.

In the specification of the present application, in a case where substitution or unsubstitution is not noted in regard to the notation of a group (atomic group), the group includes not only a group that does not have a substituent but also a group having a substituent. For example, the concept of an “alkyl group” includes not only an alkyl group that does not have a substituent (unsubstituted alkyl group) but also an alkyl group having a substituent (substituted alkyl group).

In addition, in the present disclosure, “% by mass” has the same definition as that for “% by weight” and “part(s) by mass” has the same definition as that for “part(s) by weight”.

Further, in the present disclosure, a combination of two or more preferred aspects is a more preferred aspect.

Further, in the present disclosure, the “main chain” indicates the relatively longest bonding chain in a molecule of a polymer compound constituting a resin, and a “side chain” indicates a molecular chain branched from the main chain.

Further, the weight-average molecular weight (Mw) and the number average molecular weight (Mn) according to the present disclosure indicate a molecular weight obtained by performing detection using a gel permeation chromatography (GPC) analyzer, for which TSKgel GMHxL, TSKgel G4000HxL, and TSKgel G2000HxL (all trade names, manufactured by Tosoh Corporation) are used as columns, tetrahydrofuran (THF) as a solvent, and a differential refractometer and by performing conversion using polystyrene as a standard substance, unless otherwise specified.

In the present disclosure, a “group which may have a substituent” indicates both of a group which has a substituent and a group which does not have a substituent. For example, an alkyl group which may have a substituent includes both of an alkyl group which has a substituent and an alkyl group which does not have a substituent.

Hereinafter, the present disclosure will be described in detail.

(Positive Type Planographic Printing Plate Precursor)

A positive type planographic printing plate precursor according to the embodiment of the present disclosure (hereinafter, also simply referred to as a “planographic printing plate precursor”) includes a support which has a hydrophilic surface (hereinafter, also simply referred to as a “support”); and an image recording layer which contains a polymer compound 1 having at least one bond selected from the group consisting of a urea bond, a urethane bond, and a carbonate bond in the main chain and containing a sulfonamide group in the main chain, a polymer compound 2-1 having at least one of a constitutional unit represented by Formula S-1 or a constitutional unit represented by Formula S-2 or a polymer compound 2-2 having a constitutional unit represented by Formula EV-1 and a constitutional unit represented by Formula EV-2, and an infrared absorbent, on the support.

The positive type planographic printing plate precursor according to the embodiment of the present disclosure may have the image recording layer on the support, and the support and the image recording layer are in contact with each other or another layer (for example, an undercoat layer) is provided between the support and the image recording layer.

As the result of intensive research conducted by the present inventors, it was found that a positive type planographic printing plate precursor from which a planographic printing plate with excellent chemical resistance and printing durability is obtained and which has high temporal stability after exposure is obtained by employing the above-described configuration.

The mechanism for obtaining the excellent effect by employing the above-described configuration is not clear, but can be assumed as follows.

It is considered that a sulfonamide group or phenolic hydroxyl group in a side chain which is contained in the polymer compound 2-1 or 2-2 easily interacts with the sulfonamide group contained in the main chain of the polymer compound 1 because the sulfonamide group or phenolic hydroxyl group has less steric hindrance.

Accordingly, it is speculated that the printing durability and the chemical resistance become excellent because the interaction between resins is strengthened and the strength of an image area of a printing plate to be obtained is improved, compared to a case where the polymer compound 1 is contained alone or a case where the polymer compound 2-1 or 2-2 is contained alone.

Further, it is considered that, in a case where the image recording layer contains two kinds of polymer compounds, which are the polymer compound 1 and the polymer compound 2-1 or the polymer compound 2-2, the interaction between low-molecular components such as an infrared absorbent and polymer compounds is dispersed in these two kinds of polymer compounds so that recovery of the interaction after exposure is effectively suppressed.

Therefore, it is speculated that the temporal stability of the positive type planographic printing plate precursor after exposure is increased (in other words, “the burnability is excellent”).

<Image Recording Layer>

The planographic printing plate precursor according to the embodiment of the present disclosure includes an image recording layer which contains a polymer compound 1 having at least one bond selected from the group consisting of a urea bond, a urethane bond, and a carbonate bond in a main chain and containing a sulfonamide group in the main chain, a polymer compound 2-1 having at least one of a constitutional unit represented by Formula S-1 or a constitutional unit represented by Formula S-2 or a polymer compound 2-2 having a constitutional unit represented by Formula EV-1 and a constitutional unit represented by Formula EV-2, and an infrared absorbent.

The image recording layer can be formed by, for example, dissolving each component contained in the image recording layer in a solvent and coating the support with the solvent.

Examples of the solvent to be used here include ethylene dichloride, cyclohexanone, methyl ethyl ketone, methanol, ethanol, propanol, ethylene glycol monomethyl ether, 1-methoxy-2-propanol, 2-methoxy ethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone, and toluene, but the present invention is not limited to these examples. These solvents may be used alone or in the form of a mixture.

Hereinafter, each component contained in the image recording layer will be described in detail.

[Polymer Compound 1]

The polymer compound 1 is a polymer compound which has at least one bond selected from the group consisting of a urea bond, a urethane bond, and a carbonate bond in the main chain and contains a sulfonamide group in the main chain,

—Urea Bond, Urethane Bond, and Carbonate Bond—

The polymer compound 1 used in the present disclosure has at least one selected from the group consisting of a urea bond, a urethane bond, and a carbonate bond in the main chain.

Further, it is preferable that the main chain skeleton of the polymer compound 1 used in the present disclosure is at least one selected from the group consisting of a urea bond, a urethane bond, and a carbonate bond.

As the main chain skeleton of the polymer compound 1, a urethane bond is preferable from the viewpoint of achieving the image formability, the printing durability, and the manufacturing suitability, and a urea bond is preferable from the viewpoint of achieving the chemical resistance, the printing durability, and the developability.

The urea bond, the urethane bond, and the carbonate bond contained in the main chain of the polymer compound 1 according to the present disclosure are each a bond represented by the following chemical formula.

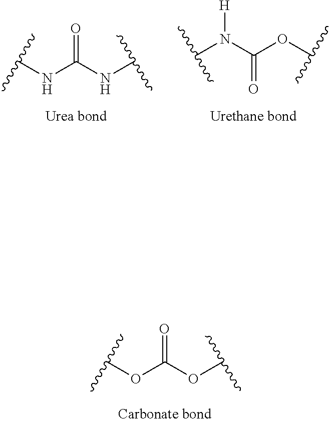 [SMILES: *NC(=O)N* ; *NC(=O)O* ; *OC(=O)O*]

—Acid Group in Main Chain or Side Chain—

The polymer compound 1 contains a sulfonamide group in the main chain.

It is preferable that the polymer compound 1 contains another acid group in a side chain. As the acid group in a side chain, a phenolic hydroxyl group, a sulfonamide group, or a carboxy group is preferable.

Further, the polymer compound corresponding to the polymer compound 2-1 or the polymer compound 2-2, that is, the polymer compound having at least one of a constitutional unit represented by Formula S-1 or a constitutional unit represented by Formula S-2 and the polymer compound having a constitutional unit represented by Formula EV-1 and a constitutional unit represented by Formula EV-2 are set to those that do not correspond to the polymer compound 1.

—Polycyclic Structure—

From the viewpoints of the printing durability and the chemical resistance, it is preferable that the polymer compound 1 further has a polycyclic structure in the main chain.

The polycyclic structure indicates a fused cyclic hydrocarbon structure, a fused polycyclic aromatic structure, or a structure formed by a plurality of aromatic hydrocarbons being bonded through a single bond. As the polycyclic structure, a naphthalene derivative structure, an anthracene derivative structure, a biphenyl structure, or a terphenyl structure is preferable. Among examples of the naphthalene derivative structure and the anthracene derivative structure, a naphthalene structure, a xanthone structure, an anthrone structure, a xanthene structure, a dihydroanthracene structure, and an anthracene structure are preferable, and from the viewpoints of the chemical resistance, the printing durability, and the developability, a xanthone structure, an anthrone structure, a biphenyl structure, and a naphthalene structure are more preferable, and a xanthone structure and an anthrone structure are still more preferable.

—Constitutional Unit Represented by Formula A-1—

It is preferable that the polymer compound 1 used in the present disclosure has a constitutional unit represented by Formula A-1 as the constitutional unit containing a sulfonamide group.

Two sulfonamide groups contained in Formula A-1 are each a sulfonamide group contained in the polymer compound 1 in the main chain.

In a case where the polymer compound 1 has a constitutional unit represented by Formula A-1, since the acid value of the polymer compound 1 is increased in the structure thereof, a positive type planographic printing plate precursor having excellent developability is obtained.

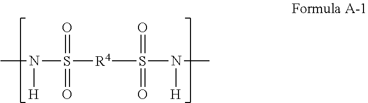

In Formula A-1, R⁴ represents a divalent linking group, preferably a divalent linking group having the above-described polycyclic structure or a divalent linking group having a phenylene group, and more preferably a divalent linking group having the above-described polycyclic structure from the viewpoint of the printing durability.

The content of the constitutional unit represented by Formula A-1 in the polymer compound 1 according to the present disclosure is preferably in a range of 10% to 90% by mass, more preferably in a range of 30% to 80% by mass, and still more preferably in a range of 50% to 75% by mass with respect to the total mass of the polymer compound 1.

—Divalent Linking Group Containing Phenylene Group—

As the divalent linking group containing a phenylene group, a phenylene group or a group represented by Formula Ph-1 is preferable.

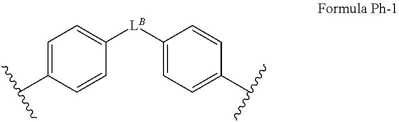

In Formula Ph-1, L^{B} represents an ether bond (—O—) or a sulfonyl group (—S(═O)₂—), and wavy line parts each represent a bonding site with respect to a sulfur atom of the sulfonamide group in Formula A-1.

In a case where R⁴ represents a phenylene group, it is preferable that two sulfonamide groups in Formula A-1 are bonded to the phenylene group so as to be the meta-position.

Further, the phenylene group may be substituted. Examples of the substituent include an alkyl group, a hydroxy group, and a halogen atom. Among these, an alkyl group is preferable. As the alkyl group, an alkyl group having 1 to 8 carbon atoms is preferable, an alkyl group having 1 to 4 carbon atoms is more preferable, and a methyl group is still more preferable.

—Constitutional Unit Represented by Formulae B1-1 to B1-6—

It is preferable that the constitutional unit represented by Formula A-1 contains a constitutional unit represented by any of Formulae B1-1 to B1-6 and more preferable that the constitutional unit represented by Formula A-1 contains a constitutional unit represented by Formula B1-1 or B1-2.

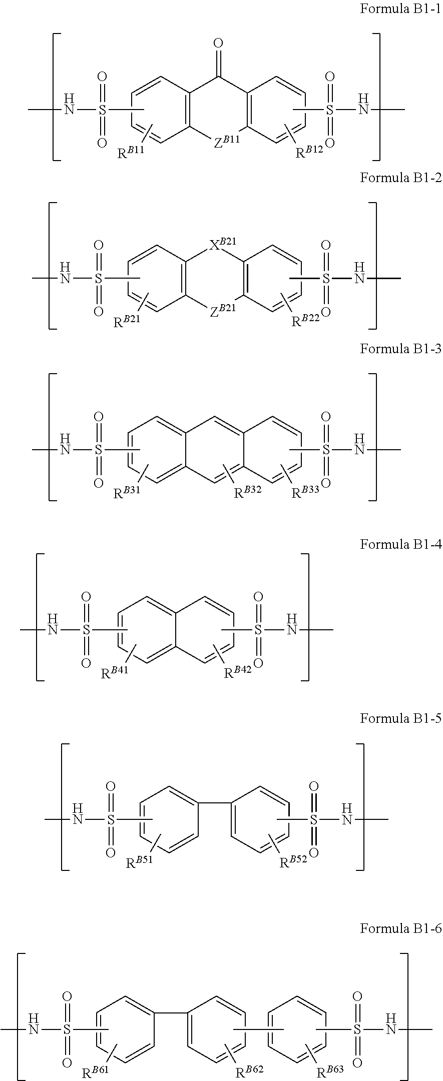

In Formulae B-1 to B1-6, each of R^{B11}, R^{B12}, R^{B21}, R^{B22}, R^{B31} to R^{B33}, R^{B41}, R^{B42}, R^{B51}, R^{B52}, and R^{B61} to R^{B63} independently represents a hydrogen atom, a sulfonamide group, a hydroxy group, a carboxy group, an alkyl group, or a halogen atom, Z^{B11} represents —C(R)₂—, —C(═O)—, —O—, —NR—, —S—, or a single bond, Z^{B21} represents —C(R)₂—, —O—, —NR—, —S—, or a single bond, each of R's independently represents a hydrogen atom or an alkyl group, X^{B21} represents —C(R′)₂—, —O—, —NR′—, —S—, or a single bond, and each of R's independently represents a hydrogen atom or an alkyl group.

In Formulae B1-1 to B1-6, each of R^{B}11, R^{B12}, R^{B21}, R^{B22}, R^{B31} to R^{B33}, R^{B41}, R^{B42}, R^{B51}, R^{B52}, and R^{B61} to R^{B63} independently represents a hydrogen atom, a sulfonamide group, a hydroxyl group, a carboxy group, an alkyl group, or a halogen atom, preferably a hydrogen atom, an alkyl group, or a halogen atom, and more preferably a hydrogen atom. From the viewpoint of improving the developability, an acid group such as a sulfonamide group, a hydroxyl group, or a carboxy group is preferable.

In Formulae B1-1 to B1-6, each of Z^{B11} and Z^{B21} independently represents —C(R)₂—, —O—, —NR—, —S—, or a single bond, preferably —C(R)₂— or —O—, and more preferably —O—.

In Formulae B1-1 to B1-6, R represents a hydrogen atom or an alkyl group and preferably a hydrogen atom.

In Formulae B1-1 to B1-6, X^{B21} represents —C(R′)₂—, —O—, —NR′—, —S—, or a single bond and preferably —C(R′)₂—.

In Formulae B1-1 to B1-6, R represents a hydrogen atom or an alkyl group and preferably a hydrogen atom.

The content of the structure represented by any of Formulae B1-1 to B1-6 in the polymer compound 1 according to the present disclosure is preferably in a range of 10% to 90% by mass, more preferably in a range of 30% to 80% by mass, and still more preferably in a range of 50% to 75% by mass with respect to the total mass of the polymer compound 1.

—Constitutional Unit Represented by Formula A-2—

It is preferable that the polymer compound 1 used in the present disclosure has a constitutional unit represented by formula A-2 as the constitutional unit containing a sulfonamide group.

Both of two sulfonamide groups contained in Formula A-2 are sulfonamide groups contained in the polymer compound 1 in the main chain thereof.

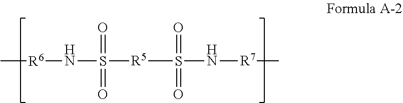

In Formula A-2, each of R⁵ to R⁷ independently represents a divalent linking group.

In Formula A-2, R⁵ has the same definition as that for R⁴ in Formula A-1 and the preferable aspects thereof are the same as described above.

In Formula A-2, each of R⁶ and R⁷ independently represents a divalent linking group, preferably an alkylene group, an arylene group, or a divalent saturated alicyclic hydrocarbon group, a divalent unsaturated alicyclic hydrocarbon group, or a divalent group formed by a plurality of these groups being linked to one another, and more preferably an alkylene group or an arylene group.

As the alkylene group, an alkylene group having 1 to 20 carbon atoms is preferable, an alkylene group having 2 to 15 carbon atoms is more preferable, and an alkylene group having 2 to 8 carbon atoms is still more preferable. Further, the alkylene group may contain oxygen atoms in a carbon chain. Examples of the substituent which may be included in the alkylene group include an alkyl group, an aryl group, and a halogen atom.

As the arylene group, an arylene group having 6 to 20 carbon atoms is preferable, a phenylene group or a naphthylene group is more preferable, and a phenylene group is still more preferable. The arylene group may contain heteroatoms in a ring structure, and examples of the heteroatom include an oxygen atom, a nitrogen atom, and a sulfur atom.

As the divalent saturated alicyclic hydrocarbon group, a divalent saturated alicyclic hydrocarbon group having 4 to 10 carbon atoms is preferable, a divalent saturated alicyclic hydrocarbon group having 4 to 8 carbon atoms is more preferable, and a divalent saturated alicyclic hydrocarbon group having 6 to 8 carbon atoms is still more preferable. Further, examples of the substituent which may be contained in the divalent saturated alicyclic hydrocarbon group include an alkyl group, an aryl group, and a halogen atom.

As the divalent unsaturated alicyclic hydrocarbon group, a cyclopentenyl group, a cyclopentadienyl group, a cyclohexenyl group, a cyclohexadienyl group, and a cycloheptenyl group are exemplified.

As the divalent group formed by a plurality of these groups being linked to one another, a group in which a plurality of alkylene groups and arylene groups or a plurality of alkylene groups and divalent saturated alicyclic hydrocarbon groups are bonded is preferable and a group in which an alkylene group, an arylene group, and an alkylene group or an alkylene group, a divalent saturated alicyclic hydrocarbon group, and an alkylene group are bonded in this order is preferable.

—Constitutional Units Represented by Formulae B2-1 to B2-6—

It is preferable that the constitutional unit represented by Formula A-2 contains a constitutional unit represented by any of Formulae B2-1 to B2-6 and more preferable that the constitutional unit represented by Formula A-2 contains a constitutional unit represented by Formula B2-1 or B2-2.

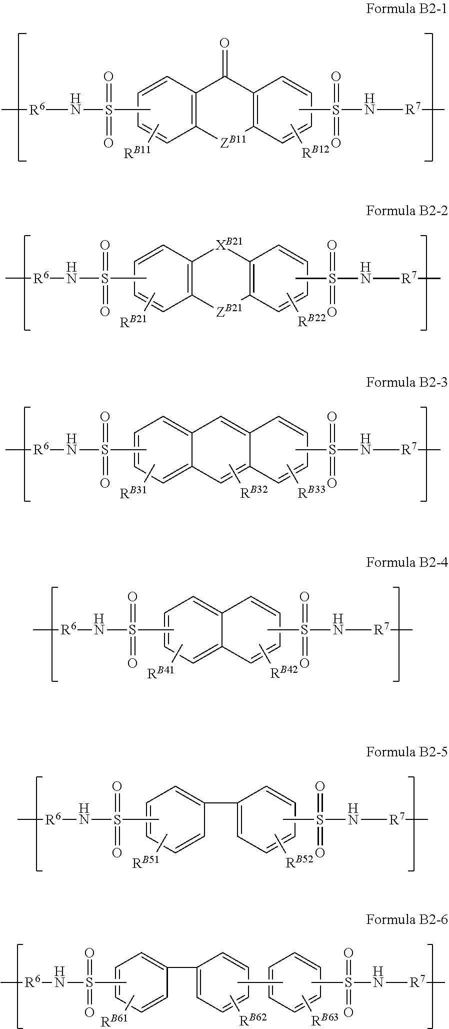

In Formulae B2-1 to B2-6, R6 and R7 each have the same definition as that for R6 and R7 in Formula A-2 and the preferable aspects thereof are the same as described above.

In Formulae B2-1 to B2-6, R^{B11}, R^{B12}, R^{B21}, R^{B22}, R^{B31}, R^{B33}, R^{B41}, R^{B42}, R^{B51}, R^{B52}, R^{B61} to R^{B63}, Z^{B11}, Z^{B21}, and X^{B21} each have the same definition as that for R^{B11}, R^{B12}, R^{B21}, R^{B22}, R^{B31}, R^{B33}, R^{B41}, R^{B42}, R^{B51}, R^{B52}, R^{B61}, R^{B63}, Z^{B11}, Z_{B21}, and X^{B21} in Formulae B1-1 to B1-6 and the preferable aspects thereof are the same as described above.

From the viewpoint of the developability of the planographic printing plate to be obtained, the content of the constitutional unit represented by Formula A-2 in the polymer compound 1 used in the present disclosure is preferably in a range of 10% to 90% by mass, more preferably in a range of 20% to 80% by mass, and still more preferably in a range of 30% to 70% by mass with respect to the total mass of the polymer compound 1.

It is preferable that the constitutional unit represented by Formula A-2 is a constitutional unit derived from a specific diamine compound containing a sulfonamide group described below in the main chain or a specific diol compound containing a sulfonamide group in the main chain.

—Alkyleneoxy Group—

It is preferable that the polymer compound 1 used in the present disclosure further contains an alkyleneoxy group in the main chain.

According to the above-described embodiment, it is possible to obtain a planographic printing plate precursor from which a planographic printing plate with excellent image formability and excellent printing durability is obtained.

As the alkyleneoxy group, an alkyleneoxy group having 2 to 10 carbon atoms is preferable, an alkyleneoxy group having 2 to 8 carbon atoms is more preferable, an alkyleneoxy group having 2 to 4 carbon atoms is still more preferable, and an ethyleneoxy group or a propyleneoxy group is particularly preferable.

Further, the alkyleneoxy group may be a polyalkyleneoxy group.

As the polyalkyleneoxy group, a polyalkyleneoxy group having 2 to 50 repeating units is preferable, a polyalkyleneoxy group having 2 to 40 repeating units is more preferable, and a polyalkyleneoxy group having 2 to 30 repeating units is still more preferable.

The preferable number of carbon atoms in the repeating units constituting the polyalkyleneoxy group is the same as the preferable number of carbon atoms of the alkyleneoxy group.

—Example of Polymer Compound 1—

It is preferable that the polymer compound 1 used in the present disclosure is a polymer compound having a combination of constitutional units represented by any of Formulae D-1 to D-3.

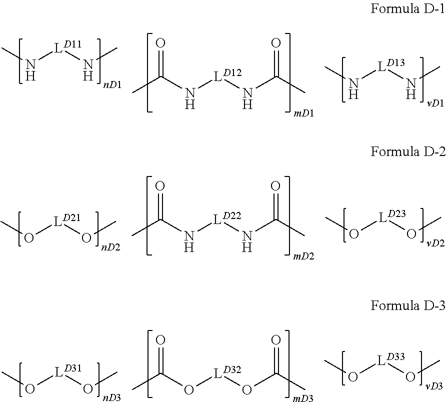

In Formulae D-1 to D-3, each of L^{D11}, L^{D21}, and L^{D31} independently represents a constitutional unit represented by Formula A-2 and the preferable aspects thereof are the same as described above.

In Formulae D-1 to D-3, each of L^{D12}, L^{D22}, and L^{D32} independently represents an alkylene group, an arylene group, a carbonyl group, a sulfonyl group, an amide bond, a urethane bond, a single bond, or a linking group formed by two or more of these bonds being bonded to each other, preferably an alkylene group having 1 to 20 carbon atoms, an arylene group having 6 to 20 carbon atoms, a carbonyl group, a sulfonyl group, an amide bond, a urethane bond, a single bond, or a linking group formed by two or more of these bonds being bonded to each other, more preferably an alkylene group having 1 to 15 carbon atoms, a phenylene group, a naphthylene group, a carbonyl group, a sulfonyl group, an amide bond, a urethane bond, a single bond, or a linking group formed by two or more of these bonds being bonded to each other, and still more preferably an alkylene group having 1 to 15 carbon atoms, a phenylene group, a naphthylene group, or a linking group formed by two or more of these bonds being bonded to each other.

In Formulae D-1 to D-3, each of L^{D13}, L^{D23}, and L^{D33} independently represents an alkylene group, an alkyleneoxy group, an arylene group, a carbonyl group, a sulfonyl group, an amide bond, a urethane bond, a single bond, or a linking group formed by two or more of these bonds being bonded to each other, preferably an alkylene group having 1 to 20 carbon atoms, an alkyleneoxy group having 2 to 10 carbon atoms, an arylene group having 6 to 20 carbon atoms, a carbonyl group, a sulfonyl group, an amide bond, a urethane bond, a single bond, or a linking group formed by two or more of these bonds being bonded to each other, more preferably an alkylene group having 1 to 15 carbon atoms, an alkyleneoxy group having 2 to 8 carbon atoms, a phenylene group, a naphthylene group, a carbonyl group, a sulfonyl group, an amide bond, a urethane bond, a single bond, or a linking group formed by two or more of these bonds being bonded to each other, and still more preferably an alkylene group having 1 to 15 carbon atoms, an alkyleneoxy group having 2 to 4 carbon atoms, a phenylene group, a naphthylene group, or a linking group formed by two or more of these bonds being bonded to each other.

Further, the alkyleneoxy group may form a polyalkyleneoxy group. As the polyalkyleneoxy group, a polyalkyleneoxy group having 2 to 50 repeating units is preferable, a polyalkyleneoxy group having 2 to 40 repeating units is more preferable, and a polyalkyleneoxy group having 2 to 30 repeating units is still more preferable. The preferable number of carbon atoms in the repeating units constituting the polyalkyleneoxy group is the same as the preferable number of carbon atoms of the alkyleneoxy group.

In a case where L^{D13}, L^{D23} or L^{D33} represents an alkyleneoxy group, it is possible to obtain a positive type planographic printing plate precursor from which a planographic printing plate with excellent image formability and excellent printing durability is obtained.

In Formula D-1, nD1, mD1, and vD1 represent a content ratio (mass ratio) in a case where the total mass of molecules of the polymer compound 1 is set to 100, and nD1:mD1:vD1 is preferably in a range of 90:10:0 to 30:60:10 and more preferably in a range of 80:20:0 to 60:30:10. Further, the total value of nD1 and mD1 is preferably 90 or greater and more preferably 95 or greater. The total value of nD1, mD1, and vD1 is preferably 90 or greater, more preferably 95 or greater, and still more preferably 98 or greater.

In Formula D-2, nD2, mD2, and vD2 represent a content ratio (mass ratio) in a case where the total mass of molecules of the polymer compound 1 is set to 100, and nD2:mD2:vD2 is preferably in a range of 90:10:0 to 30:60:10 and more preferably in a range of 80:20:0 to 60:30:10. Further, the total value of nD2 and mD2 is preferably 90 or greater and more preferably 95 or greater. The total value of nD2, mD2, and vD2 is preferably 90 or greater, more preferably 95 or greater, and still more preferably 98 or greater.

In Formula D-3, nD3, mD3, and vD3 represent a content ratio (mass ratio) in a case where the total mass of molecules of the polymer compound 1 is set to 100, and nD3:mD3:vD3 is preferably in a range of 90:10:0 to 30:60:10 and more preferably in a range of 80:20:0 to 60:30:10. Further, the total value of nD3 and mD3 is preferably 90 or greater and more preferably 95 or greater. The total value of nD3, mD3, and vD3 is preferably 90 or greater, more preferably 95 or greater, and still more preferably 98 or greater.

The compound having a combination of a plurality of constitutional units represented by Formula D-1 can be produced by a sequential polymerization reaction of a diamine compound formed by an amino group being bonded to both terminals of the structure represented by L^{D11}, a diisocyanate compound formed by an isocyanate group being bonded to both terminals of the structure represented by L^{D12}, and optionally a diamine compound formed by an amino group being bonded to a terminal of the structure represented by L^{D13}.

The terminal of the compound having a combination of a plurality of constitutional units represented by Formula D-1 is not particularly limited, is typically an amino group or an isocyanate group, and may be blocked by a known terminal blocking agent such as a monoamine, a monoalcohol, or a monoisocyanate.

The compound having a combination of a plurality of constitutional units represented by Formula D-2 can be produced by a sequential polymerization reaction of a diol compound formed by a hydroxy group being bonded to both terminals of the structure represented by L^{D21}, a diisocyanate compound formed by an isocyanate group being bonded to both terminals of the structure represented by L^{D22}, and optionally a diol compound formed by a hydroxy group being bonded to a terminal of the structure represented by LD²³.

The terminal of the compound having a combination of a plurality of constitutional units represented by Formula D-2 is not particularly limited, is typically a hydroxy group or an isocyanate group, and may be blocked by a known terminal blocking agent such as a monoamine, a monoalcohol, or a monoisocyanate.

The compound having a combination of a plurality of constitutional units represented by Formula D-3 can be produced by a sequential polymerization which is carried out using a compound containing a carbonate group such as alkyl carbonate and which occurs between a diol compound formed by a hydroxy group being bonded to both terminals of the structure represented by L^{D41}, a diol compound formed by a hydroxy group being bonded to both terminals of the structure represented by L^{D42}, and optionally a diol compound formed by a hydroxy group being bonded to a terminal of the structure represented by L^{D43}.

The terminal of the compound having a combination of a plurality of constitutional units represented by Formula D-3 is not particularly limited, is typically a hydroxy group, and may be blocked by a known terminal blocking agent such as a monoalcohol or a monoamine.

The weight-average molecular weight of the polymer compound 1 according to the present disclosure is preferably in a range of 10000 to 500000, more preferably in a range of 10000 to 200000, and still more preferably in a range of 20000 to 100000.

Hereinafter, the polymer compound 1 will be described based on specific examples.

—Polyurea Containing Sulfonamide Group in Main Chain—

As the polymer compound 1 used in the present disclosure, polyurea containing a sulfonamide group in the main chain is preferable.

The polyurea containing a sulfonamide group in the main chain is a polymer generated by a sequential polymerization reaction of a specific diamine compound containing a sulfonamide group in the main chain and a compound (diisocyanate compound) containing two or more isocyanate groups. Further, the polyurea is not particularly limited as long as the polyurea contains a sulfonamide group in the main chain.

Preferred examples of the specific diamine compound containing a sulfonamide group in the main chain include compounds SA-1 to SA-26 described below.

Further, the main chain of the diamine compound indicates a carbon chain serving as the main chain of a polymer compound in a case where a polymer compound such as polyurea is formed.

Specific preferred examples of the polyurea which can be used in the present disclosure are described below. Specific examples PU-1 to PU-20 indicate polymer compounds 1 formed by reacting a diamine compound containing a sulfonamide group described below in the main chain, a compound having two or more isocyanate groups, and optionally other diamine compounds at ratios (molar ratios) listed in the following table.

Further, the table shows molar ratios used for synthesis of polyureas and weight-average molecular weights (Mw) of obtained polyureas containing a sulfonamide group in the main chain, but the polyurea containing a sulfonamide group in the main chain which is used in the present disclosure is not limited to these.

In addition, the weight-average molecular weight of a polymer is a value measured according to the GPC method.

TABLE 1

| | Diamine | Diamine | Diisocyanate | Diisocyanate | |
|---|---|---|---|---|---|
| | compound-1 | compound-2 | compound-1 | compound-2 | Weight-average |
| Polymer | (molar ratio | (molar ratio | (molar ratio | (molar ratio | molecular weight |
| compound 1 | thereof contained) | thereof contained | thereof contained) | thereof contained) | (ten thousand) |
| PU-1 | SA-1 | — | HDI | — | 4.8 |
| | 50 | — | 50 | — | |
| PU-2 | SA-1 | — | MDI | — | 5.1 |
| | 50 | — | 50 | — | |
| PU-3 | SA-2 | — | HDI | — | 4.6 |
| | 50 | — | 50 | — | |
| PU-4 | SA-5 | — | H6-XDI | — | 4.9 |
| | 50 | — | 50 | — | |
| PU-5 | SA-7 | — | H6-XDI | — | 5.3 |
| | 50 | — | 50 | — | |
| PU-6 | SA-8 | — | H6-XDI | — | 6.5 |
| | 50 | — | 50 | — | |
| PU-7 | SA-11 | — | XDI | — | 4.2 |
| | 50 | — | 50 | — | |
| PU-8 | SA-11 | — | XDI | NBDI | 3.9 |
| | 50 | — | 25 | 25 | |
| PU-9 | SA-12 | — | NBDI | — | 5.5 |
| | 50 | — | 50 | — | |
| PU-10 | SA-13 | — | NBDI | — | 6.9 |
| | 50 | — | 50 | — | |
| PU-11 | SA-14 | — | H6-XDI | — | 7.1 |
| | 50 | — | 50 | — | |
| PU-12 | SA-15 | — | TDI | — | 10.5 |
| | 50 | — | 50 | — | |
| PU-13 | SA-22 | — | TDI | — | 5.3 |
| | 50 | — | 50 | — | |
| PU-14 | SA-23 | — | TDI | — | 6.9 |
| | 50 | — | 50 | — | |
| PU-15 | SA-23 | — | TDI | — | 5.5 |
| | 50 | — | 50 | — | |
| PU-16 | SA-23 | 6FAP | H6-XDI | — | 3.9 |
| | 40 | 10 | 50 | — | |
| PU-17 | SA-23 | DEGDAP | TDI | — | 9.2 |
| | 40 | 10 | 50 | — | |
| PU-18 | SA-24 | — | H6-XDI | — | 5.4 |
| | 50 | — | 50 | — | |
| PU-19 | SA-25 | — | H6-XDI | — | 6.2 |
| | 50 | — | 50 | — | |
| PU-20 | SA-26 | — | TDI | — | 8.5 |
| | 50 | — | 50 | — | |

The details of the compounds shown by using abbreviations in the table are as follows.

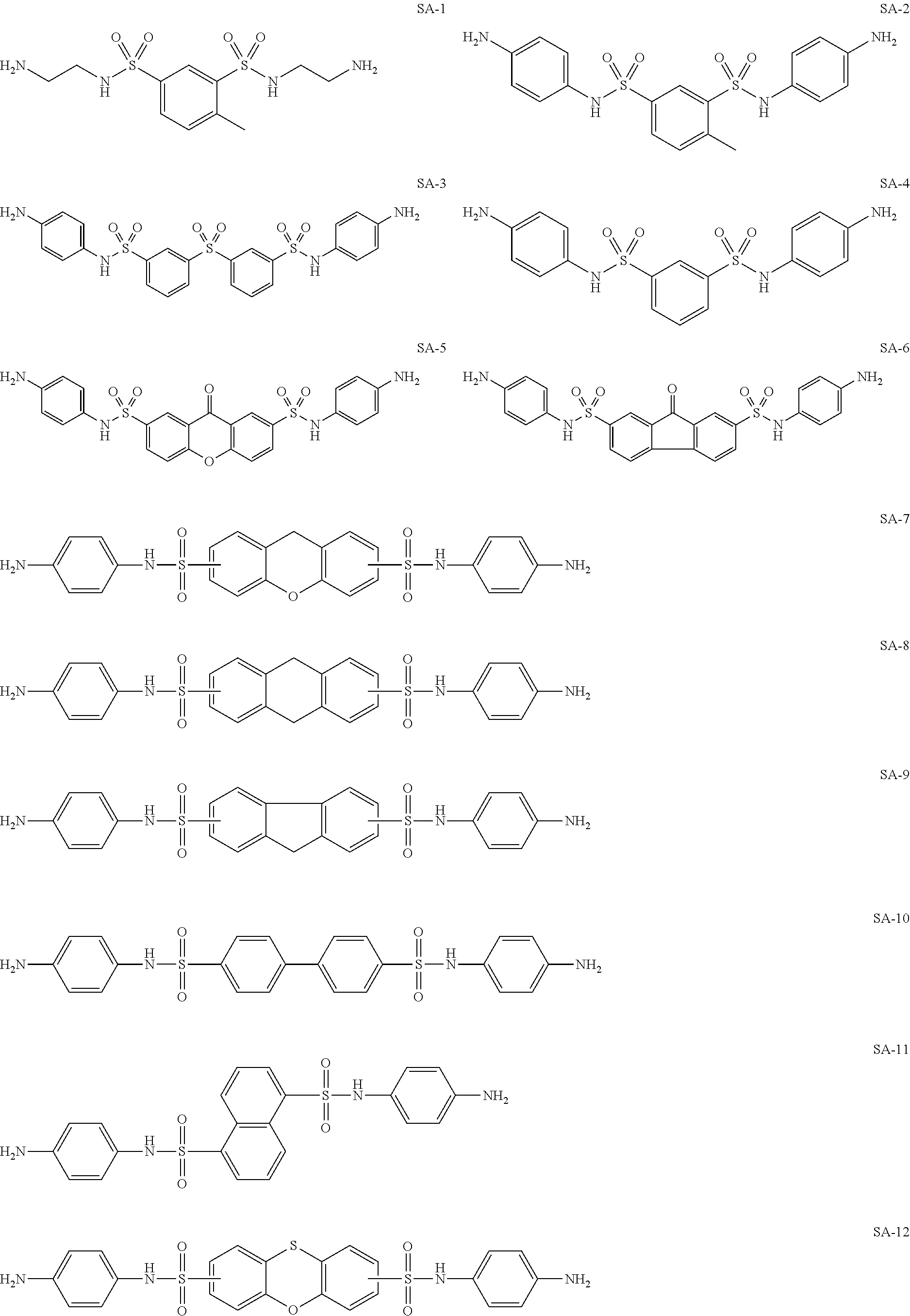

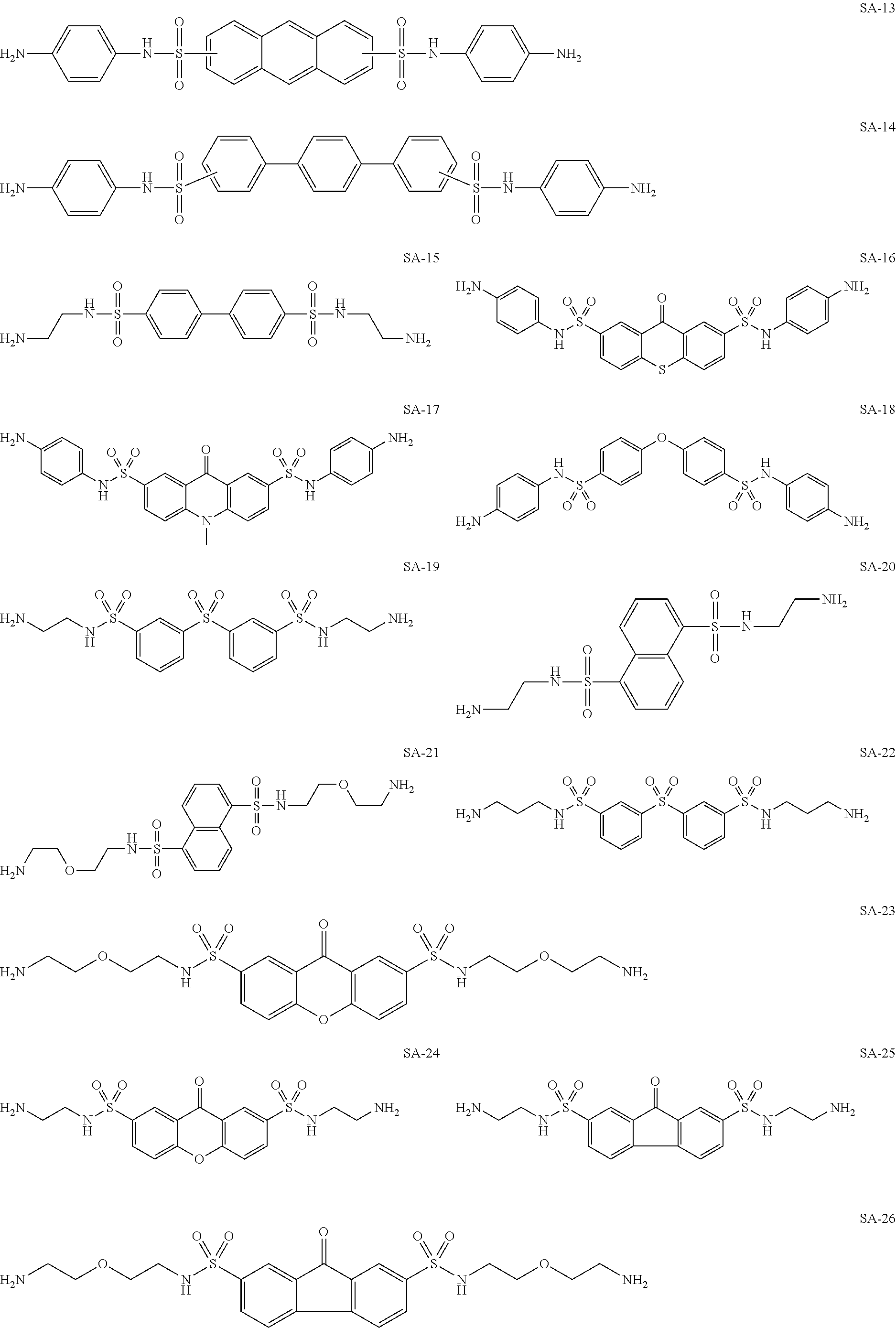

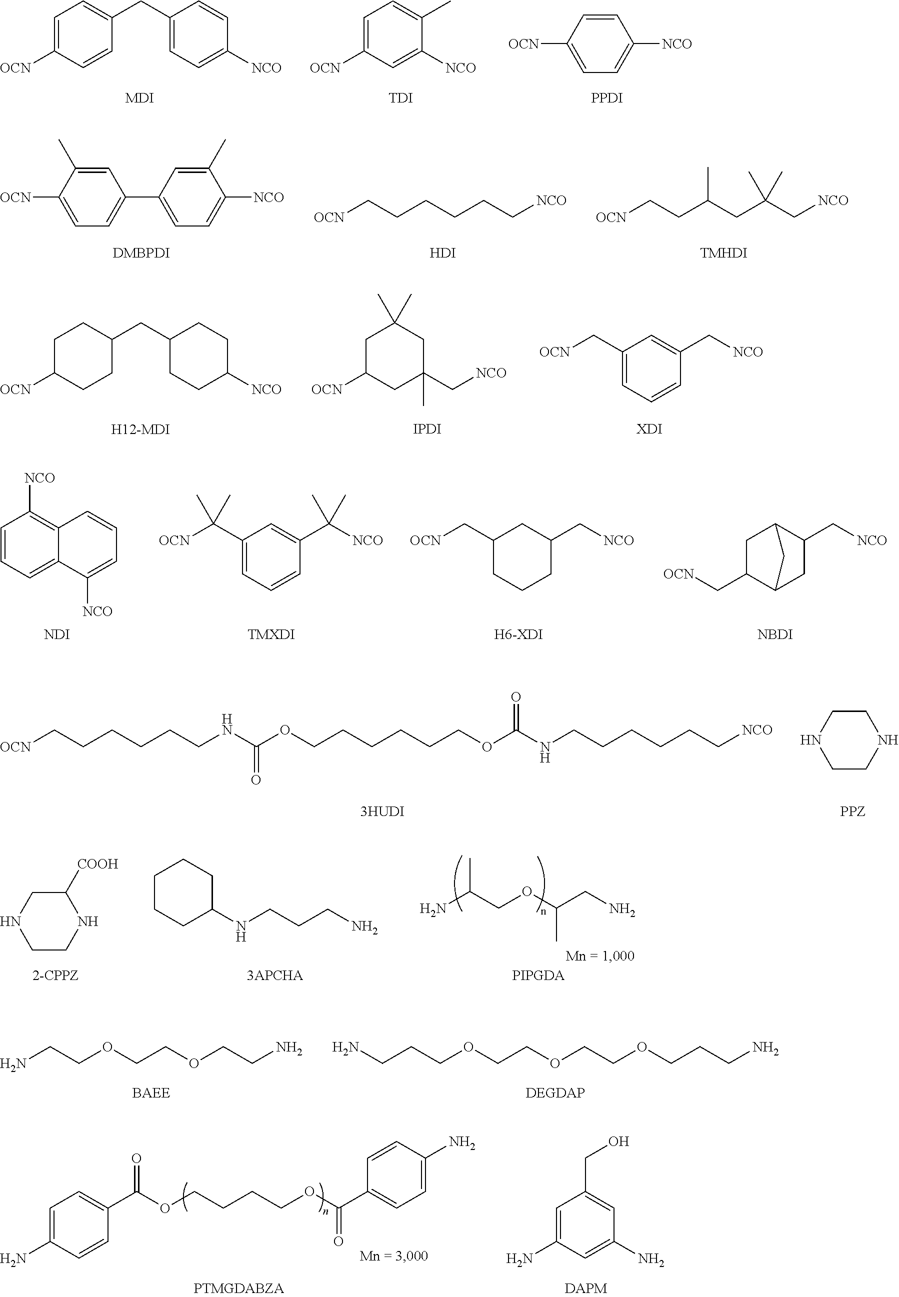

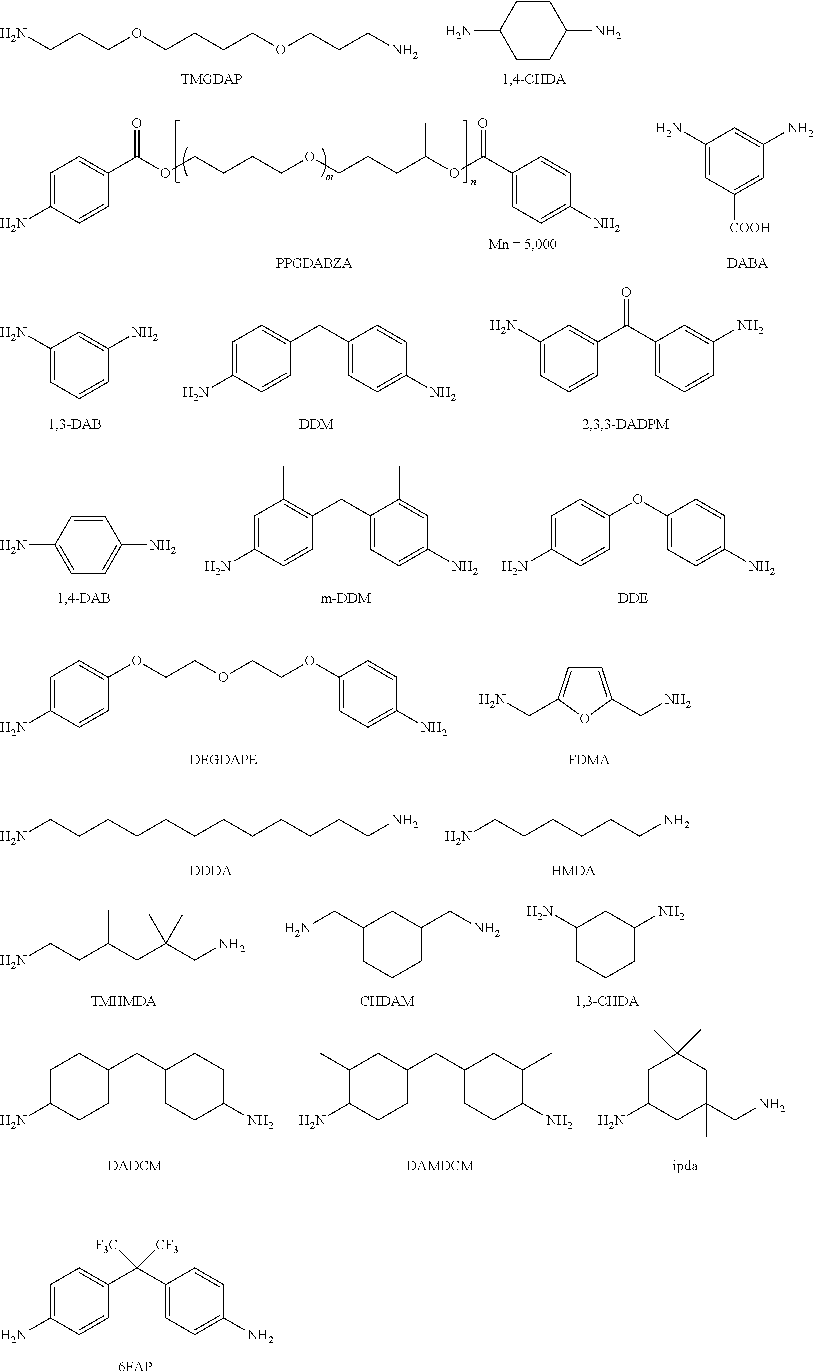

—Polyurethane Containing Sulfonamide Group in Main Chain—

As the polymer compound 1 used in the present disclosure, polyurethane containing a sulfonamide group in the main chain is preferable.

The polyurethane which is used in the present disclosure and contains a sulfonamide group in the main chain is a polymer generated by a sequential polymerization reaction of a specific diol compound containing a sulfonamide group in the main chain and a compound having two or more isocyanate groups. Further, the polyurethane is not particularly limited as long as the polyurethane contains a sulfonamide group in the main chain.

Preferred examples of the specific diol compound containing a sulfonamide group in the main chain include compounds SB-1 to SB-26 described below.

In addition, the main chain of the diol compound indicates a carbon chain serving as the main chain of a polymer compound in a case where a polymer compound such as polyurethane is formed.

Specific preferred examples of the polyurethane which can be used in the present disclosure are shown in the following table. Specific examples PT-1 to PT-20 indicate polymer compounds 1 formed by reacting a diol compound containing a sulfonamide group in the main chain and a compound having two or more isocyanate groups at ratios (molar ratios) listed in the following table.

In addition, the table shows molar ratios used for synthesis of polyurethanes and weight-average molecular weights (Mw) of obtained specific polyurethanes containing a sulfonamide group in the main chain, but the polyurethane containing a sulfonamide group in the main chain which is used in the present disclosure is not limited to these.

Moreover, the weight-average molecular weight of a polymer is a value measured according to the GPC method.

TABLE 2

| | | | Diisocyanate | Diisocyanate | |
|---|---|---|---|---|---|
| | Diol compound-1 | Diol compound-2 | compound-1 | compound-2 | Weight-average |
| Polymer | (molar ratio | (molar ratio | (molar ratio | (molar ratio | molecular weight |
| compound 1 | thereof contained) | thereof contained | thereof contained) | thereof contained) | (ten thousand) |
| PT-1 | SB-1 | — | MDI | — | 4.3 |
| | 50 | — | 50 | — | |
| PT-2 | SB-2 | — | MDI | TDI | 5.5 |
| | 50 | — | 40 | 10 | |
| PT-3 | SB-3 | — | H6-XDI | — | 6.2 |
| | 50 | — | 50 | — | |
| PT-4 | SB-4 | — | H6-XDI | — | 5.1 |
| | 50 | — | 50 | — | |
| PT-5 | SB-5 | — | H6-XDI | — | 5.8 |
| | 50 | — | 50 | — | |
| PT-6 | SB-10 | — | H6-XDI | — | 5.4 |
| | 50 | — | 50 | — | |
| PT-7 | SB-12 | — | H6-XDI | — | 4.4 |
| | 50 | — | 50 | — | |
| PT-8 | SB-17 | — | H6-XDI | — | 4.8 |
| | 50 | — | 50 | — | |
| PT-9 | SB-18 | — | H6-XDI | — | 4.3 |
| | 50 | — | 50 | — | |
| PT-10 | SB-19 | — | MDI | TDI | 4.3 |
| | 50 | — | 40 | 10 | |
| PT-11 | SB-20 | — | MDI | TDI | 6.9 |
| | 50 | — | 40 | 10 | |
| PT-12 | SB-20 | — | TDI | — | 4.5 |
| | 50 | — | 50 | — | |
| PT-13 | SB-23 | — | TDI | — | 4.7 |
| | 50 | — | 50 | — | |
| PT-14 | SB-23 | — | TDI | MDI | 5.5 |
| | 50 | — | 40 | 10 | |
| PT-15 | SB-23 | DO-9 | TDI | — | 5.1 |
| | 45 | 5 | 50 | — | |
| PT-16 | SB-23 | DO-10 | TDI | — | 4.6 |
| | 45 | 5 | 50 | — | |
| PT-17 | SB-26 | — | XDI | — | 5.5 |
| | 50 | — | 50 | — | |
| PT-18 | SB-26 | — | XDI | — | 11.3 |
| | 50 | — | 50 | — | |
| PT-19 | SB-26 | — | H6-XDI | — | 5.5 |
| | 50 | — | 50 | — | |
| PT-20 | SB-26 | DO-9 | H6-XDI | — | 6.3 |
| | 50 | 5 | 50 | — | |

Among the compounds shown by using abbreviations in the table, the details of compounds other than the above-described compounds are as follows.

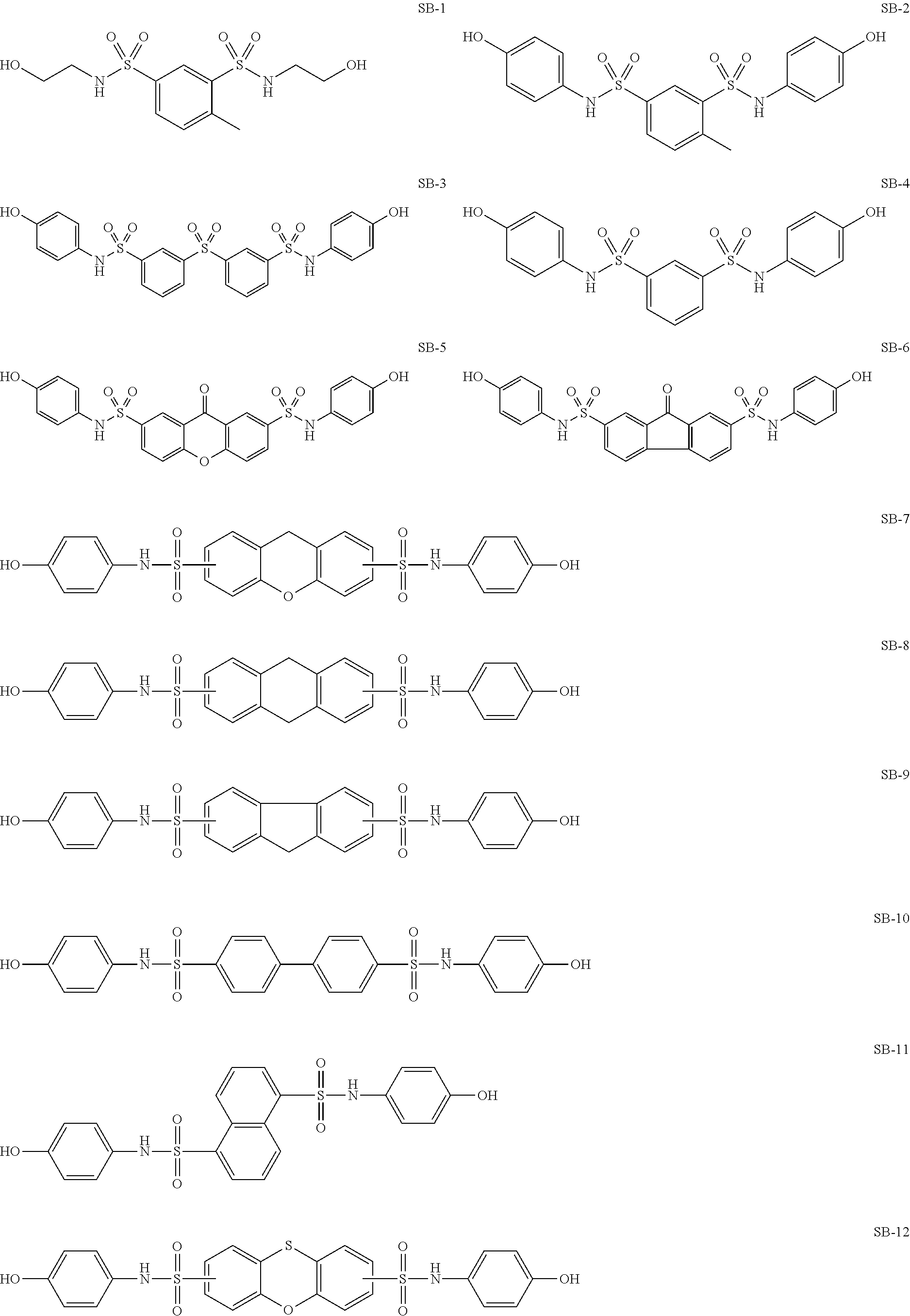

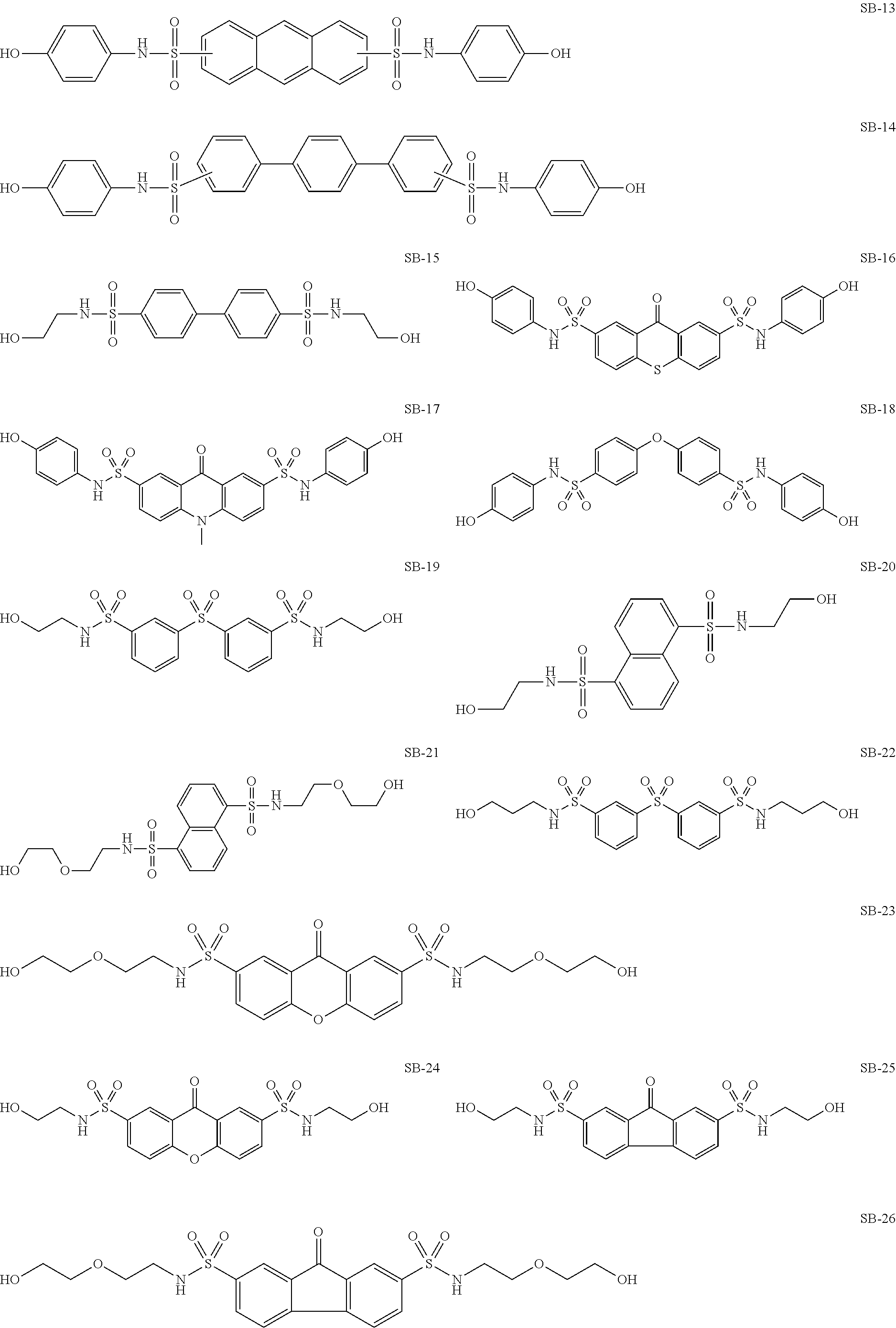

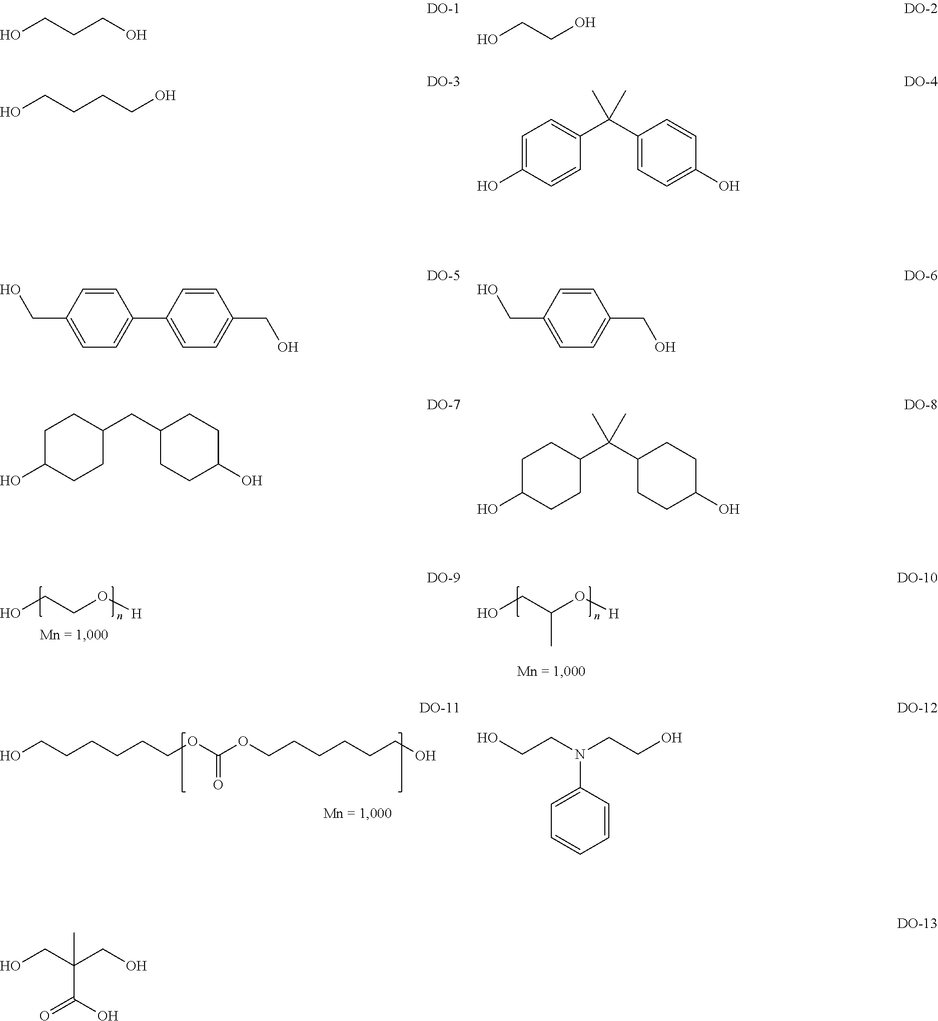

—Polycarbonate Containing Sulfonamide Group in Main Chain—

As the polymer compound 1 used in the present disclosure, polycarbonate containing a sulfonamide group in the main chain is preferable.

The polycarbonate which is used in the present disclosure and contains a sulfonamide group in the main chain is a polymer which is obtained by using a compound (for example, diethyl carbonate) containing a carbonate group such as alkyl carbonate and is generated by a sequential polymerization reaction of a diol compound and a diol compound containing a sulfonamide group in the main chain. Further, the polycarbonate is not particularly limited as long as the polycarbonate contains a sulfonamide group in the main chain.

Preferred examples of the diol compound containing a sulfonamide group in the main chain include compounds SB-1 to SB-26 described above.

TABLE 3

| | Diol compound-1 | Diol compound-2 | Diol compound-3 | Weight-average |
|---|---|---|---|---|
| Polymer | (molar ratio | (molar ratio | (molar ratio | molecular weight |
| compound 1 | thereof contained) | thereof contained) | thereof contained) | (ten thousand) |
| PC-1 | SB-1 | DO-3 | — | 6.1 |
| | 70 | 30 | — | |
| PC-2 | SB-1 | DO-4 | — | 5.4 |
| | 70 | 30 | — | |
| PC-3 | SB-2 | DO-3 | — | 3.9 |
| | 70 | 30 | — | |
| PC-4 | SB-5 | DO-3 | — | 7.5 |
| | 70 | 30 | — | |
| PC-5 | SB-20 | DO-1 | — | 5.9 |
| | 70 | 30 | — | |
| PC-6 | SB-23 | DO-1 | — | 5.3 |
| | 70 | 30 | — | |
| PC-7 | SB-23 | DO-1 | — | 11.5 |
| | 70 | 30 | — | |
| PC-8 | SB-23 | DO-4 | — | 6.7 |
| | 65 | 35 | — | |
| PC-9 | SB-23 | DO-6 | — | 8.2 |
| | 70 | 30 | — | |
| PC-10 | SB-23 | DO-1 | DO-9 | 8.5 |
| | 70 | 25 | 5 | |
| PC-11 | SB-26 | DO-6 | — | 4.5 |
| | 70 | 30 | — | |
| PC-12 | SB-26 | DO-6 | DO-13 | 6.5 |
| | 70 | 25 | 5 | |
| PC-13 | SB-10 | DO-2 | — | 9.5 |
| | 70 | 30 | — | |
| PC-14 | SB-13 | DO-2 | — | 10.2 |
| | 70 | 30 | — | |

—Content—

Further, the content of the polymer compound 1 in the image recording layer according to the present disclosure is preferably in a range of 10% to 90% by mass, more preferably in a range of 20% to 80% by mass, and still more preferably in a range of 30% to 80% by mass with respect to the total mass of the image recording layer.

[Polymer Compound 2-1]

—Constitutional Unit Represented by Formula S-1 or S-2—

A polymer compound 2-1 has at least one of a constitutional unit represented by Formula S-1 or a constitutional unit represented by Formula S-2, and it is preferable that the polymer compound 2-1 has a constitutional unit represented by Formula S-1.

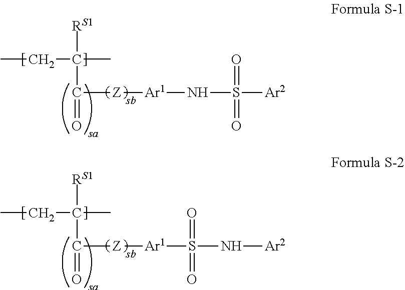

In Formulae S-1 and S-2, R^{sl} represents a hydrogen atom or an alkyl group, Z represents —O— or —N(R^{S2}), R^{S2} represents a hydrogen atom, an alkyl group, an alkenyl group, or an alkynyl group, each of Ar¹ and Ar² independently represents an aromatic group, at least one of Ar¹ or Ar² represents a heteroaromatic group, and each of sa and sb independently represents 0 or 1.

In Formula S-1, R^{S1} represents a hydrogen atom or an alkyl group. The alkyl group is a substituted or unsubstituted alkyl group, and an alkyl group that does not have a substituent is preferable. Examples of the alkyl group represented by R^{S1} include lower alkyl groups such as a methyl group, an ethyl group, a propyl group, and a butyl group. It is preferable that R^{S1} represents a hydrogen atom or a methyl group.

Z represents —O— or —N(R^{S2})— and preferably —N(R^{S2})—. Here, R^{S2} represents a hydrogen atom, an alkyl group, an alkenyl group, or an alkynyl group, preferably a hydrogen atom or an alkyl group which does not have a substituent, and more preferably a hydrogen atom.

Each of sa and sb independently represents 0 or 1. It is preferable that sa represents 0 and sb represents 1, both of sa and sb represent 0, or both of sa and sb represent 1 and most preferable that both of sa and sb represent 1.

More specifically, in the constitutional unit described above, it is preferable that Z represents —O— in a case where sa represents 0 and sb represents 1. Further, it is preferable that Z represents —N(R^{S2})— and R^{S2} here represents a hydrogen atom in a case where both of sa and sb represent 1.

Each of Ar¹ and Ar² independently represents an aromatic group and at least one of Ar¹ or Ar² represents a heteroaromatic group. Ar¹ represents a divalent aromatic group and Ar² represents a monovalent aromatic group. These aromatic groups are each a substituent formed by replacing one or two hydrogen atoms constituting an aromatic ring with a linking group.

Such an aromatic group may be selected from hydrocarbon aromatic rings such as benzene, naphthalene, and anthracene and may be selected from heteroaromatic rings such as furan, thiophene, pyrrole, imidazole, 1,2,3-triazole, 1,2,4-triazole, tetrazole, oxazole, isoxazole, thiazole, isothiazole, thiadiazole, oxadiazole, pyridine, pyridazine, pyrimidine, pyrazine, 1,3,5-triazine, 1,2,4-triazine, and 1,2,3-triazine.

Further, a plurality of these rings may be fused to be formed into fused rings such as benzofuran, benzothiophene, indole, indazole, benzoxazole, quinoline, quinazoline, benzoimidazole, and benzotriazole.

These aromatic groups and heteroaromatic groups may further have a substituent, and examples of the substituent which can be introduced include an alkyl group, a cycloalkyl group, an alkenyl group, a cycloalkenyl group, an aryl group, a heteroaryl group, a hydroxy group, —SH, a carboxylic acid group or alkyl ester thereof, a sulfonic acid group or alkyl ester thereof, a phosphinic acid group or alkyl ester thereof, an amino group, a sulfonamide group, an amide group, a nitro group, a halogen atom, and a substituent formed by a plurality of these being bonded to one another. Further, these substituents may further have substituents exemplified here.

Ar² represents preferably a heteroaromatic group which may have a substituent and more preferably a heteroaromatic ring containing a nitrogen atom, which is selected from pyridine, pyridazine, pyrimidine, pyrazine, 1,3,5-triazine, 1,2,4-triazine, 1,2,3-triazine, tetrazole, oxazole, isoxazole, thiazole, isothiazole, thiadiazole, and oxadiazole.

Hereinafter, examples of monomers (exemplary monomers (A-1) to (A-27)) which can form a constitutional unit represented by Formula S-1 or S-2 will be shown, but the present invention is not limited thereto. Among these exemplary monomers shown below, a monomer containing a linking group which is —SO₂—NH— in the main chain side (for example, a monomer (A-1)) is a monomer which can form a constitutional unit represented by Formula S-1, and a monomer containing a linking group which is —NH—SO₂— in the main chain side (for example, a monomer (A-12)) is a monomer which can form a constitutional unit represented by Formula S-2.

Further, in the examples shown below, Me represents a methyl group.

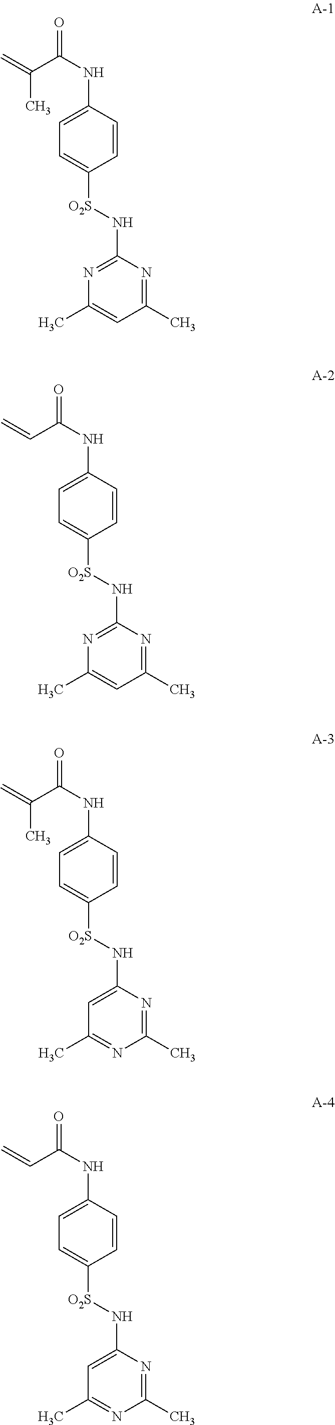

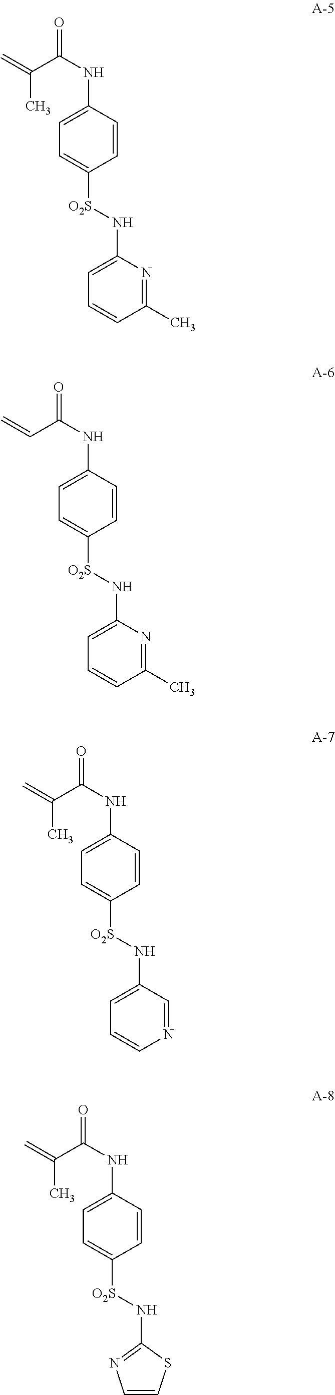

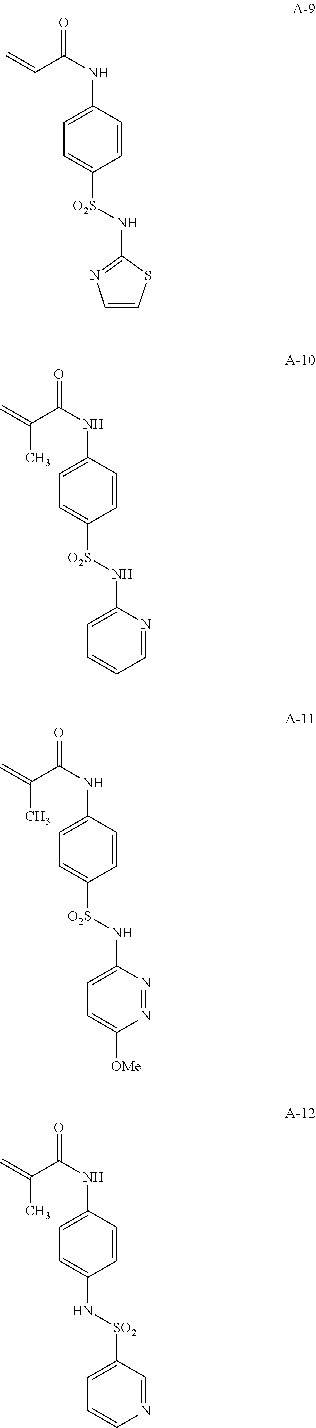 [SMILES: C=CC(=O)Nc1ccc(S(=O)(=O)Nc2nccs2)cc1 ; C=C(C)C(=O)Nc1ccc(S(=O)(=O)Nc2ccccn2)cc1 ; C=C(C)C(=O)Nc1ccc(S(=O)(=O)Nc2ccc(OC)nn2)cc1 ; C=C(C)C(=O)Nc1ccc(NS(=O)(=O)c2cccnc2)cc1]

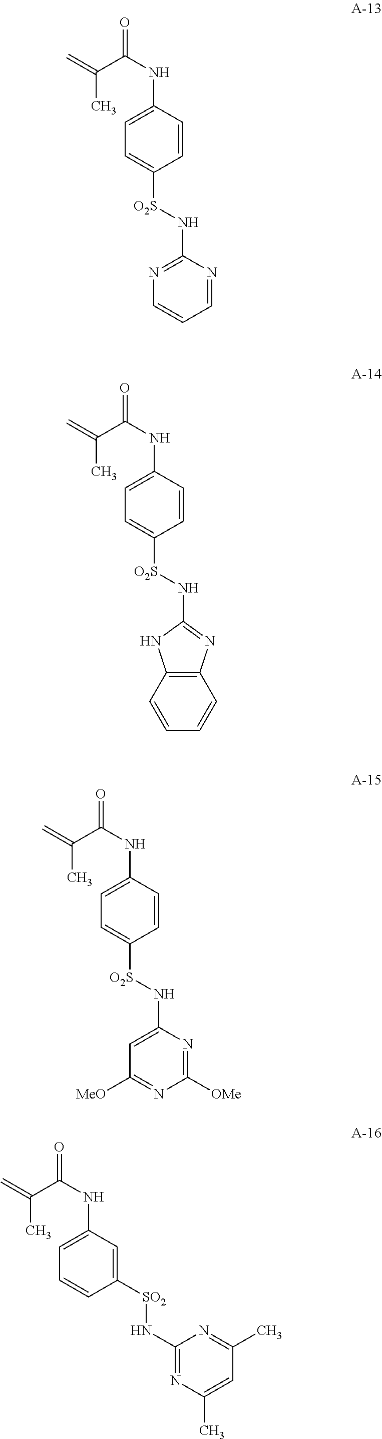 [SMILES: C=C(C)C(=O)Nc1ccc(S(=O)(=O)Nc2ncccn2)cc1 ; C=C(C)C(=O)Nc1ccc(S(=O)(=O)Nc2nc3ccccc3[nH]2)cc1 ; C=C(C)C(=O)Nc1ccc(S(=O)(=O)Nc2cc(OC)nc(OC)n2)cc1 ; C=C(C)C(=O)Nc1cccc(S(=O)(=O)Nc2nc(C)cc(C)n2)c1]

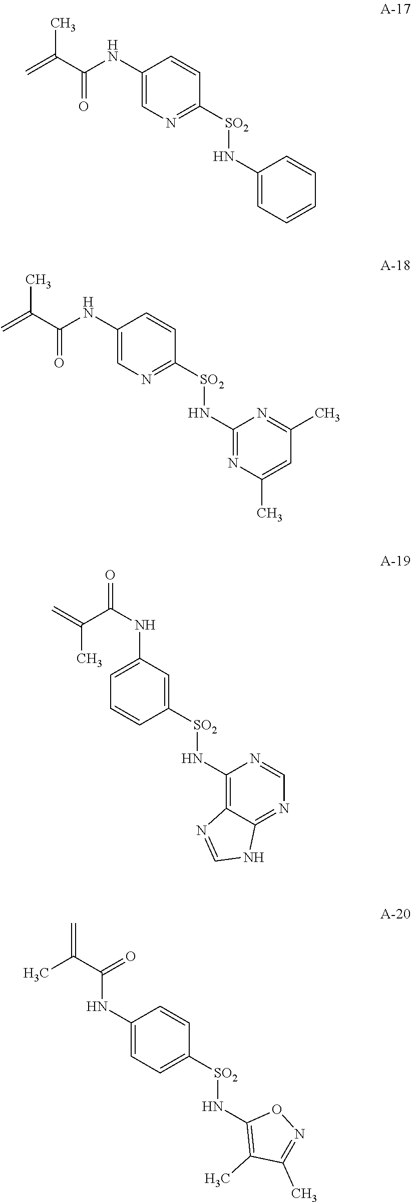

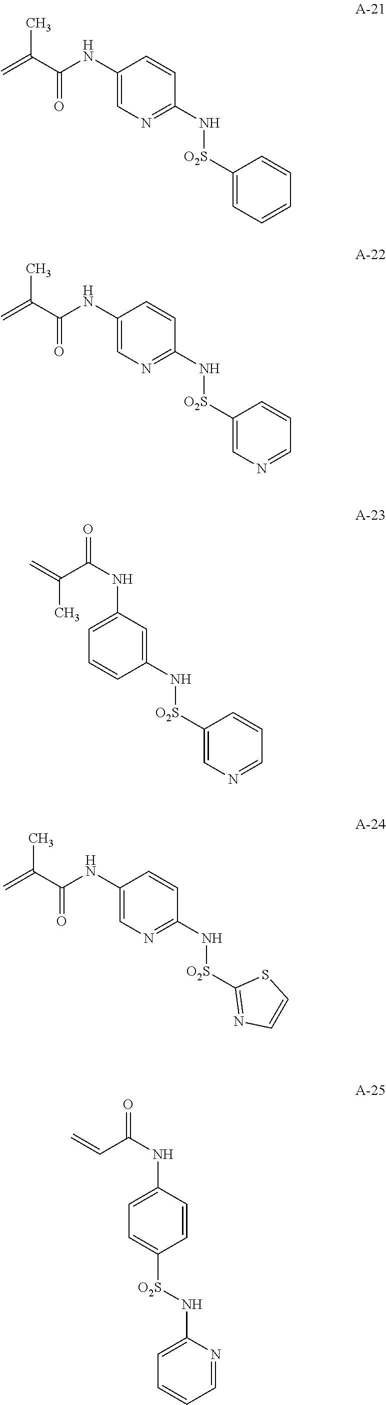 [SMILES: C=C(C)C(=O)Nc1ccc(NS(=O)(=O)c2ccccc2)nc1 ; C=C(C)C(=O)Nc1ccc(NS(=O)(=O)c2cccnc2)nc1 ; C=C(C)C(=O)Nc1cccc(NS(=O)(=O)c2cccnc2)c1 ; C=C(C)C(=O)Nc1ccc(NS(=O)(=O)c2nccs2)nc1 ; C=CC(=O)Nc1ccc(S(=O)(=O)Nc2ccccn2)cc1]

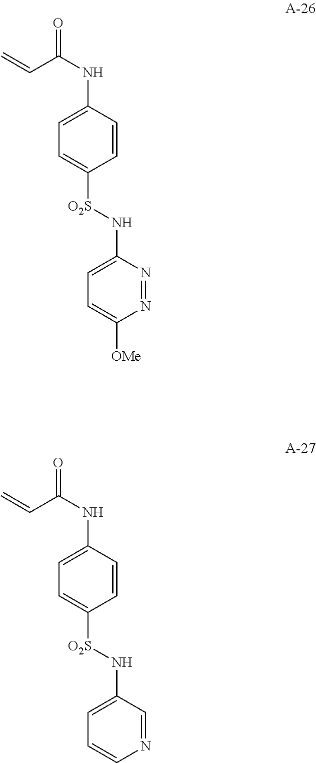 [SMILES: C=CC(=O)Nc1ccc(S(=O)(=O)Nc2ccc(OC)nn2)cc1 ; C=CC(=O)Nc1ccc(S(=O)(=O)Nc2cccnc2)cc1]

It is preferable that the polymer compound 2-1 is an alkali-soluble polymer containing at least one of a constitutional unit represented by Formula S-1 or a constitutional unit represented by Formula S-2. The polymer compound 2-1 may contain a single constitutional unit represented by Formula S-1 or S-2 or a combination of two or more kinds thereof.

The content of the constitutional unit (here, converted in the monomer unit) represented by Formula S-1 or S-2 is preferably in a range of 10% by mole to 100% by mole, more preferably in a range of 20% by mole to 90% by mole, still more preferably in a range of 30% by mole to 80% by mole, and most preferably in a range of 30% by mole to 70% by mole with respect to the total amount of the monomer units in the polymer compound 2-1.

—Other Constitutional Units—

The polymer compound 2-1 may be a copolymer containing constitutional units other than the constitutional unit represented by Formula S-1 or S-2. Examples of other constitutional units include a constitutional unit derived from a hydrophobic monomer containing a substituent such as an alkyl group or an aryl group in a side chain structure of the monomer and a constitutional unit derived from a hydrophilic monomer containing an acidic group, an amide group, a hydroxy group, or an ethylene oxide group in the side chain structure of the monomer, and can be appropriately selected from these depending on the purpose thereof. Further, the kinds of monomers to be copolymerized need to be selected within a range not damaging the alkali-solubility of the polymer compound 2-1.

Examples of other copolymerization components which can be used in the polymer compound 2-1 according to the present disclosure include (meth)acrylamide, N-substituted (meth)acrylamide, N-substituted maleimide, (meth)acrylic acid ester, (meth)acrylic acid ester having a polyoxyethylene chain, 2-hydroxyethyl (meth)acrylate, styrene, styrenesulfonic acid, o-, p-, or m-vinylbenzen acid, vinylpyridine, N-vinylcaprolactam, N-vinylpyrrolidone, (meth)acrylic acid, itaconic acid, maleic acid, glycidyl (meth)acrylate, hydrolyzed vinyl acetate, and vinylphosphonic acid. Among these, preferred examples of copolymerization components include N-benzyl (meth)acrylamide and (meth)acrylic acid.

Hereinafter, examples of monomers (exemplary monomers (A-28) to (A-47)) which can form constitutional units of other copolymerization components will be shown. Further, in the examples shown below, Me represents a methyl group, and Et represents an ethyl group.

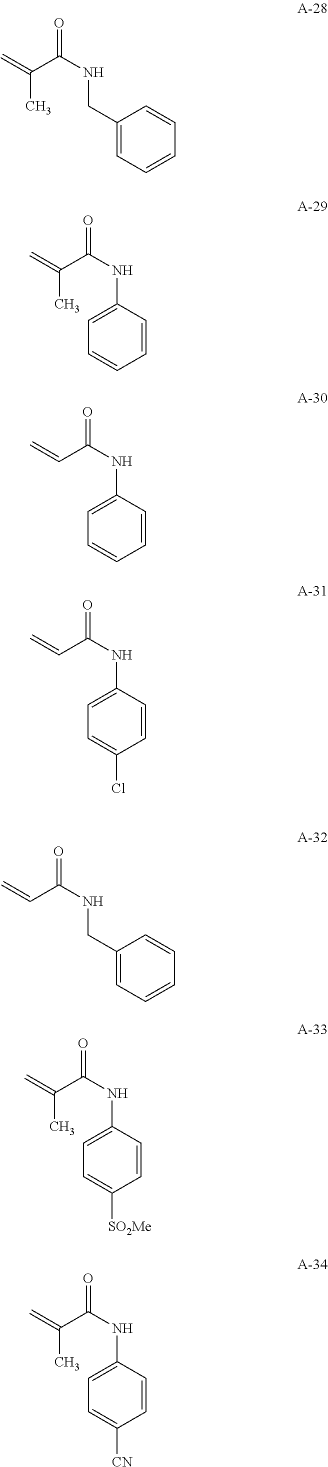

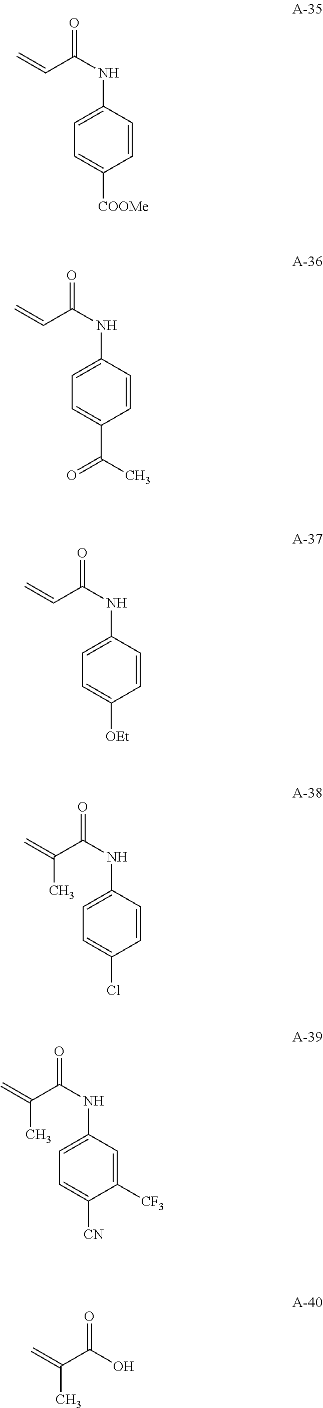

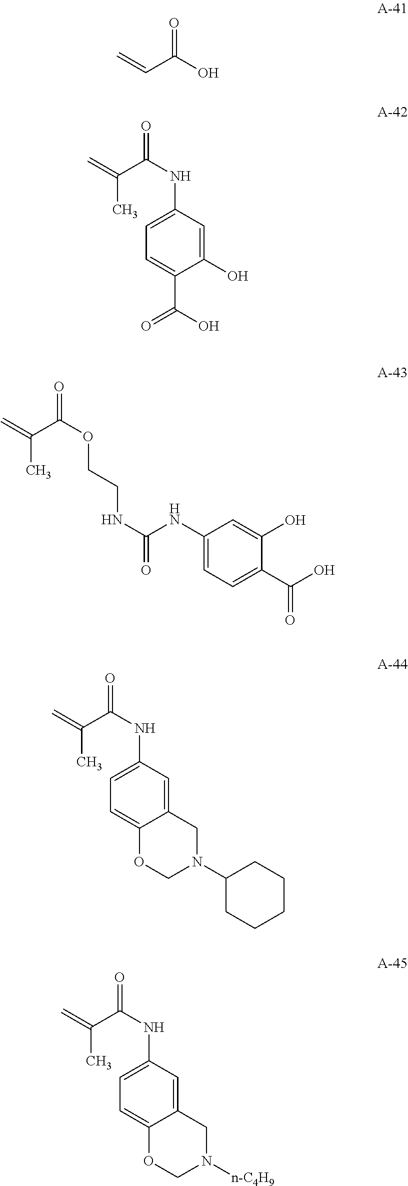

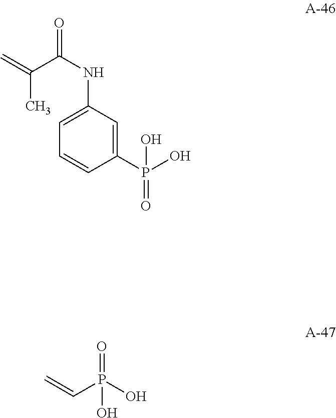

—Molecular Weight—

The number average molecular weight (Mn) of the polymer compound 2-1 is preferably in a range of 10000 to 500000, more preferably in a range of 10000 to 200000, and most preferably in a range of 10000 to 100000. Further, the weight-average molecular weight (Mw) thereof is preferably in a range of 10000 to 1000000, more preferably in a range of 20000 to 500000, and most preferably in a range of 20000 to 200000.

Hereinafter, examples of the configurations of the polymer compound 2-1 which can be suitably used for the planographic printing plate precursor according to the embodiment of the present disclosure are described below based on each combination of constitutional units. Further, the polymer compound 2-1 used in the present disclosure is not limited thereto.

TABLE 4

| | Monomer-1 | Monomer-2 | Monomer-3 | Weight-average |
|---|---|---|---|---|
| Polymer | (molar ratio | (molar ratio | (molar ratio | molecular weight |
| compound 2-1 | thereof contained) | thereof contained) | thereof contained) | (ten thousand) |
| PA-1 | A-1 | A-32 | A-41 | 6.6 |
| | 50 | 10 | 10 | |
| PA-2 | A-1 | A-32 | A-41 | 6.7 |
| | 54 | 44 | 2 | |
| PA-3 | A-1 | A-32 | A-41 | 8.1 |
| | 40 | 50 | 10 | |
| PA-4 | A-4 | A-32 | A-41 | 16.6 |
| | 54 | 44 | 2 | |
| PA-5 | A-7 | A-32 | A-41 | 4.5 |
| | 54 | 44 | 2 | |
| PA-6 | A-5 | A-32 | A-41 | 5.5 |
| | 54 | 44 | 2 | |
| PA-7 | A-8 | A-32 | A-41 | 3.1 |
| | 40 | 50 | 10 | |
| PA-8 | A-17 | A-32 | A-41 | 6.9 |
| | 50 | 40 | 10 | |
| PA-9 | A-1 | A-30 | A-44 | 5.6 |
| | 62 | 33 | 5 | |
| PA-10 | A-1 | A-30 | A-46 | 4.5 |
| | 60 | 35 | 5 | |
| PA-11 | A-1 | A-30 | A-47 | 3.9 |
| | 52 | 40 | 8 | |
| PA-12 | A-1 | A-30 | A-43 | 4.2 |
| | 50 | 45 | 5 | |

—Content—

In a case where the image recording layer according to the present disclosure contains the polymer compound 2-1, the content of the polymer compound 2-1 is preferably in a range of 10% to 90% by mass, more preferably in a range of 20% to 80% by mass, and still more preferably in a range of 30% to 80% by mass with respect to the total mass of the image recording layer.

[Polymer compound 2-2]

—Constitutional Unit Represented by Formula EV-1 and Constitutional Unit Represented by Formula EV-2—

The polymer compound 2-2 used in the present disclosure contains a constitutional unit represented by Formula EV-1 and a constitutional unit represented by Formula EV-2.

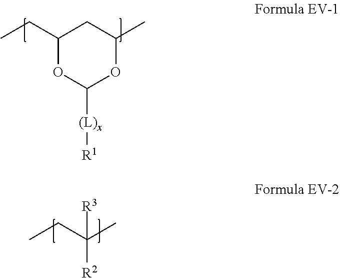

In Formula EV-1 or EV-2, L represents a divalent linking group, x represents 0 or 1, R¹ represents an aromatic ring or heteroaromatic ring which contains at least one hydroxy group, and each of R² and R³ independently represents a hydrogen atom, a halogen atom, a linear, branched, or cyclic alkyl group which may have a substituent, a linear, branched, or cyclic alkenyl group which may have a substituent, an aromatic ring which may have a substituent, or a heteroaromatic ring which may have a substituent.

In Formula EV-1, R¹ represents an aromatic ring or heteroaromatic ring which contains at least one hydroxy group, and the hydroxy group may be contained in any of the ortho, meta, or para position with respect to the bonding site with L.

Preferred examples of the aromatic ring include a phenyl group, a benzyl group, a tolyl group, an o-, m-, or p-xylyl group, a naphthyl group, an anthracenyl group, and a phenanthrenyl group.

Preferred examples of the heteroaromatic ring include a furyl group, a pyridyl group, a pyrimidyl group, a pyrazoyl group, and a thiophenyl group.

These aromatic rings or heteroaromatic rings may have a substituent other than a hydroxyl group, and examples of the substituent include an alkyl group such as a methyl group or an ethyl group, an alkoxy group such as a methoxy group or an ethoxy group, an azo group such as an aryloxy group, a thioalkyl group, a thioaryl group, —SH, an azoalkyl group or an azophenyl group, a thioalkyl group, an amino group, an ethenyl group, an alkenyl group, an alkynyl group, a cycloalkyl group, an aryl group, a heteroaryl group, and a heteroalicyclic group.

R¹ represents preferably a hydroxyphenyl group or hydroxynaphthyl group which contains a hydroxy group and more preferably a hydroxyphenyl group.

Examples of the hydroxyphenyl group include a 2-hydroxyphenyl group, a 3-hydroxyphenyl group, and a 4-hydroxyphenyl group.

Examples of the hydroxynaphthyl group include a 2,3-dihydroxynaphthyl group, a 2,4-dihydroxynaphthyl group, a 2,5-dihydroxynaphthyl group, a 1,2,3-trihydroxynaphthyl group, and a hydroxynaphthyl group.

A hydroxyphenyl group or a hydroxynaphthyl group may have a substituent, and preferred examples of the substituent include an alkoxy group such as a methoxy group and an ethoxy group.

In Formula EV-1, L represents a divalent linking group and preferably an alkylene group, an arylene group, a heteroarylene group, —O—, —C(═O)—, —C(═O)O—, —C(═O)—NH—, —NH—C(═O)—, —NH—C(═O)—O—, —O—C(═O)—NH—, —NH—C(═O)—NH—, —NH—C(═S)—N^{H}—, —S(═O)—, —S(═O)₂—, —CH═N—, —NH—NH—, or a group represented by any of these bonds.

The alkylene group, the arylene group, or a heteroarylene group may have a substituent, and examples of the substituent include an alkyl group, a hydroxy group, an amino group, a monoalkylamino group, a dialkylamino group, an alkoxy group, and a phosphonic acid group or a salt thereof.

L represents more preferably an alkylene group, an arylene group, or a heteroarylene group and still more preferably —CH₂—, —CH₂—CH₂—, —CH₂—CH₂—CH₂—, or a phenylene group.

It is more preferable that the constitutional unit represented by Formula EV-1 is a constitutional unit represented by Formula EV-1A.

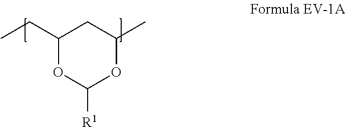

In Formula EV-1A, R¹ has the same definition as that for R¹ in Formula EV-1 and the preferable aspects thereof are the same as described above.

In Formula EV-2, each of R² and R³ independently represents a hydrogen atom, a halogen atom, a linear, branched, or cyclic alkyl group which may have a substituent, a linear, branched, or cyclic alkenyl group which may have a substituent, an aromatic ring which may have a substituent, or a heteroaromatic ring which may have a substituent.

Examples of the alkyl group include a methyl group, an ethyl group, an n-propyl group, an n-butyl group, an n-pentyl group, an n-hexyl group, a chloromethyl group, a trichloromethyl group, an isopropyl group, an isobutyl group, an isopentyl group, a neopentyl group, a 1-methoxybutyl group, an isohexyl group, a cyclopropyl group, a cyclobutyl group, a cyclopentyl group, a cyclohexyl group, and a methylcyclohexyl group.

Examples of the alkenyl group include an ethenyl group, an n-propenyl group, an n-butenyl group, an n-pentenyl group, an n-hexenyl group, an isopropenyl group, an isobutenyl group, an isopentenyl group, a neopentenyl group, a 1-methylbutenyl group, an isohexenyl group, a cyclopentenyl group, a cyclohexenyl group, and a methylcyclohexenyl group.

Examples of the halogen atom include a chlorine atom.

Preferred examples of the aromatic ring include an aryl group such as a phenyl group, a benzyl group, a tolyl group, an o-, m-, or p-xylyl group, a naphthyl group, an anthracenyl group, or a phenanthrenyl group.

Examples of the heteroaromatic ring include a furyl group, a pyridyl group, a pyrimidyl group, a pyrazoyl group, and a thiophenyl group.

Each of R² and R³ independently represents preferably a hydrogen atom, a chlorine atom, or a methyl group and more preferably a hydrogen atom.

Examples of the substituent in the alkyl group, alkenyl group, aromatic ring, or heteroaromatic ring include an alkoxy group such as a methoxy group or an ethoxy group, a thioalkyl group, and —SH.

The aromatic ring or heteroaromatic ring may contain an aryloxy group, a thioaryl group, an azo group such as an azoalkyl group or an azoaryl group, or an amino group, as a substituent.

It is more preferable that the constitutional unit represented by Formula EV-2 is a constitutional unit represented by Formula EV-2A.

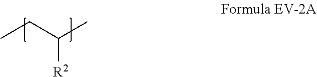

In Formula EV-2A, R² has the same definition as that for R² in Formula EV-2 and the preferable aspects thereof are the same as described above.

The content of the constitutional unit (here, converted in the monomer unit) represented by Formula EV-1 is preferably 10% by mole or greater, more preferably in a range of 10% to 55% by mole, still more preferably in a range of 15% to 45% by mole, and particularly preferably in a range of 20% to 35% by mole with respect to the total amount of the monomer units in the polymer compound 2-2.

The content of the constitutional unit (here, converted in the monomer unit) represented by Formula EV-2 is preferably 15% by mole or greater, more preferably in a range of 15% to 60% by mole, still more preferably in a range of 20% to 50% by mole, and particularly preferably in a range of 25% to 45% by mole with respect to the total amount of the monomer units in the polymer compound 2-2.

Further, the total content of the constitutional unit represented by Formula EV-1 and the constitutional unit represented by Formula EV-2 (here, converted in the monomer unit) is preferably in a range of 50% to 90% by mole, more preferably in a range of 60% to 80% by mole, and still more preferably in a range of 65% to 75% by mole with respect to the total amount of the monomer units in the polymer compound 2-2.

—Other Constitutional Units—

The polymer compound 2-2 may contain constitutional units other than the constitutional unit represented by Formula EV-1 and the constitutional unit represented by Formula EV-2.

Examples of other constitutional units include a constitutional unit derived from vinyl alcohol which is represented by Formula EV-3 and a constitutional unit represented by Formula EV-4.

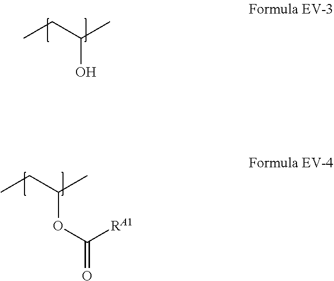

In Formula EV-4, R^{A1} represents a hydrogen atom, a linear, branched, or cyclic alkyl group which may have a substituent, an aromatic ring which may have a substituent, or a heteroaromatic ring which may have a substituent.

Examples of the substituent in the alkyl group, aromatic ring, or heteroaromatic ring include an alkoxy group such as a methoxy group or an ethoxy group, a thioalkyl group, and —SH.

Further, examples of the substituent in the aromatic ring or heteroaromatic ring aryloxy group include an aryloxy group, a thioaryl group, an azo group, and an amino group.

The content of the constitutional unit (here, converted in the monomer unit) represented by Formula EV-3 is preferably in a range of 10% to 60% by mole, more preferably in a range of 15% to 50% by mole, and still more preferably in a range of 20% to 30% by mole with respect to the total amount of the monomer units in the polymer compound 2-2.

The content of the constitutional unit (here, converted in the monomer unit) represented by Formula EV-4 is preferably in a range of 0% to 10% by mole, more preferably less than 8% by mole, still more preferably 0% or greater and less than 3% by mole, and particularly preferably 0% by mole or greater and less than 1% by mole with respect to the total amount of the monomer units in the polymer compound 2-2.

Further, as the polymer compound 2-2, polyvinyl acetal represented by Formula VA is preferable.

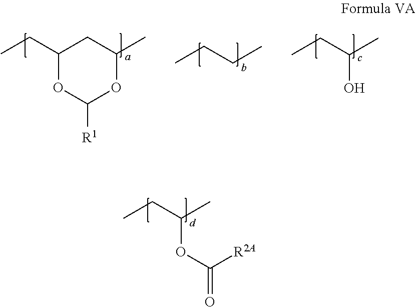

In Formula VA, R¹ represents an aromatic ring or heteroaromatic ring which contains at least one hydroxy group, R^{2A} represents an alkyl group which may have a substituent, a represents 10% to 55% by mole, b represents 15% to 60% by mole, c represents 10% to 60% by mole, and d represents 0% to 10% by mole.

In Formula VA, R¹ has the same definition as that for R¹ in Formula EV-1 and the preferable aspects thereof are the same as described above.

In Formula VA, R^{2A} represents an alkyl group which may have a substituent and preferably a methyl group.

In Formula VA, a represents preferably 20% to 50% by mole and more preferably 25% to 45% by mole.

In Formula VA, b represents preferably 15% to 45% by mole and more preferably 20% to 35% by mole.

In Formula VA, c represents preferably 15% to 50% by mole and more preferably 20% to 30% by mole.

In Formula VA, d represents preferably 0% or greater and less than 3% by mole and more preferably 0% or greater and less than 1% by mole.

Hereinafter, specific examples of the polymer compound 2-2 which is preferably used in the present disclosure will be described. In the specific example, Mn represents the number average molecular weight. Further, the polymer compound 2-2 used in the present disclosure is not limited thereto.

Further, the compounds in the following specific examples are not block copolymers but random copolymers randomly having constitutional units delimited by [ ].

Further, in the following examples, Me represents a methyl group.

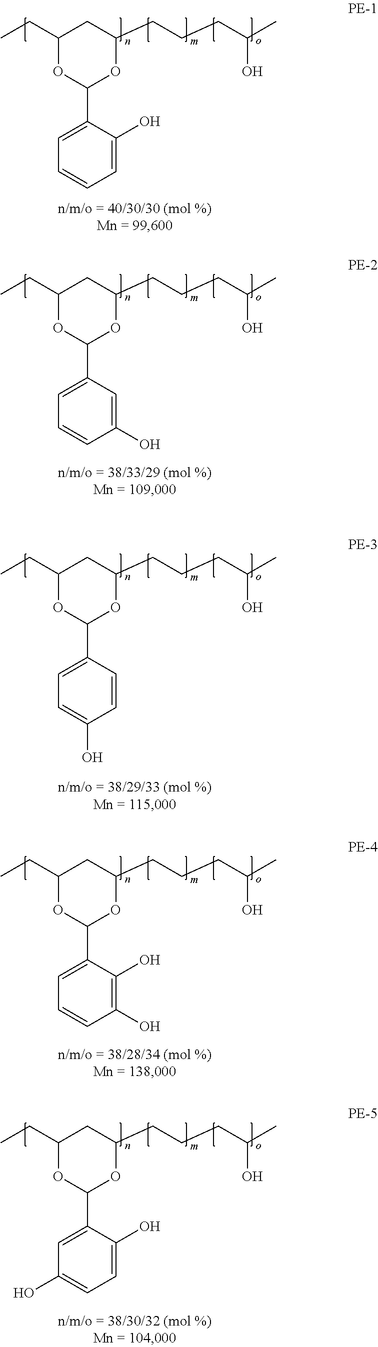

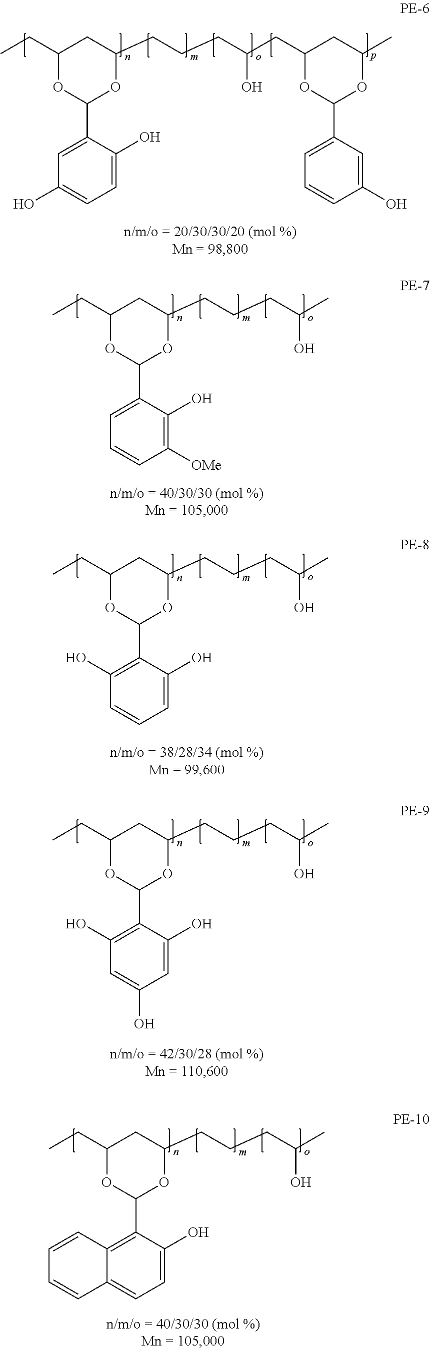

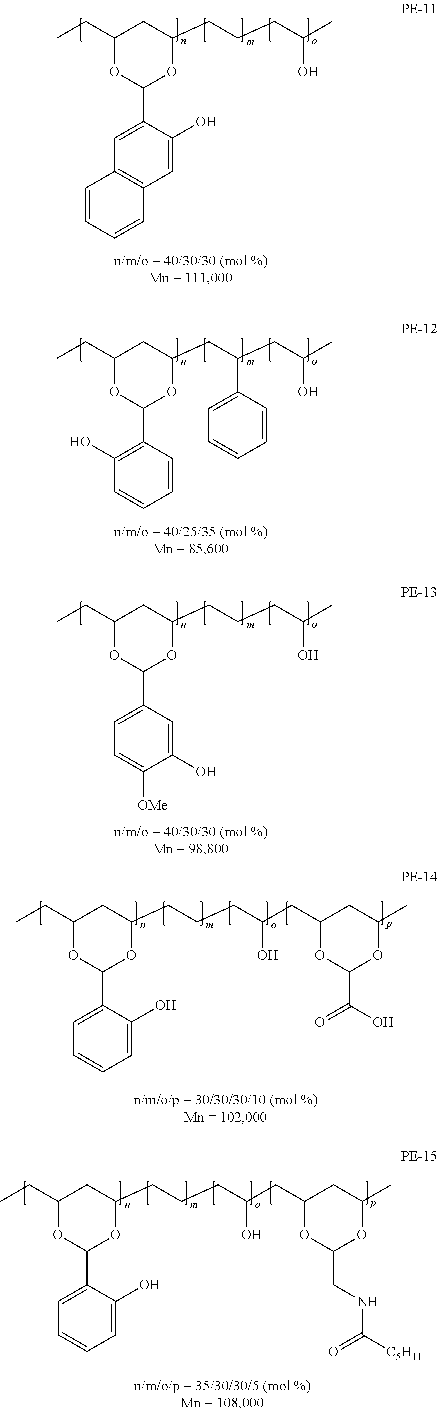

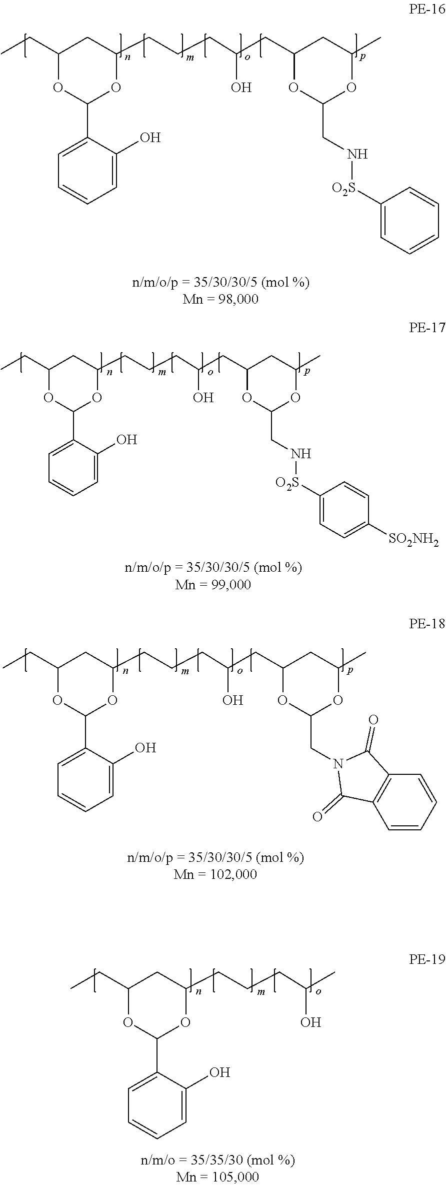

The number average molecular weight (Mn) of the polymer compound 2-2 used in the present disclosure is preferably 1500 or greater, more preferably in a range of 3000 to 300000, and still more preferably in a range of 10000 to 150000.

The polymer compound 2-2 according to the present disclosure may contain constitutional units other than the constitutional units represented by Formulae EV-1 and EV-2.

Examples of other constitutional units include constitutional units described in U.S. Pat. No. 5,169,897A, WO1993/003068A, U.S. Pat. Nos. 5,534,381A, 5,698,360A, JP1999-212252A (JP-H11-212252A), JP1999-231535A (JP-H11-231535A), JP2000-039707A, JP2000-275821A, JP2000-275823A, U.S. Pat. No. 6,087,066A, WO2001/009682A, U.S. Pat. Nos. 6,270,938B, 6,596,460B, WO2002/073315A, WO2002/096961A, U.S. Pat. No. 6,818,378B, WO2004/20484A, WO2007/003030A, WO2009/005582A, and WO2009/099518A.

The polymer compound 2-2 can be prepared using known starting materials and reaction conditions.

Examples of the method of preparing the polymer compound 2-2 include methods described in U.S. Pat. Nos. 6,541,181B, 4,665,124A, 4,940,646A, 5,169,898A, 5,700,619A, 5,792,823A, 5,849,842A, WO93/003068A, German Patent No. 10011096, German Patent No. 3404366, U.S. Ser. No. 09/751,660A, WO01/009682A, WO03/079113A, WO2004/081662A, WO2004/020484A, WO2008/103258A, and JP1997-328519A (JP-H09-328519A).

—Content—

In a case where the image recording layer according to the present disclosure contains the polymer compound 2-2, the content of the polymer compound 2-2 is preferably in a range of 10% to 90% by mass, more preferably in a range of 20% to 80% by mass, and still more preferably in a range of 30% to 80% by mass with respect to the total mass of the image recording layer.

[Infrared Absorbent]

The image recording layer according to the present disclosure contains an infrared absorbent.

The infrared absorbent is not particularly limited as long as it is a dye which generates heat by absorbing infrared light, and various dyes known as an infrared absorbent can be used.

Examples of the infrared absorbent which can be used in the present disclosure include the infrared absorbents described in paragraphs 0075 to 0085 of WO2016/047392A.

Among these dyes, examples of a particularly preferable dye include a cyanine coloring agent, a phthalocyanine dye, an oxonol dye, a squarylium coloring agent, a pyrylium salt, a thiopyrylium dye, and a nickel thiolate complex. Furthermore, it is most preferable that a cyanine coloring agent represented by the following Formula (a) is used for the upper layer of the positive type planographic printing plate precursor according to the embodiment of the present disclosure from the viewpoint that the dissolution suppressing action is satisfactorily released due to exposure and stability and economic efficiency are excellent.

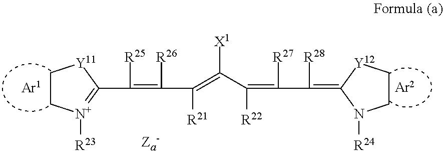

In Formula (a), X¹ represents a hydrogen atom, a halogen atom, a diarylamino group, X²-L¹, or a group shown represented by Formula (b). X² represents an oxygen atom or a sulfur atom, and L¹ represents a hydrocarbon group having 1 to 12 carbon atoms, an aromatic ring having a heteroatom, or a hydrocarbon group having 1 to 12 carbon atoms including a heteroatom. Here, the heteroatom represents N, S, O, a halogen atom, or Se.

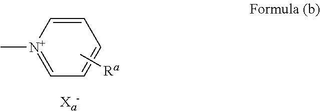

In Formula (b), Xa⁻ has the same definition as Za⁻ described below, and R^{a} represents a substituent selected from a hydrogen atom, an alkyl group, an aryl group, a substituted or unsubstituted amino group, and a halogen atom.

Each of R²¹ and R²² independently represents a hydrocarbon group having 1 to 12 carbon atoms. From the viewpoint of storage stability of the positive type planographic printing plate precursor, each of R²¹ and R²² is preferably a hydrocarbon group having two or more carbon atoms, and R²¹ and R²² are particularly preferably bonded to each other to form a 5-membered ring or a 6-membered ring.

Ar¹ and Ar² may be the same as or different from each other, and Ar¹ and Ar² each represent an aromatic hydrocarbon group which may have a substituent. Examples of a preferable aromatic hydrocarbon group include a benzene ring and a naphthalene ring. In addition, preferred examples of the substituent include a hydrocarbon group having 1 to 12 carbon atoms, a halogen atom, and an alkoxy group having 1 to 12 carbon atoms.

Y¹¹ and Y¹² may be the same as or different from each other, and Y¹¹ and Y¹² each represent a sulfur atom or a dialkyl methylene group having 3 to 12 carbon atoms. R²³ and R²⁴ may be the same as or different from each other, and R²³ and R²⁴ each represent a hydrocarbon group having 1 to 20 carbon atoms which may have a substituent. Preferred examples of the substituent include an alkoxy group having 1 to 12 carbon atoms, a carboxyl group, and a sulfo group.

R²⁵, R²⁶, R²⁷, and R²⁸ may be the same as or different from each other, and R²⁵, R²⁶, R²⁷, and R²⁸ each represent a hydrogen atom or a hydrocarbon group having 1 to 12 carbon atoms. From the viewpoint of availability of a raw material, it is preferable that R²⁵, R²⁶, R²⁷, and R²⁸ each represent a hydrogen atom. In addition, Za⁻ represents a counter anion. Here, the cyanine coloring agent represented by Formula (a) has an anionic substituent in the structure thereof, and in a case where neutralization of the charge is not necessary, Za⁻ is not necessary. From the viewpoint of storage stability of the positive type planographic printing plate precursor, Za⁻ represents preferably a halide ion, a perchlorate ion, a tetrafluoroborate ion, a hexafluorophosphate ion, or a sulfonic acid ion and particularly preferably a perchlorate ion, a hexafluorophosphate ion, or an arylsulfonic acid ion.

Specific examples of the cyanine coloring agent represented by Formula (a) which can be suitably used include the cyanine coloring agents described in paragraphs 0017 to 0019 of JP2001-133969A, paragraphs 0012 to 0038 of JP2002-040638A, and paragraphs 0012 to 0023 of JP2002-023360A. It is particularly preferable that the infrared absorbent contained is a cyanine dye A shown below.

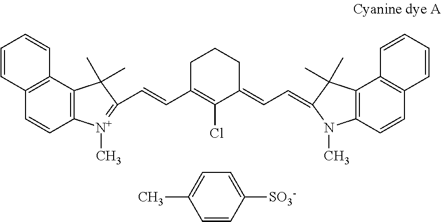

The content of the infrared absorbent in the image recording layer according to the present disclosure is preferably in a range of 0.01% to 50% by mass, more preferably in a range of 0.1% to 30% by mass, and particularly preferably in a range of 1.0% to 30% by mass, with respect to the total mass of the image recording layer. In a case where the content thereof is 0.01% by mass or greater, the layer becomes highly sensitive, and in a case where the content thereof is 50% by mass or less, the uniformity of the layer is excellent and the durability of the layer is excellent.

[Other Alkali-Soluble Resins]

The image recording layer according to the present disclosure may contain alkali-soluble resins other than the polymer compound 1, the polymer compound 2-1, and the polymer compound 2-2.

In the present disclosure, the “alkali-soluble” means that “0.01 g of a resin is dissolved in 5 g of a sodium hydroxide aqueous solution having a pH of 13.0 at 30° C. within 200 seconds. Further, the dissolution indicates is a state in which the residual of a dissolved substance cannot be visually confirmed.

Although other alkali-soluble resins used in the image recording layer of the present disclosure is not particularly limited as long as the resin has a characteristic of being dissolved by contact with an alkaline developer, it is preferable that the alkali-soluble resin has an acidic functional group such as a sulfonic acid group, a phosphoric acid group, a sulfonamide group, or an active imide group in at least one of the main chain or a side chain in the polymer, a resin including 10% by mole or greater of a monomer having such an acidic functional group imparting alkali-solubility is exemplified, and a resin including 20% by mole or greater is more preferable. In a case where the copolymerization component of the monomer imparting alkali-solubility is 10% by mole or greater, sufficient alkali-solubility is obtained, and developability is excellent.

In addition, as other alkali-soluble resin, a novolac resin is also preferably exemplified.

Preferred examples of the novolac resin which can be used in the image recording layer of the present disclosure, novolac resins such as a phenol formaldehyde resin, an m-cresol formaldehyde resin, a p-cresol formaldehyde resin, an m-/p-mixed cresol formaldehyde resin, a phenol/cresol (which may be any mixture of m-, p-, or m-/p-) mixed formaldehyde resin or pyrogallol acetone resins are preferably exemplified.

In addition, a polycondensate of phenol having an alkyl group having 3 to 8 carbon atoms as a substituent and formaldehyde, such as a t-butyl phenol formaldehyde resin or an octyl phenol formaldehyde resin, as described in U.S. Pat. No. 4,123,279A, is exemplified. In addition, the weight-average molecular weight (Mw) thereof is preferably 500 or greater, and more preferably 1,000 to 700,000. In addition, the number average molecular weight (Mn) thereof is preferably 500 or greater, and more preferably 750 to 650,000. The dispersity (weight-average molecular weight/number average molecular weight) is preferably 1.1 to 10.

Other alkali-soluble resins preferably have a weight-average molecular weight of 2,000 or greater and a number average molecular weight of 500 or greater, and more preferably have a weight-average molecular weight of 5,000 to 300,000 and a number average molecular weight of 800 to 250,000. The dispersity (weight-average molecular weight/number average molecular weight) of other alkali-soluble resins is preferably 1.1 to 10.

Other alkali-soluble resins included in the image recording layer according to the present disclosure as desired may be used alone or in combination of two or more kinds thereof.

The content of other alkali-soluble resins in the image recording layer according to the present disclosure is preferably 0% to 80% by mass and more preferably 0% to 70% by mass with respect to the total mass of the image recording layer. In addition, the proportion of other alkali-soluble resin is preferably 80 parts by mass or less with respect to 100 parts by mass which is the total amount of the polymer compounds 1 and 2 used in the image recording layer according to the present disclosure.

[Acid Generator]

It is preferable that the image recording layer according to the present disclosure contains an acid generator from the viewpoint of improving the sensitivity.

The acid generator in the present disclosure is a compound which generates an acid by light or heat, and indicates a compound which generates an acid due to decomposition by irradiation with infrared rays or heating at 100° C. or higher. The acid generated is preferably a strong acid having a pKa of 2 or less such as sulfonic acid or hydrochloric acid. The permeability of a developer into the image recording layer of the exposed portion is increased and the solubility of the image recording layer in an alkali aqueous solution is further improved due to an acid generated from this acid generator.

Examples of the acid generator which is suitably used in the image recording layer according to the present disclosure include the acid generators described in paragraphs 0116 to 0130 of WO2016/047392A.

Among these, from the viewpoint of sensitivity and stability, an onium salt compound is preferably used as an acid generator. The onium salt compound will be described below.

As the onium salt compound which can be suitably used in the image recording layer according to the present disclosure, compounds known as a compound which generates an acid due to decomposition by infrared ray exposure or heat energy generated from the infrared absorbent by exposure can be exemplified. As the onium salt compound suitable in the image recording layer according to the present disclosure, from the viewpoint of sensitivity, known thermal polymerization initiators or compounds having a bond with small bond dissociation energy and having an onium salt structure described below can be exemplified.

Examples of the onium salt suitably used in the image recording layer according to the present disclosure include known diazonium salts, iodonium salts, sulfonium salts, ammonium salts, pyridinium salts, and azinium salts, and among these, sulfonate of triarylsulfonium or diaryliodonium, carboxylate, BF₄⁻, PF₆⁻, or ClO₄⁻ is preferable.

Examples of the onium salt which can be used as an acid generator in the image recording layer of the positive type planographic printing plate precursor according to the embodiment of the present disclosure include onium salts represented by the following Formulae (III) to (V).

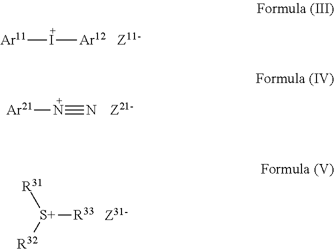

In Formula (III), each of Ar¹¹ and Ar¹² independently represents an aryl group having 6 to 20 carbon atoms which may have a substituent. Examples of a preferable substituent in a case where the aryl group has a substituent include a halogen atom, a nitro group, an alkyl group having 1 to 12 carbon atoms, an alkoxy group having 1 to 12 carbon atoms, and an aryloxy group having 1 to 12 carbon atoms. Z¹¹⁻ represents a counter ion selected from the group consisting of a halide ion, a perchlorate ion, a tetrafluoroborate ion, a hexafluorophosphate ion, a sulfonic acid ion, or a sulfonic acid ion having a fluorine atom such as a perfluoroalkyl sulfonic acid ion, and a perchlorate ion, a hexafluorophosphate ion, an aryl sulfonic acid ion, or a perfluoroalkyl sulfonic acid is preferable.

In Formula (IV), Ar²¹ represents an aryl group having 6 to 20 carbon atoms which may have a substituent. Examples of a preferable substituent include a halogen atom, a nitro group, an alkyl group having 1 to 12 carbon atoms, an alkoxy group having 1 to 12 carbon atoms, an aryloxy group having 1 to 12 carbon atoms, an alkylamino group having 1 to 12 carbon atoms, a dialkylamino group having 2 to 12 carbon atoms, an arylamino group having 6 to 12 carbon atoms, and a diarylamino group (each independently having 6 to 12 carbon atoms in the aryl group). Z²¹⁻ represents a counter ion having the same definition as that for Z¹¹⁻.

In Formula (V), R³¹, R³², and R³³ may be the same as or different from each other, and R³¹, R³², and R³³ each represent a hydrocarbon group having 1 to 20 carbon atoms which may have a substituent. Examples of a preferable substituent include a halogen atom, a nitro group, an alkyl group having 1 to 12 carbon atoms, an alkoxy group having 1 to 12 carbon atoms, and an aryloxy group having 1 to 12 carbon atoms. Z³¹⁻ represents a counter ion having the same definition as that for Z¹¹⁻.

Specific examples of the onium salt which can be suitably used in the image recording layer according to the present disclosure are the same as the compounds described in paragraphs 0121 to 0124 of WO2016/047392A.

In addition, as another example of the compounds represented by each of Formula (III) to (V), the compounds described as an example of a radical polymerization initiator in paragraphs 0036 to 0045 of JP2008-195018A can be suitably used as an acid generator in the image recording layer according to the present disclosure.

More preferred examples of the acid generator which can be used in the image recording layer according to the present disclosure include compounds represented by Formulae PAG-1 to PAG-5. Further, in Formulae PAG-1 to PAG-5, Me represents a methyl group.

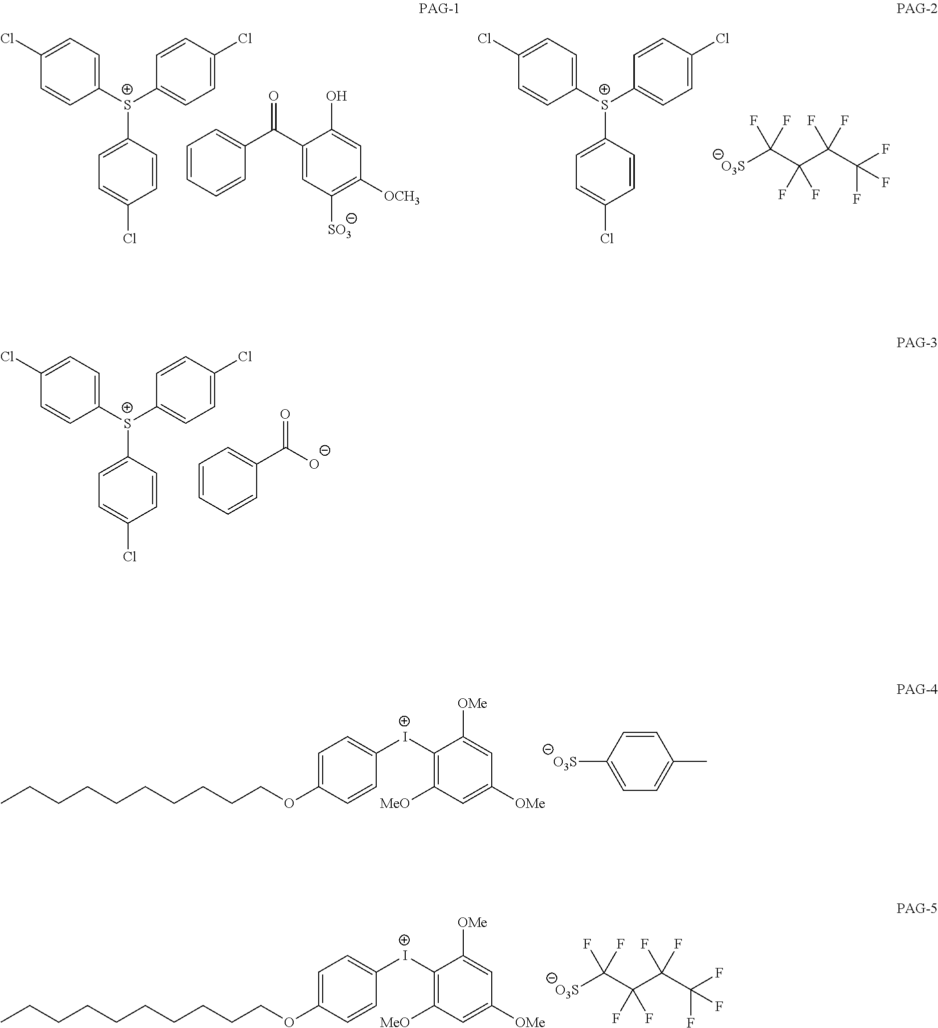

In a case where these acid generators are contained in the image recording layer according to the present disclosure, these compounds may be used alone or in combination of two or more kinds thereof.

The content of acid generator is preferably in a range of 0.01% to 50% by mass, more preferably in a range of 0.1% to 40% by mass, and still more preferably in a range of 0.5% to 30% by mass with respect to the total mass of the image recording layer. In a case where the content is within the above-described range, improvement of sensitivity which is the effect of the addition of an acid generator is observed, and an occurrence of a residual film in a non-image area is suppressed.

[Acid Proliferation Agent]

An acid proliferation agent may be contained in the image recording layer according to the present disclosure. The acid proliferation agent in the image recording layer according to the present disclosure is a compound substituted with a residue of a relatively strong acid, and a compound which newly generates an acid by being easily released in the presence of an acid catalyst. That is, the compound is decomposed by an acid catalyzed reaction, and generates an acid again. Since one or more acids per reaction are increased, and with the progress of the reaction, the acid concentration is increasingly increased, sensitivity is dramatically improved. The intensity of this generated acid preferably is 3 or less as an acid dissociation constant (pKa) and more preferably 2 or less. In a case where the intensity of the acid is 3 or less as an acid dissociation constant, the elimination reaction using an acid catalyst is likely to be caused.

Examples of the acid used in such an acid catalyst include dichloroacetic acid, trichloroacetic acid, methanesulfonic acid, ethanesulfonic acid, benzenesulfonic acid, p-toluenesulfonic acid, naphthalenesulfonic acid, and phenyl sulfonic acid.

Examples of the acid proliferation agent which can be used are the same as those described in paragraphs 0133 to 0135 of WO2016/047392A.

The content of the acid proliferation agent is in a range of 0.01% to 20% by mass, preferably in a range of 0.01% to 10% by mass, and more preferably in a range of 0.1% to 5% by mass with respect to the total mass of the image recording layer according to the present disclosure. In a case where the content of the acid proliferation agent is in the above-described range, effects of adding acid proliferation agent are sufficiently obtained, improvement in sensitivity is achieved, and film hardness reduction of an image area is suppressed.

[Other Additives]

The image recording layer according to the present disclosure may include a development accelerator, a surfactant, a print-out agent/colorant, a plasticizer, or a wax agent, as other additives. As other additives, those described in paragraphs 0138 to 0142 of WO2016/047392A can be used.

[Compositional Ratio of Respective Components]

The content of the polymer compound 1 is preferably 10% to 90% by mass, the content of the polymer compound 2-1 or the polymer compound 2-2 is preferably in a range of 10% to 90% by mass, the content of the infrared absorbent is preferably in a range of 0.01% to 50% by mass, the content of other alkali-soluble resins is preferably 0% to 80% by mass, the content of the acid generator is preferably 0% to 30% by mass, the content of the acid proliferation agent is preferably 0% to 20% by mass, the content of the development accelerator is preferably 0% to 20% by mass, the content of the surfactant is preferably 0% to 5% by mass, the content of the print-out agent/colorant is preferably 0% to 10% by mass, the content of the plasticizer is preferably 0% to 10% by mass, and the content of the wax agent is preferably 0% to 10% by mass, with respect to the total mass of the image recording layer according to the present disclosure.

In a case where the image recording layer according to the present disclosure contains the polymer compound 2-1, the content ratio (mass ratio) between the polymer compound 1 and the polymer compound 2-1 (polymer compound 1:polymer compound 2-1) which are contained in the image recording layer according to the present disclosure is preferably in a range of 1:5 to 5:1 and more preferably in a range of 1:3 to 3:1.

In a case where the image recording layer according to the present disclosure contains the polymer compound 2-2, the content ratio (mass ratio) between the polymer compound 1 and the polymer compound 2-2 (polymer compound 1: polymer compound 2-2) which are contained in the image recording layer according to the present disclosure is preferably in a range of 1:5 to 5:1 and more preferably in a range of 1:3 to 3:1.

[Upper Layer and Lower Layer]

It is preferable that the positive type planographic printing plate precursor according to the embodiment of the present disclosure includes a recording layer having a lower layer and an upper layer in this order, on the support having a hydrophilic surface, and at least one of the lower layer or the upper layer is the image recording layer (the image recording layer containing the polymer compound 1, the polymer compound 2-1 or the polymer compound 2-2, and the infrared absorbent, and also referred to as the “image recording layer according to the present disclosure”).

The positive type planographic printing plate precursor having the lower layer and the upper layer is also referred to as a “positive type planographic printing plate precursor having a two-layer structure”.

In the present disclosure, the recording layer indicates a layer whose solubility in an alkali aqueous solution is changed due to heat. It is preferable that both of the lower layer and the upper layer are recording layers.

In a case where any one of the lower layer or the upper layer is the image recording layer according to the present disclosure, it is preferable that the other layer is another recording layer.

Another recording layer indicates a recording layer whose composition is different from the composition of the image recording layer according to the present disclosure, and it is preferable that another layer is a recording layer whose solubility in an alkali aqueous solution is improved due to heat.

In the positive type planographic printing plate precursor according to the embodiment of the present disclosure, from the viewpoint of the printing durability in a case where a particularly low-quality material such as paper or ink is used, it is preferable that the lower layer is the image recording layer according to the present disclosure and the upper layer is another recording layer.

The detailed mechanism for obtaining the above-described effect is not clear, but it is assumed that the film hardness of the resin used in the lower layer is important for the printing durability in printing. Therefore, in the image recording layer according to the present disclosure, it is speculated that the printing durability is improved by using the image recording layer according to the present disclosure as the lower layer because the interaction (a hydrogen bond or the like) between binders is strong.

—Formation of Lower Layer and Upper Layer—

It is preferable that the lower layer and the upper layer are separately formed.

As the method of separately forming the two layers, for example, a method of using the difference in the solvent solubilities between the components included in the lower layer and the components included in the upper layer and a method of rapidly drying and removing the solvent after application to the upper layer are exemplified. Since by using the latter method in combination, the separation between the layers is more favorably performed, the method is preferable.

These methods will be described in detail below, but the method of separately applying to the two layers is not limited thereto.

In the method of using the difference in the solvent solubilities between the components included in the lower layer and the components included in the upper layer, in a case where applying a coating solution for an upper layer, a solvent system in which all the components included in the lower layer are insoluble is used. Thus, even in a case where two-layer coating is performed, a coated film can be formed such that each layer thereof is clearly separated. For example, by selecting a component insoluble in a solvent such as methyl ethyl ketone or 1-methoxy-2-propanol which dissolves an alkali-soluble resin which is the upper layer component, as the lower layer component, applying to the lower layer and drying using a solvent system which dissolves the lower layer component, dissolving the alkali-soluble resin-based upper layer in methyl ethyl ketone or 1-methoxy-2-propanol, and applying the resulting product and drying, bilayering is possible.

Next, the method of very rapidly drying the solvent after application to the second layer (upper layer) can be achieved by blowing high-pressure air from a slit nozzle provided substantially at a right angle with respect to the running direction of the web, applying heat energy as conductive heat from the lower surface of the web by a roll (heating roll) into which a heating medium such as steam has been supplied, or combining these.

The coating amount after drying of the lower layer components to be applied to the support of the positive type planographic printing plate precursor according to the embodiment of the present disclosure is preferably in a range of 0.5 to 4.0 g/m² and more preferably in a range of 0.6 to 2.5 g/m². In a case where the coating amount is 0.5 g/m² or greater, printing durability is excellent, and in a case where the coating amount is 4.0 g/m² or less, image reproducibility and sensitivity are excellent.

In addition, the coating amount after drying of the upper layer component is preferably 0.05 to 1.0 g/m² and more preferably 0.08 to 0.7 g/m². In a case where the coating amount is 0.05 g/m² or greater, development latitude and scratch resistance are excellent, and in a case where the coating amount is 1.0 g/m² or less, sensitivity is excellent.

The coating amount after drying of the lower layer and the upper layer is preferably in a range of 0.6 to 4.0 g/m² and more preferably in a range of 0.7 to 2.5 g/m². In a case where the coating amount is 0.6 g/m² or greater, printing durability is excellent, and in a case where the coating amount is 4.0 g/m² or less, image reproducibility and sensitivity are excellent.

[Upper Layer]

The upper layer of the positive type planographic printing plate precursor having a two-layer structure according to the embodiment of the present disclosure may be the image recording layer according to the present disclosure, but it is preferable that the upper layer thereof is another recording layer.

It is preferable that the upper layer of the positive type planographic printing plate precursor having a two-layer structure according to the embodiment of the present disclosure is an infrared sensitive positive type recording layer whose solubility in an alkali aqueous solution is improved by heat.

The mechanism of improving the solubility in alkali aqueous solution by heat in the upper layer is not particularly limited, and any one can be used as long as it includes a binder resin and improves the solubility of the heated region. As the heat used in image formation, the heat generated in a case where the lower layer including an infrared absorbent is exposed is exemplified.

Preferable examples of the upper layer of which the solubility in an alkali aqueous solution is improved by heat include a layer including an alkali-soluble resin having a hydrogen-bonding capacity such as a novolac resin or a urethane resin, a layer including a water-insoluble and alkali-soluble resin and a compound having a dissolution suppressing action, and a layer including an ablation-possible compound.

In addition, by further adding an infrared absorbent to the upper layer, the heat generated from the upper layer can also be used in image formation. Preferable examples of the constitution of the upper layer including an infrared absorbent include a layer including an infrared absorbent, a water-insoluble and alkali-soluble resin, and a compound having a dissolution suppressing action, and a layer including an infrared absorbent, a water-insoluble and alkali-soluble resin, and an acid generator.

—Water-Insoluble and Alkali-Soluble Resin—

It is preferable that the upper layer according to the present disclosure contains a water-insoluble and alkali-soluble resin. By containing the water-insoluble and alkali-soluble resin, an interaction is formed between the polar groups of the infrared absorbent and the water-insoluble and alkali-soluble resin, and a layer having a positive type photosensitivity is formed.

Typical water-insoluble and alkali-soluble resin will be described below in detail, and among these, a polyamide resin, an epoxy resin, a polyacetal resin, an acrylic resin, a methacrylic resin, a polystyrene-based resin, and a novolac-type phenolic resin are preferably exemplified.

The water-insoluble and alkali-soluble resin which can be used in the present disclosure is not particularly limited as long as it has a characteristic of being dissolved by contact with an alkaline developer, and a homopolymer containing an acidic group in the main chain and/or a side chain in the polymer, a copolymer thereof, or a mixture thereof is preferable.

Such a water-insoluble and alkali-soluble resin having an acidic group preferably has a functional group such as a phenolic hydroxyl group, a carboxy group, a sulfonic acid group, a phosphoric acid group, a sulfonamide group, or an active imide group. Therefore, such a resin can be suitably generated by copolymerizing a monomer mixture including one or more ethylenically unsaturated monomers having a functional group described above. As the ethylenically unsaturated monomer having a functional group described above, in addition to acrylic acid and methacrylic acid, a compound represented by the following formula and a mixture thereof can be preferably exemplified. Moreover, in the following formula, R⁴⁰ represents a hydrogen atom or a methyl group.

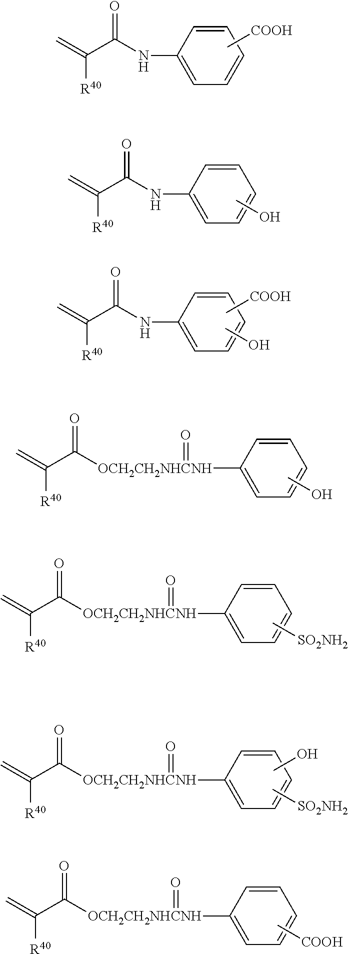

It is preferable that the water-insoluble and alkali-soluble resin which can be used in the present disclosure is a polymer compound obtained by copolymerizing another polymerizable monomer in addition to the above-mentioned polymerizable monomers. As the copolymerization ratio in this case, a monomer imparting alkali-solubility such as a monomer having a functional group such as a phenolic hydroxyl group, a carboxy group, a sulfonic acid group, a phosphoric acid group, a sulfonamide group, or an active imide group is preferably included in 10% by mole or greater, and more preferably included in 20% by mole or greater. In a case where the copolymerization component of the monomer imparting alkali-solubility is 10% by mole or greater, sufficient alkali-solubility is obtained, and developability is excellent.

Examples of other usable polymerizable monomers include compounds exemplified below.

Alkyl acrylates or alkyl methacrylates such as methyl acrylate, ethyl acrylate, propyl acrylate, benzyl acrylate, methyl methacrylate, ethyl methacrylate, cyclohexyl methacrylate, and benzyl methacrylate. Acrylic acid esters or methacrylic acid esters having an aliphatic hydroxyl group such as 2-hydroxyethyl acrylate and 2-hydroxyethyl methacrylate. Acrylamides or methacrylamides such as acrylamide, methacrylamide, N-methylacrylamide, N-ethylacrylamide, and N-phenylacrylamide. Vinyl esters such as vinyl acetate, vinyl chloroacetate, vinyl butyrate, and vinyl benzoate. Styrenes such as styrene, ca-methylstyrene, methylstyrene, and chloromethylstyrene. Other nitrogen atom-containing monomers such as N-vinyl pyrrolidone, N-vinyl pyridine, acrylonitrile, and methacrylonitrile. Maleimides such as N-methylmaleimide, N-ethylmaleimide, N-propylmaleimide, N-butylmaleimide, N-phenylmaleimide, N-2-methylphenylmaleimide, N-2,6-diethylphenylmaleimide, N-2-chlorophenylmaleimide, N-cyclohexylmaleimide, N-laurylmaleimide, and N-hydroxyphenylmaleimide.

Among these other ethylenically unsaturated monomers, (meth)acrylic acid esters, (meth)acrylamides, maleimides, or (meth)acrylonitrile is suitably used.

In addition, as the alkali-soluble resin, a novolac resin exemplified as another alkali-soluble resin described as an optional component of the image recording layer according to the present disclosure may also be preferably exemplified.

In addition, the water-insoluble and alkali-soluble resin described above can also be used in the image recording layer according to the present disclosure.

Furthermore, in the upper layer according to the present disclosure, other resins can be used in combination within a range not impairing the effects of the positive type planographic printing plate precursor according to the embodiment of the present disclosure. Since the upper layer is required to express alkali-solubility, in particular, in a non-image area region, it is necessary to select a resin which does not impair this characteristic. From this viewpoint, as a resin usable in combination, a water-insoluble and alkali-soluble resin is exemplified. General water-insoluble and alkali-soluble resin will be described below in detail, and among these, a polyamide resin, an epoxy resin, a polyacetal resin, an acrylic resin, a methacrylic resin, a polystyrene-based resin, and a novolac-type phenolic resin are preferably exemplified.

In addition, the amount to be mixed is preferably 50% by mass or less with respect to the water-insoluble and alkali-soluble resin.

The water-insoluble and alkali-soluble resin preferably has a weight-average molecular weight of 2,000 or greater and a number average molecular weight of 500 or greater, and more preferably has a weight-average molecular weight of 5,000 to 300,000 and a number average molecular weight of 800 to 250,000. The dispersity (weight-average molecular weight/number average molecular weight) of the alkali-soluble resin is preferably 1.1 to 10.

The alkali-soluble resin in another recording layer according to the present disclosure may be used alone or in combination of two or more kinds thereof.

The content of the alkali-soluble resin in another recording layer according to the present disclosure is preferably in a range of 2.0% to 99.5% by mass, more preferably in a range of 10.0% to 99.0% by mass, and still more preferably in a range of 20.0% to 90.0% by mass with respect to the total mass of another recording layer according to the present disclosure. In a case where the amount of the alkali-soluble resin to be added is 2.0% by mass or greater, the durability of the recording layer (photosensitive layer) is excellent. Further, in a case where the amount of the alkali-soluble resin to be added is 99.5% by mass or less, both the sensitivity and the durability are excellent.

—Infrared Absorbent—

The upper layer may contain an infrared absorbent.

The infrared absorbent is not particularly limited as long as it is a dye which generates heat by absorbing infrared light, and the infrared absorbent used in the image recording layer according to the present disclosure, described above, can also be used.

A particularly preferred dye is the cyanine coloring agent represented by Formula (a).

In a case where the upper layer contains an infrared absorbent, the sensitivity to infrared light becomes excellent.

The amount of the infrared absorbent to be added in the upper layer is preferably 0.01% to 50% by mass, more preferably 0.1% to 30% by mass, and particularly preferably 1.0% to 10% by mass with respect to the total solid content in the upper layer. In a case where the amount of the infrared absorbent to be added is 0.01% by mass or greater, the sensitivity is improved, and in a case where the amount of the infrared absorbent to be added is 50% by mass or less, the uniformity of the layer is excellent and the durability of the layer is excellent.

—Other Components—

In addition, the upper layer of the planographic printing plate precursor having a two-layer structure may include an acid generator, an acid proliferation agent, a development accelerator, a surfactant, a print-out agent/colorant, a plasticizer, or a wax agent. As these components, respective components used in the image recording layer according to the present disclosure, described above, can also be used, and the preferable aspects thereof are the same as described above.

[Lower Layer]

It is preferable that the lower layer of the planographic printing plate precursor having a two-layer structure according to the embodiment of the present disclosure is the image recording layer according to the present disclosure.

A printing plate with excellent image formability and printing durability can be obtained by using the image recording layer according to the present disclosure as the lower layer.

In a case where the image recording layer according to the present disclosure is used as the upper layer, it is preferable that the lower layer is also the image recording layer according to the present disclosure, but the lower layer may be another recording layer. The preferable aspects of the lower layer in this case are the same as the preferable aspects of the upper layer described above.

<Support Having Hydrophilic Surface>

The support used in the positive type planographic printing plate precursor according to the embodiment of the present disclosure is not particularly limited as long as the support is a dimensionally stable plate-shaped material having required strength and durability, and examples thereof include the supports described in paragraphs 0166 to 0169 of WO2016/047392A.

In the description above, an aluminum support is preferable, and an aluminum support to which a hydrophilic treatment has been applied is particularly preferable.

<Undercoat Layer>

It is preferable that the positive type planographic printing plate precursor according to the embodiment of the present disclosure includes an undercoat layer between the support having a hydrophilic surface and the image recording layer.

In a case where the positive type planographic printing plate precursor according to the embodiment of the present disclosure is a planographic printing plate having a two-layer structure, it is preferable that the precursor includes the support having a hydrophilic surface and an undercoat layer between the support and the lower layer.

As the undercoat layer component, various organic compounds can be used, and preferable examples thereof include phosphonic acids having an amino group such as carboxymethyl cellulose or dextrin, an organic phosphonic acid, an organic phosphorus acid, an organic phosphinic acid, amino acids, and hydrochloride of an amine having a hydroxy group. In addition, these undercoat layer components may be used alone or in a mixture of two or more types thereof. Details of the compound used in the undercoat layer and the method of forming the undercoat layer are described in paragraphs 0171 and 0172 of JP2009-175195A, and those described here are also applied to the present disclosure.

The coating amount of the undercoat layer is preferably in a range of 2 to 200 mg/m² and more preferably in a range of 5 to 100 mg/m². In a case where the coating amount is in the above-described range, sufficient printing durability is obtained.

<Back Coat Layer>

A back coat layer is provided on the rear surface of the support of the planographic printing plate precursor according to the embodiment of the present disclosure, as necessary. As the back coat layer, coating layers formed of an organic polymer compound described in JP1993-045885A (JP-H05-045885A) or a metal oxide obtained by hydrolyzing and polycondensing an organic or inorganic metal compound described in JP1994-035174A (JP-H06-035174A) are preferably used. Among these coating layers, alkoxy compounds of silicon such as Si(OCH₃)₄, Si(OC₂H₅)₄, Si(OC₃H₇)₄, and Si(OC₄H₉)₄ are easily available at low cost, and coating layers of metal oxides obtained from these have excellent developer resistance, and thus, these are particularly preferable.

(Method of Producing Planographic Printing Plate)

A method of producing a planographic printing plate according to the embodiment of the present disclosure includes: an exposure step of subjecting the planographic printing plate precursor to image-wise light exposure; and a development step of subjecting the precursor to development using an alkali aqueous solution having a pH of 8.5 to 13.5, in this order.

According to the method of producing the planographic printing plate according to the embodiment of the present disclosure, occurrence of stain caused by the residual film of a non-image area is suppressed and a planographic printing plate with excellent printing durability and chemical resistance is obtained.

Hereinafter, each step of the method of producing a planographic printing plate according to the embodiment of the present disclosure will be described in detail.

<Exposure Step>

The method of producing the planographic printing plate according to the embodiment of the present disclosure includes an exposure step of subjecting the positive type planographic printing plate precursor according to the embodiment of the present disclosure to image-wise light exposure. The detailed description is the same as the description in paragraphs 0173 to 0175 of WO2016/047392A.

<Development Step>

The method of producing the planographic printing plate according to the embodiment of the present disclosure includes a development step of performing development using an alkali aqueous solution with a pH of 8.5 to 13.5 (hereinafter, also referred to as a “developer”).

[Developer]

The developer used in the development step is an aqueous solution having a pH of 8.5 to 13.5 and more preferably an alkali aqueous solution having a pH of 12 to 13.5. The surfactant contributes to improvement of the processability.

Further, it is preferable that the developer contains a surfactant and more preferable that the developer contains at least an anionic surfactant or a nonionic surfactant. A surfactant contributes to improvement of processability.

As the surfactant used in the developer, any of an anionic surfactant, a nonionic surfactant, a cationic surfactant, and an amphoteric surfactant can be used, and as described above, an anionic surfactant or a nonionic surfactant is preferable.

As the anionic surfactant, the nonionic surfactant, the cationic surfactant, and the amphoteric surfactant used in the developer according to the method of producing a planographic printing plate according to the embodiment of the present disclosure, the surfactants described in paragraphs 0128 to 0131 of JP2013-134341A can be used.

In addition, from the viewpoint of stable solubility or turbidity in water, a surfactant preferably has a hydrophile-lipophile balance (HLB) value of 6 or greater and more preferably has a HLB value of 8 or greater.

As the surfactant used in the developer, an anionic surfactant or a nonionic surfactant is preferable, and an anionic surfactant containing sulfonic acid or sulfonate or a nonionic surfactant having an aromatic ring and an ethylene oxide chain is particularly preferable.

The surfactant can be used alone or in combination.

The content of the surfactant in the developer is preferably in a range of 0.01% to 10% by mass, and more preferably in a range of 0.01% to 5% by mass.

In a case where as a buffer, carbonate ions and hydrogencarbonate ions are included to maintain the pH of the developer at 8.5 to 13.5, it is possible to suppress variations in pH even in a case where the developer is used for a long period of time, and it is possible to suppress developability deterioration and a development scum occurrence due to the variation in pH. To make carbonate ions and hydrogencarbonate ions present in the developer, carbonate and hydrogencarbonate may be added to the developer, or by adjusting the pH after carbonate or hydrogencarbonate is added, carbonate ions and hydrogencarbonate ions may be generated. Although carbonate and hydrogencarbonate are not particularly limited, an alkali metal salt is preferable. Examples of the alkali metal include lithium, sodium, and potassium, and sodium is particularly preferable. These may be used alone or in combination of two or more types thereof.

The total amount of carbonate and hydrogencarbonate is preferably in a range of 0.3% to 20% by mass, more preferably in a range of 0.5% to 10% by mass, and particularly preferably in a range of 1% to 5% by mass, with respect to the total mass of the developer. In a case where the total amount is 0.3% by mass or greater, developability and processing capability are not reduced, and in a case where the total amount is 20% by mass or less, a precipitate or a crystal is less likely to be generated and at the time of the waste liquid treatment of the developer, gelation during neutralization is less likely to occur, and thus, trouble does not occur in the waste liquid treatment.

After the development step, a continuous or discontinuous drying step is preferably performed. Drying is performed by hot air, infrared rays, or far infrared rays.

As an automatic treatment machine suitably used for the method of producing the planographic printing plate according to the embodiment of the present disclosure, a device having a developing unit and a drying unit is used, and a planographic printing plate is obtained by performing development and gumming on the positive type planographic printing plate precursor in a developer tank and drying the positive type planographic printing plate precursor in the drying unit.

In addition, for the purpose of improving printing durability or the like, it is also possible to heat the printing plate after developing in very strong conditions. The heating temperature is preferably in a range of 200° C. to 500° C. In a case where the temperature is low, sufficient image strengthening effects are not obtained, and in a case where the temperature is too high, there is a possibility that problems such as deterioration of the support or thermal decomposition of the image area occur.

The planographic printing plate obtained in this manner is mounted on an offset printing machine, and can be suitably used in printing a large number of sheets.

Hereinafter, the present invention will be described in detail based on examples. The materials, the used amounts, the proportions, the treatment contents, and the treatment procedures described in the following examples can be appropriately changed within the range not departing from the scope of the embodiment of the present invention. Therefore, the range of the embodiment of the present invention is not limited to the following specific examples. Moreover, “part” and “%” in the present examples respectively represent “part(s) by mass” and “% by mass” unless otherwise specified.

Hereinafter, compounds PU-1 to PU-20, compounds PT-1 to PT-20, compounds PC-1 to PC-14, compounds PA-1 to PA-12, and compounds PE-1 to PE-19 in examples each correspond to the compounds PU-1 to PU-20, the compounds PT-1 to PT-20, the compounds PC-1 to PC-14, the compounds PA-1 to PA-12, and the compounds PE-1 to PE-19 in the specific examples described above.

### Examples

<Synthesis of Compounds PU-1 to PU-20, Compounds PT-1 to PT-20, and Compounds PC-1 to PC-14>

The compounds PU-1 to PU-20, the compounds PT-1 to PT-20, and the compounds PC-1 to PC-14 were synthesized with reference to the method described in WO2016/133072A.

<Synthesis of Compounds PA-1 to PA-12>

The compounds PA-1 to PA-12 were synthesized with reference to the method described in EP1826001B.

<Synthesis of Compounds PE-1 to PE-12>

The compounds PE-1 to PE-12 were synthesized with reference to the method described in WO2014/106554A.

<Preparation of Support>

An aluminum alloy plate having a thickness of 0.3 mm of a material 1S was subjected to the following (A-a) to (A-k) treatments, thereby producing a support for a planographic printing plate. Moreover, during all treatment steps, a washing treatment with water was performed, and after the washing treatment with water, liquid cutting was performed using a nip roller.

(A-a) Mechanical Roughening Treatment (Brush Grain Method)

While supplying a suspension of pumice (specific gravity of 1.1 g/cm³) to the surface of an aluminum plate as a polishing slurry liquid, a mechanical roughening treatment was performed using rotating bundle bristle brushes.

The median diameter (μm) of a polishing material was 30 μm, the number of the brushes was four, and the rotation speed (rpm) of the brushes was set to 250 rpm. The material of the bundle bristle brushes was nylon-6,10, the diameter of the brush bristles was 0.3 mm, and the bristle length was 50 mm. The brushes were produced by implanting bristles densely into the holes in a stainless steel cylinder having ϕ300 mm. The distance between two support rollers (ϕ200 mm) of the lower portion of the bundle bristle brush was 300 mm. The bundle bristle brushes were pressed until the load of a driving motor for rotating the brushes became 10 kW plus with respect to the load before the bundle bristle brushes were pressed against the aluminum plate. The rotation direction of the brushes was the same as the moving direction of the aluminum plate.

(A-b) Alkali Etching Treatment

The aluminum plate obtained above was subjected to an etching treatment by spraying a caustic soda aqueous solution in which the concentration of caustic soda was 26% by mass and the concentration of aluminum ions was 6.5% by mass using a spray tube at a temperature of 70° C. Thereafter, washing with water by spraying was performed. The amount of aluminum dissolved was 10 g/m².

(A-c) Desmutting Treatment in Acidic Aqueous Solution

Next, a desmutting treatment was performed in a nitric acid aqueous solution. As the nitric acid aqueous solution used in the desmutting treatment, the waste liquid of nitric acid used in electrochemical roughening of the next step was used. The liquid temperature was 35° C. The desmutting treatment was performed for 3 seconds by spraying the desmutting liquid using a spray.

(A-d) Electrochemical Roughening Treatment

An electrochemical roughening treatment was continuously performed using an AC voltage of nitric acid electrolysis 60 Hz. As the electrolyte at this time, an electrolyte which had been adjusted to have a concentration of aluminum ions of 4.5 g/L by adding aluminum nitrate to a nitric acid aqueous solution having a concentration of 10.4 g/L at a temperature of 35° C. was used. Using a trapezoidal rectangular waveform AC having a time tp until the current value reached a peak from zero of 0.8 msec and the duty ratio of 1:1 as the AC power source waveform, the electrochemical roughening treatment was performed using a carbon electrode as a counter electrode. As an auxiliary anode, ferrite was used. The current density was 30 A/dm² as the peak current value, and 5% of the current from the power source was separately flowed to the auxiliary anode. The electric quantity (C/dm²) was 185 C/dm² as the sum total of electric quantity at the time of anodization of the aluminum plate. Thereafter, washing with water by spraying was performed.

(A-e) Alkali Etching Treatment

The aluminum plate obtained above was subjected to an etching treatment by spraying a caustic soda aqueous solution in which the concentration of caustic soda was 5% by mass and the concentration of aluminum ions was 0.5% by mass using a spray tube at a temperature of 50° C. Thereafter, washing with water by spraying was performed. The amount of aluminum dissolved was 0.5 g/m².

(A-f) Desmutting Treatment in Acidic Aqueous Solution

Next, a desmutting treatment was performed in a sulfuric acid aqueous solution. As the sulfuric acid aqueous solution used in the desmutting treatment, a solution in which the concentration of sulfuric acid was 170 g/L and the concentration of aluminum ions was 5 g/L was used. The liquid temperature was 30° C. The desmutting treatment was performed for 3 seconds by spraying the desmutting liquid using a spray.

(A-g) Electrochemical Roughening Treatment

An electrochemical roughening treatment was continuously performed using an AC voltage of hydrochloric acid electrolysis 60 Hz. As the electrolyte, an electrolyte which had been adjusted to have a concentration of aluminum ions of 4.5 g/L by adding aluminum chloride to a hydrochloric acid aqueous solution having a concentration of 6.2 g/L at a liquid temperature of 35° C. was used. Using a trapezoidal rectangular waveform AC having a time tp until the current value reached a peak from zero of 0.8 msec and the duty ratio of 1:1, the electrochemical roughening treatment was performed using a carbon electrode as a counter electrode. As an auxiliary anode, ferrite was used.

The current density was 25 A/dm² as the peak current value, and the electric quantity (C/dm²) in the hydrochloric acid electrolysis was 63 C/dm² as the sum total of electric quantity at the time of anodization of the aluminum plate. Thereafter, washing with water by spraying was performed.

(A-h) Alkali Etching Treatment

The aluminum plate obtained above was subjected to an etching treatment by spraying a caustic soda aqueous solution in which the concentration of caustic soda was 5% by mass and the concentration of aluminum ions was 0.5% by mass using a spray tube at a temperature of 50° C. Thereafter, washing with water by spraying was performed. The amount of aluminum dissolved was 0.1 g/m².

(A-i) Desmutting Treatment in Acidic Aqueous Solution

Next, a desmutting treatment was performed in a sulfuric acid aqueous solution. Specifically, the desmutting treatment was performed at a liquid temperature of 35° C. for 4 seconds using the waste liquid (aluminum ions having a concentration of 5 g/L were dissolved in a sulfuric acid aqueous solution having a concentration of 170 g/L) generated in the anodization treatment step. The desmutting treatment was performed for 3 seconds by spraying the desmutting liquid using a spray.

(A-j) Anodization Treatment

An anodization treatment was performed using an anodization apparatus (the length of each of a first electrolytic portion and a second electrolytic portion was 6 m, the length of each of a first feeding portion and a second feeding portion was 3 m, and the length of each of a first feeding electrode and a second feeding electrode was 2.4 m) of a two-stage feeding electrolytic treatment method. As the electrolyte supplied to the first electrolytic portion and the second electrolytic portion, sulfuric acid was used. All electrolytes have a concentration of sulfuric acid of 50 g/L (including 0.5% by mass of aluminum ions) and were at a temperature of 20° C. Thereafter, washing with water by spraying was performed.

(A-k) Silicate Treatment

To ensure hydrophilicity of the non-image area, a silicate treatment was performed by dipping at 50° C. for 7 seconds using 2.5% by mass No. 3 sodium silicate aqueous solution. The amount of Si attached was 10 mg/m². Thereafter, washing with water by spraying was performed.

<Formation of Undercoat Layer>

The support prepared in the above-described manner was coated with an undercoat layer coating solution 1 described below, and the coating solution was dried at 80° C. for 15 seconds to provide an undercoat layer, thereby preparing a support. The coating amount after drying was 15 mg/m².

[Undercoat Layer Coating Solution 1]
Following copolymer having weight-average molecular weight of 28000: 0.3 parts (in the structural formulae, Et represents an ethyl group, and each numerical value on the lower right side of parentheses indicates the molar ratio)
Methanol: 100 parts
Water: 1 part

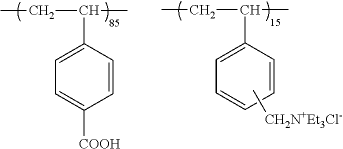

<Formation of Recording Layer>

After the obtained support was coated with a coating solution composition (I) for forming a lower layer having the following composition using a wire bar, the resulting product was dried in a drying oven at 150° C. for 40 seconds such that the coating amount thereof was set to 1.0 g/m², and thus a lower layer was provided. After the lower layer was provided, the lower layer was coated with a coating solution composition (II) for forming an upper layer having the following composition using a wire bar, whereby an upper layer was provided. After the coating, the resulting product was dried at 150° C. for 40 seconds, whereby a planographic printing plate precursor in which the coating amount of the lower layer and the upper layer was 1.2 g/m² was obtained.

[Coating Solution Composition (I) for Forming Lower Layer]
Polymer compound 1 listed in Tables 5 to 7: amounts listed in Tables 5 to 7
Polymer compound 2-1 or 2-2 listed in Tables 5 to 7: amounts listed in Tables 5 to 7
m,p-Cresol novolac (m/p ratio=6/4, weight-average molecular weight of 6,000): 0.6 parts
Infrared absorbent (IR coloring agent (1): following structure): 0.2 parts
4,4′-Bishydroxyphenyl sulfone: 0.3 parts
Tetrahydrophthalic acid: 0.4 parts
p-Toluenesulfonic acid: 0.02 parts
3-Methoxy-4-diazodiphenyl amine hexafluorophosphate: 0.06 parts
Product obtained by replacing a counter ion of ethyl violet with 6-hydroxynaphthalenesulfonic acid: 0.15 parts
Fluorine-based surfactant (MEGAFACE F-780, manufactured by DIC Corporation): 0.07 parts
Methyl ethyl ketone: 30 parts
1-Methoxy-2-butyrolactone: 15 parts
γ-Butyrolactone: 15 parts

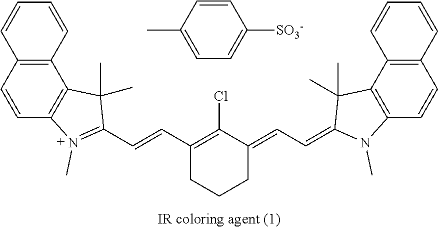

[Coating Solution Composition (II) for Forming Upper Layer]
Novolac resin (m-cresol/p-cresol/phenol=3/2/5, Mw of 8,000): 0.68 parts
Infrared absorbent (IR coloring agent (1): above structure): 0.045 parts
Fluorine-based surfactant (MEGAFACE F-780, manufactured by DIC Corporation): 0.03 parts
Methyl ethyl ketone: 15.0 parts
1-Methoxy-2-propanol: 30.0 parts
5-Benzoyl-4-hydroxy-2-methoxybenzenesulfonate of 1-(4-methylbenzyl)-1-phenylpiperidinium: 0.01 parts

The following evaluations were performed using the obtained planographic printing plate precursors, and the results are listed in the following Tables 5 to 7.

<Evaluation of Planographic Printing Plate Precursor>

[Evaluation of Solubility Resistance of Image Area and Non-Image Area Development Time]

Drawing of a test pattern in an image was performed on each positive type planographic printing plate precursor of each example and each comparative example using a Trendsetter VX (manufactured by Creo Company) at a beam intensity of 9 W and a drum rotation speed of 150 rpm.

Thereafter, the resulting product was immersed in a developing bath charged with a developer XP-D (which was made to have a conductivity of 43 mS/cm by dilution) (manufactured by Fujifilm Corporation), and the time taken until the dissolution of the image area was started at a development temperature of 30° C. and the time required for developing the non-image area were measured.

The time taken until the dissolution of the image area was started was set as the time taken until the measured value of the optical density (OD value) in the image area was decreased by 0.05 from the measured value of the optical density in the image area before the development treatment. Further, the immersion time at which a difference between the measured value of the optical density in the non-image area and the measured value of the optical density of the A1 support reached 0.02 or less was set as the non-image area development time. In both cases, the optical density was measured using a spectrophotometer SpectroEye (manufactured by GretagMacbeth Company).

As the time until the dissolution of the image area is started is longer, the resistance to an alkali aqueous solution is excellent. Further, as the non-image area development time is shorter, the solubility of the non-image area in an alkali aqueous solution is excellent and an alkali aqueous solution developability (highlight reproducibility) is good. Accordingly, it is evaluated that the positive type planographic printing plate precursor has excellent developability in a case where the image area dissolution starting time is long, the non-image area development time is short, and the difference between the image area dissolution starting time and the non-image area development time is large. The results are listed in Tables 5 to 7.

[Evaluation of Printing Durability]

Drawing of a test pattern in an image was performed on each positive type planographic printing plate precursor of each example and each comparative example using a Trendsetter (manufactured by Creo company) at a beam intensity of 9 W and a drum rotation speed of 150 rpm. Thereafter, using PS PROCESSOR LP940H (manufactured by Fujifilm Corporation) charged with a developer XP-D (which was made to have a conductivity of 43 mS/cm by dilution) (manufactured by Fujifilm Corporation), development was performed at a developing temperature of 30° C. for the development time which was the non-image area development time listed in Tables 5 to 7. This was continuously printed using a printing machine LITHRONE (manufactured by KOMORI Corporation). As the ink, a tokunen black ink (manufactured by TOYO INK CO., LTD.) containing calcium carbonate was used as a model of a low-grade material. At this time, by visually measuring how many sheets could be printed while maintaining a sufficient ink density, the printing durability was evaluated. It was evaluated that the printing durability was excellent as the number of sheets was larger. The results are listed in Tables 5 to 7.

[Evaluation of Chemical Resistance]

Exposure, development, and printing were performed on each positive type planographic printing plate precursor of each example and each comparative example in the same manner as in the evaluation of the printing durability. In this time, every time 5,000 sheets were printed, a step of wiping the plate surface with a cleaner (manufactured by Fujifilm Corporation, multi cleaner) was performed, and the chemical resistance was evaluated. The printing durability at this time was evaluated as 1 in a case where the number of printed sheets was 95% to 100% of the number of printing endurable sheets described above, evaluated as 2 in a case where the number of printed sheets was 80% or greater and less than 95%, evaluated as 3 in a case where the number of printed sheets was 60% or greater and less than 80%, and evaluated as 4 in a case where the number of printed sheets was less than 60%. Even in a case where the step of wiping the plate surface with a cleaner was performed, as the change in the printing durability index was smaller, the chemical resistance was evaluated to be excellent. The results are listed in Tables 5 to 7.

[Exposed Portion Development Time after Lapse of Time from Exposure]

Drawing of a test pattern in an image was performed on each positive type planographic printing plate precursor of each example and each comparative example using a Trendsetter (trade name, manufactured by Creo Company) at a beam intensity of 9 W and a drum rotation speed of 150 rpm. Thereafter, the resulting product was allowed to stand at room temperature (25° C.) and a humidity of 60% for 50 minutes and immersed in a developing bath charged with a developer DT-2 (trade name, manufactured by Fujifilm Corporation) (which was made to have a conductivity of 43 mS/cm by dilution), and the time required for developing the non-image area at a development temperature of 30° C. was measured. Further, the immersion time at which a difference between the measured value of the optical density in the non-image area and the measured value of the optical density of the A1 support reached 0.02 or less was set as the exposed portion development time. In the development carried out for a shorter time than the exposed portion development time, stains were generated on the printed material. The optical density was measured using a spectrophotometer SpectroEye (manufactured by GretagMacbeth Company). The evaluation results are listed in Tables 5 to 7.

TABLE 5

| | | | | | Evaluation results | | | | |
|---|---|---|---|---|---|---|---|---|---|
| | | | | | | | | Non-image | |
| | | | | | | | Printing | area | |
| | | | | | | | durability | development | |
| | | | | | Non-image | | Number of | time after | |
| | | | | Content of | area | Image area | printed | lapse of | |
| | | Content of | Polymer | polymer | development | dissolution | sheets | time from | |
| | Polymer | polymer | compound | compound | time | starting time | (10000 | exposure | Chemical |
| | compound 1 | compound 1 | 2-1 or 2-2 | 2-1 or 2-2 | (sec) | (sec) | sheets) | (sec) | resistance |
| Example 1 | PU-1 | 2.0 parts | PA-1 | 1.5 parts | 10 | 28 | 11 | 11 | 1 |
| Example 2 | PU-1 | 1.5 parts | PA-1 | 2.0 parts | 11 | 29 | 12 | 12 | 1 |
| Example 3 | PU-1 | 1.0 parts | PA-1 | 2.5 parts | 10 | 29 | 12 | 11 | 1 |
| Example 4 | PU-1 | 3.2 parts | PA-1 | 0.3 parts | 10 | 29 | 12 | 11 | 1 |
| Example 5 | PU-1 | 0.5 parts | PA-1 | 3.0 parts | 12 | 29 | 10 | 12 | 2 |
| Example 6 | PU-1 | 2.5 parts | PA-8 | 1.0 parts | 10 | 27 | 13 | 11 | 2 |
| Example 7 | PU-1 | 2.5 parts | PA-9 | 1.0 parts | 9 | 28 | 11 | 10 | 1 |
| Example 8 | PU-1 | 2.5 parts | PA-11 | 1.0 parts | 10 | 29 | 10 | 11 | 1 |
| Example 9 | PU-1 | 2.5 parts | PA-12 | 1.0 parts | 10 | 28 | 12 | 11 | 1 |
| Example 10 | PU-8 | 2.5 parts | PA-1 | 1.0 parts | 10 | 28 | 13 | 11 | 1 |
| Example 11 | PU-14 | 2.5 parts | PA-1 | 1.0 parts | 10 | 28 | 13 | 11 | 1 |
| Example 12 | PU-15 | 2.5 parts | PA-1 | 1.0 parts | 11 | 28 | 13 | 11 | 1 |
| Example 13 | PU-17 | 2.5 parts | PA-1 | 1.0 parts | 9 | 30 | 14 | 10 | 1 |
| Example 14 | PU-1 | 2.0 parts | PE-1 | 1.5 parts | 11 | 31 | 14 | 11 | 1 |
| Example 15 | PU-1 | 1.5 parts | PE-1 | 2.0 parts | 12 | 32 | 14 | 12 | 2 |
| Example 16 | PU-1 | 1.0 parts | PE-1 | 2.5 parts | 12 | 31 | 14 | 12 | 1 |
| Example 17 | PU-1 | 2.5 parts | PE-6 | 1.0 parts | 12 | 31 | 15 | 13 | 1 |
| Example 18 | PU-1 | 2.5 parts | PE-12 | 1.0 parts | 11 | 30 | 14 | 12 | 1 |
| Example 19 | PU-1 | 2.5 parts | PE-14 | 1.0 parts | 12 | 30 | 14 | 13 | 1 |
| Example 20 | PU-1 | 2.5 parts | PE-15 | 1.0 parts | 13 | 31 | 14 | 14 | 1 |
| Example 21 | PU-1 | 2.5 parts | PE-16 | 1.0 parts | 12 | 31 | 14 | 13 | 1 |
| Example 22 | PU-1 | 2.5 parts | PE-17 | 1.0 parts | 13 | 31 | 14 | 14 | 1 |
| Example 23 | PU-1 | 2.5 parts | PE-18 | 1.0 parts | 12 | 32 | 14 | 13 | 1 |
| Example 24 | PU-1 | 2.5 parts | PE-19 | 1.0 parts | 12 | 30 | 14 | 12 | 2 |
| Example 25 | PU-8 | 2.5 parts | PE-1 | 1.0 parts | 12 | 30 | 15 | 12 | 1 |
| Example 26 | PU-14 | 2.5 parts | PE-1 | 1.0 parts | 13 | 30 | 15 | 14 | 1 |
| Example 27 | PU-15 | 2.5 parts | PE-1 | 1.0 parts | 12 | 31 | 15 | 13 | 1 |
| Example 28 | PU-17 | 2.5 parts | PE-1 | 1.0 parts | 11 | 32 | 16 | 11 | 1 |
| Comparative | CP-1 | 2.5 parts | PA-1 | 1.0 parts | 130 | 200 | 9 | 140 | 2 |
| Example 1 | | | | | | | | | |
| Comparative | CP-1 | 2.5 parts | PE-1 | 1.0 parts | 130 | 200 | 10 | 140 | 2 |
| Example 2 | | | | | | | | | |
| Comparative | CP-2 | 2.5 parts | PA-1 | 1.0 parts | 130 | 200 | 7 | 140 | 4 |
| Example 3 | | | | | | | | | |
| Comparative | CP-3 | 2.5 parts | PA-1 | 1.0 parts | 20 | 40 | 5 | 25 | 1 |
| Example 4 | | | | | | | | | |
| Comparative | — | — | PA-1 | 1.0 parts | 22 | 40 | 7 | 27 | 3 |
| Example 5 | | | | | | | | | |
| Comparative | — | — | PE-1 | 1.0 parts | 25 | 45 | 7 | 30 | 2 |
| Example 6 | | | | | | | | | |

Further, the structures of CP-1, CP-2, and CP-3 used in Comparative Examples 1 to 4 are as shown below. In the structures, Me represents a methyl group, and each numerical value on the lower right side of parentheses indicates the molar ratio. CP-1, CP-2, and CP-3 were synthesized with reference to the method described in WO2016/133072A.

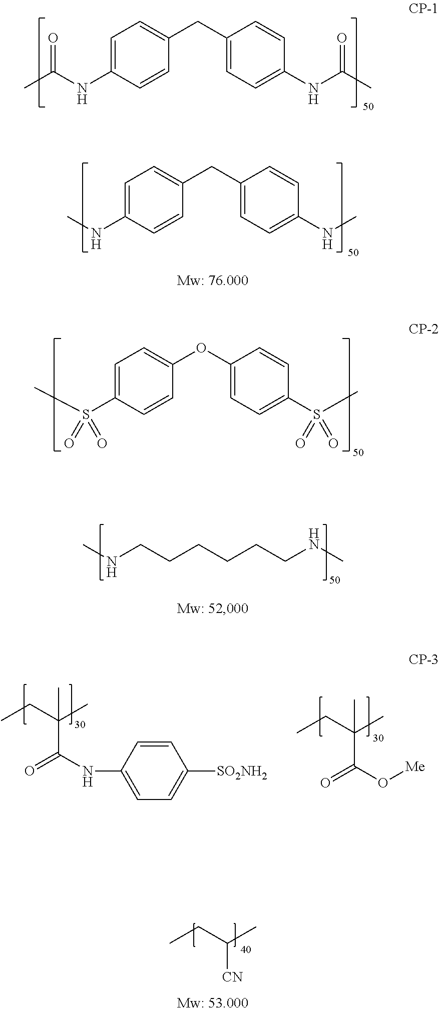

TABLE 6

| | | | | | Evaluation results | | | | |
|---|---|---|---|---|---|---|---|---|---|
| | | | | | | | | Non-image | |
| | | | | | | | Printing | area | |
| | | | | | | | durability | development | |
| | | | | | Non-image | | Number of | time after | |
| | | | | Content of | area | Image area | printed | lapse of | |
| | | Content of | Polymer | polymer | development | dissolution | sheets | time from | |
| | Polymer | polymer | compound | compound | time | starting time | (10000 | exposure | Chemical |
| | compound 1 | compound 1 | 2-1 or 2-2 | 2-1 or 2-2 | (sec) | (sec) | sheets) | (sec) | resistance |
| Example 29 | PT-1 | 2.0 parts | PA-1 | 1.5 parts | 9 | 28 | 11 | 10 | 1 |
| Example 30 | PT-1 | 1.5 parts | PA-1 | 2.0 parts | 10 | 28 | 12 | 10 | 1 |
| Example 31 | PT-1 | 1.0 parts | PA-1 | 2.5 parts | 9 | 29 | 11 | 9 | 1 |
| Example 32 | PT-1 | 3.2 parts | PA-1 | 0.3 parts | 9 | 29 | 12 | 10 | 1 |
| Example 33 | PT-1 | 0.5 parts | PA-1 | 3.0 parts | 12 | 28 | 10 | 12 | 2 |
| Example 34 | PT-1 | 2.5 parts | PA-8 | 1.0 parts | 9 | 27 | 11 | 10 | 2 |
| Example 35 | PT-1 | 2.5 parts | PA-9 | 1.0 parts | 9 | 28 | 11 | 9 | 1 |
| Example 36 | PT-1 | 2.5 parts | PA-11 | 1.0 parts | 9 | 29 | 10 | 9 | 2 |
| Example 37 | PT-1 | 2.5 parts | PA-12 | 1.0 parts | 9 | 28 | 12 | 10 | 2 |
| Example 38 | PT-13 | 2.5 parts | PA-1 | 1.0 parts | 8 | 30 | 14 | 9 | 1 |
| Example 39 | PT-14 | 2.5 parts | PA-1 | 1.0 parts | 9 | 28 | 13 | 10 | 1 |
| Example 40 | PT-15 | 2.5 parts | PA-1 | 1.0 parts | 10 | 28 | 13 | 10 | 1 |
| Example 41 | PT-16 | 2.5 parts | PA-1 | 1.0 parts | 9 | 30 | 12 | 9 | 1 |
| Example 42 | PT-1 | 2.0 parts | PE-1 | 1.5 parts | 10 | 30 | 13 | 10 | 1 |
| Example 43 | PT-1 | 1.5 parts | PE-1 | 2.0 parts | 10 | 31 | 13 | 10 | 2 |
| Example 44 | PT-1 | 1.0 parts | PE-1 | 2.5 parts | 11 | 31 | 13 | 12 | 1 |
| Example 45 | PT-1 | 2.5 parts | PE-6 | 1.0 parts | 11 | 30 | 14 | 12 | 1 |
| Example 46 | PT-1 | 2.5 parts | PE-12 | 1.0 parts | 10 | 30 | 13 | 11 | 1 |
| Example 47 | PT-1 | 2.5 parts | PE-14 | 1.0 parts | 11 | 30 | 13 | 11 | 1 |
| Example 48 | PT-1 | 2.5 parts | PE-15 | 1.0 parts | 12 | 31 | 13 | 13 | 1 |
| Example 49 | PT-1 | 2.5 parts | PE-16 | 1.0 parts | 11 | 31 | 13 | 11 | 1 |
| Example 50 | PT-1 | 2.5 parts | PE-17 | 1.0 parts | 12 | 31 | 13 | 13 | 1 |
| Example 51 | PT-1 | 2.5 parts | PE-18 | 1.0 parts | 12 | 32 | 13 | 13 | 1 |
| Example 52 | PT-1 | 2.5 parts | PE-19 | 1.0 parts | 11 | 30 | 13 | 12 | 2 |
| Example 53 | PT-13 | 2.5 parts | PE-1 | 1.0 parts | 10 | 33 | 15 | 11 | 1 |
| Example 54 | PT-14 | 2.5 parts | PE-1 | 1.0 parts | 12 | 30 | 15 | 12 | 1 |
| Example 55 | PT-15 | 2.5 parts | PE-1 | 1.0 parts | 11 | 31 | 15 | 12 | 1 |
| Example 56 | PT-16 | 2.5 parts | PE-1 | 1.0 parts | 12 | 32 | 16 | 13 | 1 |

TABLE 7

| | | | | | Evaluation results | | | | |
|---|---|---|---|---|---|---|---|---|---|
| | | | | | | | | Non-image | |
| | | | | | | | Printing | area | |
| | | | | | | | durability | development | |
| | | | | | Non-image | | Number of | time after | |
| | | | | Content of | area | Image area | printed | lapse of | |
| | | Content of | Polymer | polymer | development | dissolution | sheets | time from | |
| | Polymer | polymer | compound | compound | time | starting time | (10000 | exposure | Chemical |
| | compound 1 | compound 1 | 2-1 or 2-2 | 2-1 or 2-2 | (sec) | (sec) | sheets) | (sec) | resistance |
| Example 57 | PC-1 | 2.0 parts | PA-1 | 1.5 parts | 9 | 27 | 10 | 9 | 1 |
| Example 58 | PC-1 | 1.5 parts | PA-1 | 2.0 parts | 10 | 27 | 11 | 10 | 2 |
| Example 59 | PC-1 | 1.0 parts | PA-1 | 2.5 parts | 9 | 28 | 10 | 10 | 1 |
| Example 60 | PC-1 | 3.2 parts | PA-1 | 0.3 parts | 10 | 27 | 11 | 11 | 1 |
| Example 61 | PC-1 | 0.5 parts | PA-1 | 3.0 parts | 12 | 29 | 9 | 13 | 2 |
| Example 62 | PC-1 | 2.5 parts | PA-8 | 1.0 parts | 9 | 27 | 10 | 10 | 2 |
| Example 63 | PC-1 | 2.5 parts | PA-9 | 1.0 parts | 9 | 28 | 10 | 10 | 1 |
| Example 64 | PC-1 | 2.5 parts | PA-11 | 1.0 parts | 9 | 28 | 11 | 9 | 2 |
| Example 65 | PC-1 | 2.5 parts | PA-12 | 1.0 parts | 9 | 28 | 11 | 9 | 1 |
| Example 66 | PT-7 | 2.5 parts | PA-1 | 1.0 parts | 8 | 29 | 13 | 9 | 2 |
| Example 67 | PT-8 | 2.5 parts | PA-1 | 1.0 parts | 9 | 28 | 12 | 10 | 1 |
| Example 68 | PT-10 | 2.5 parts | PA-1 | 1.0 parts | 10 | 27 | 12 | 10 | 1 |
| Example 69 | PT-12 | 2.5 parts | PA-1 | 1.0 parts | 9 | 29 | 13 | 9 | 2 |
| Example 70 | PC-1 | 2.0 parts | PE-1 | 1.5 parts | 10 | 29 | 11 | 10 | 1 |
| Example 71 | PC-1 | 1.5 parts | PE-1 | 2.0 parts | 10 | 30 | 12 | 11 | 2 |
| Example 72 | PC-1 | 1.0 parts | PE-1 | 2.5 parts | 11 | 30 | 12 | 12 | 1 |
| Example 73 | PC-1 | 2.5 parts | PE-6 | 1.0 parts | 11 | 29 | 13 | 12 | 1 |
| Example 74 | PC-1 | 2.5 parts | PE-12 | 1.0 parts | 10 | 29 | 12 | 10 | 2 |
| Example 75 | PC-1 | 2.5 parts | PE-14 | 1.0 parts | 11 | 30 | 12 | 11 | 1 |
| Example 76 | PC-1 | 2.5 parts | PE-15 | 1.0 parts | 12 | 30 | 12 | 13 | 2 |
| Example 77 | PC-1 | 2.5 parts | PE-16 | 1.0 parts | 11 | 30 | 12 | 11 | 1 |
| Example 78 | PC-1 | 2.5 parts | PE-17 | 1.0 parts | 12 | 30 | 11 | 12 | 1 |
| Example 79 | PC-1 | 2.5 parts | PE-18 | 1.0 parts | 12 | 31 | 12 | 12 | 2 |
| Example 80 | PC-1 | 2.5 parts | PE-19 | 1.0 parts | 11 | 30 | 12 | 12 | 2 |
| Example 81 | PT-7 | 2.5 parts | PE-1 | 1.0 parts | 10 | 30 | 13 | 11 | 1 |
| Example 82 | PT-8 | 2.5 parts | PE-1 | 1.0 parts | 12 | 29 | 13 | 12 | 1 |
| Example 83 | PT-10 | 2.5 parts | PE-1 | 1.0 parts | 11 | 30 | 13 | 12 | 1 |
| Example 84 | PT-12 | 2.5 parts | PE-1 | 1.0 parts | 11 | 31 | 15 | 12 | 1 |

As shown in the results listed in Tables 5 to 7, it was found that the positive type planographic printing plate precursor according to the embodiment of the present disclosure has excellent developability, printing durability, and temporal stability after exposure.

What is claimed is:

1. A positive type planographic printing plate precursor, comprising:
a support which has a hydrophilic surface; and
an image recording layer on the support,
the image recording layer comprising:
a polymer compound 1 comprising at least one bond selected from the group consisting of a urea bond, a urethane bond, and a carbonate bond in a main chain and comprising a sulfonamide group in the main chain;
a polymer compound 2-1 comprising at least one selected from the group consisting of a constitutional unit represented by the following Formula S-1 and a constitutional unit represented by the following Formula S-2 or a polymer compound 2-2 comprising a constitutional unit represented by the following Formula EV-1 and a constitutional unit represented by the following Formula EV-2; and
an infrared absorbent: 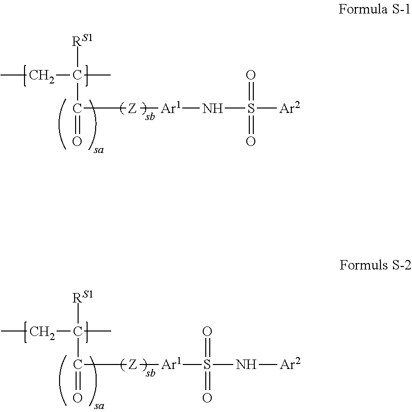
wherein, in Formulae S-1 and S-2, R^{S1} represents a hydrogen atom or an alkyl group, Z represents —O— or —N(R^{S2}), R^{S2} represents a hydrogen atom, an alkyl group, an alkenyl group, or an alkynyl group, each of Ar¹ and Ar² independently represents an aromatic group, at least one of Ar¹ or Ar² represents a heteroaromatic group, and each of sa and sb independently represents 0 or 1; and 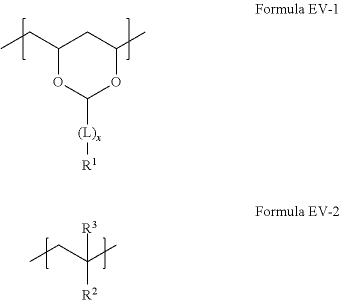
wherein, in Formulae EV-1 and EV-2, L represents a divalent linking group, X represents 0 or 1, R¹ represents an aromatic ring containing at least one hydroxy group or heteroaromatic ring containing at least one hydroxy group, and each of R² and R³ independently represents a hydrogen atom, a halogen atom, a linear, branched, or cyclic alkyl group which may have a substituent, a linear, branched, or cyclic alkenyl group which may have a substituent, an aromatic ring which may have a substituent, or a heteroaromatic ring which may have a substituent.

2. The positive type planographic printing plate precursor according to claim 1, wherein the polymer compound 1 further comprises a polycyclic structure in the main chain.

3. The positive type planographic printing plate precursor according to claim 1, wherein the polymer compound 1 comprises a constitutional unit represented by the following Formula A-1 as a constitutional unit comprising the sulfonamide group: 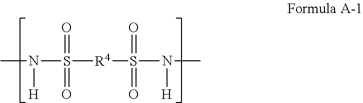
wherein, in Formula A-1, R⁴ represents a divalent linking group.

4. The positive type planographic printing plate precursor according to claim 3, wherein the constitutional unit represented by Formula A-1 comprises a constitutional unit represented by any of the following Formulae B1-1 to B1-6: 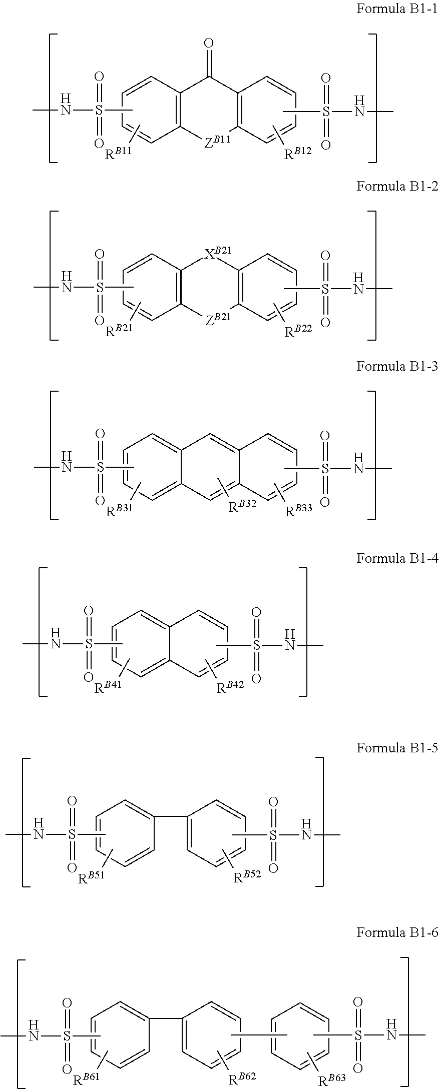
wherein, in Formulae B-1 to B1-6, each of R^{B11}, R^{B12}, R^{B21}, R^{B22}, R^{B31} to R^{B33}, R^{B41}, R^{B42}, R^{B51}, R^{B52}, and R^{B61} to R^{B63} independently represents a hydrogen atom, a sulfonamide group, a hydroxy group, a carboxy group, an alkyl group, or a halogen atom, Z^{B11} represents —C(R)₂—, —C(═O)—, —O—, —NR—, —S—, or a single bond, Z^{B21} represents —C(R)₂—, —O—, —NR—, —S—, or a single bond, each of R's independently represents a hydrogen atom or an alkyl group, X^{B21} represents —C(R′)₂—, —O—, —NR′—, —S—, or a single bond, and each of R's independently represents a hydrogen atom or an alkyl group.

5. The positive type planographic printing plate precursor according to claim 3, wherein the constitutional unit represented by Formula A-1 comprises a constitutional unit represented by the following Formula B1-1 or B1-2: 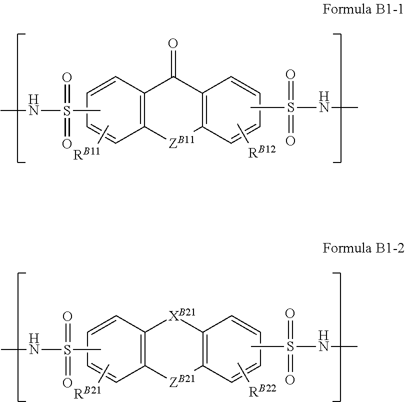
wherein, in Formula B1-1 or B1-2, each of R^{B11}, R^{B12}, R^{B21}, and R^{B22} independently represents a hydrogen atom, a sulfonamide group, a hydroxy group, a carboxy group, an alkyl group, or a halogen atom, Z^{B11} represents —C(R)₂—, —C(═O)—, —O—, —NR—, —S—, or a single bond, Z^{B21} represents —C(R)₂—, —O—, —NR—, —S—, or a single bond, each of R's independently represents a hydrogen atom or an alkyl group, X^{B21} represents —C(R′)₂—, —O—, —NR′—, —S—, or a single bond, and each of R's independently represents a hydrogen atom or an alkyl group.

6. The positive type planographic printing plate precursor according to claim 1, wherein:
the image recording layer comprises the polymer compound 2-2; and
the polymer compound 2-2 is a polymer compound 2-2 represented by the following Formula VA: 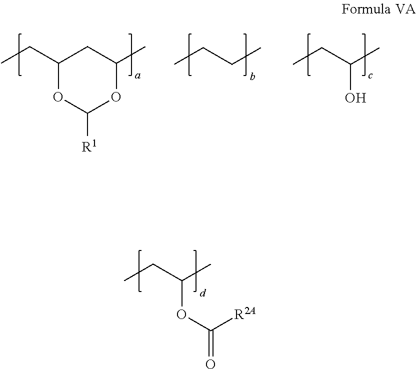
wherein, in Formula VA, R¹ represents an aromatic ring containing at least one hydroxy group or heteroaromatic ring containing at least one hydroxy group, R^{2A} represents an alkyl group which may have a substituent, a represents 10% to 55% by mole, b represents 15% to 60% by mole, c represents 10% to 60% by mole, and d represents 0% to 10% by mole.

7. The positive type planographic printing plate precursor according to claim 1, comprising a recording layer comprising a lower layer and an upper layer in this order on the support having a hydrophilic surface,
wherein at least one selected from the group consisting of the lower layer and the upper layer is the image recording layer.

8. The positive type planographic printing plate precursor according to claim 7, wherein the lower layer is the image recording layer, and
the upper layer is another recording layer.

9. The positive type planographic printing plate precursor according to claim 1, further comprising:
an undercoat layer which is provided between the support having a hydrophilic surface and the image recording layer.

10. A method of producing a planographic printing plate, comprising:
subjecting the positive type planographic printing plate precursor according to claim 1 to image-wise light exposure; and
subjecting the exposed positive type planographic printing plate precursor to development using an alkali aqueous solution having a pH of 8.5 to 13.5.
